(19) United States
(12) Patent Application Publication
(10) Pub. No.: US 2008/0158488 A1
(43) Pub. Date: Jul. 3, 2008

(54) Liquid Crystal Display Device

(75) Inventors: Yuujirou Yanai, Minami-ashigara-shi (JP); Hirofumi Toyama, Minami-ashigara-shi (JP); Hajime Nakayama, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/960,841

(22) Filed: Dec. 20, 2007

(30) Foreign Application Priority Data
Dec. 21, 2006 (JP) 2006-344062
Sep. 28, 2007 (JP) 2007-254599

(51) Int. Cl. G02F 1/13363; G02F 1/1335; G02F 1/13

(52) U.S. Cl. 349/107; 349/182

(57) ABSTRACT

A liquid crystal display device comprising at least a liquid crystal cell, and a polarizing plate (a first polarizing plate) disposed on at least one side of the outsides of the liquid crystal cell, wherein the liquid crystal cell comprises a pair of substrates which face each other, an electrode disposed on at least one of the pair of substrates, a liquid crystal layer sandwiched between the pair of substrates, and at least three pixel regions, a color filter showing wavelength selectivity in transmissivity is disposed on each of the at least three pixel regions is disclosed. In the liquid crystal display device, the thicknesses of the liquid crystal layers corresponding to a color filter showing a maximum transmissivity at a main wavelength λ₁, a color filter showing a maximum transmissivity at a main wavelength λ₂, and a color filter showing a maximum transmissivity at a main wavelength λ₃, provided that λ₁, λ₂, and λ₃ (unit: nm) are in an order from the smaller one, are d₁, d₂ and d₃ (unit: nm) respectively, and Relation (1) is satisfied:

d₂<d₃. : (1)

### CROSS-REFERENCE TO RELATED APPLICATIONS

This application claims benefit of priority under 35 U.S.C. 119 to Japanese Patent Application Nos. 2006-344062 filed Dec. 21, 2006, and 2007-254599 filed Sep. 28, 2007, and the entire contents of the applications are incorporated herein by reference.

### BACKGROUND OF THE INVENTION

1. Field of the Invention

The present invention relates to a liquid crystal display device having wide viewing angle characteristics and excellent color reproducibility.

2. Related Art

A display device employing a liquid crystal display element (also referred to as a liquid crystal display panel), an electroluminescence element (which is classified into an organic system or an inorganic system according to a fluorescent material to be used, and is hereinafter referred to as an EL element), a field emission device (hereinafter referred to as an FED element), an electrophoretic element, or the like displays an image without a space (vacuum cabinet) for two-dimensionally scanning an electron beam to a rear side of a display screen such as a cathode ray tube (CRT). Accordingly, such a display device has characteristics such as lighter weight and lower power consumption, as compared with the CRT. Such the display device may be referred to as a flat panel display due to the characteristics appearance.

The display device employing a liquid crystal display element, an EL element, an FED element, or the like has been widely used in a variety of applications including an OA apparatus such as a notebook personal computer, and a monitor for a personal computer, a mobile terminal, and a television set, instead of a display device employing the CRT because of the above-described advantages in comparison with the CRT. The flat panel display have been popularly used taking the place of CRT due to technical innovation including improvement of image quality such as enlargement of a display color reproducibility region or viewing angle characteristics of a liquid crystal display element or EL element. Recently, as multimedia or the internet comes into wide use, its moving image display capability has been also improved. Further, it expands into a field which could not be realized with the CRT such as an electronic paper, and an information display for a large-scale publication or advertisement.

A liquid crystal display device generally comprises a liquid crystal cell, a driving circuit for sending a display signal voltage to the liquid crystal cell, a backlight (rear-surface light source), and a signal control system for sending an input image signal to the driving circuit, all of which are collectively referred to as a liquid crystal module.

The liquid crystal cell generally comprises liquid crystal molecules, two substrates for filling and sandwiching the liquid crystalline molecules therebetween, and an electrode layer for applying a voltage to the liquid crystalline molecules, and a polarizing plate is disposed at the outside of the liquid crystal cell. The polarizing plate generally comprises a protective film and a polarizing film, and is prepared by dying the polarizing film comprising a polyvinyl alcohol film with iodine, stretching the dyed film and laminating a protective film on each side of the stretched film. With a transmission type liquid crystal display device, the polarizing plates are attached to both surfaces of the liquid crystal cell, and at least one optical compensation sheet maybe disposed therein. In addition, with a reflective type liquid crystal display device, a reflection plate, the liquid crystal cell, the at least one optical compensation sheet, and the polarizing plate are usually disposed in this order. The liquid crystal cell performs ON-OFF display based on difference of an alignment state of the liquid crystalline molecules, and can be applied to any of transmission type, reflection type, and semi-transmission type liquid crystal display devices.

By employing an optical compensation sheet of which an optical property is set to an optimal value for each light wavelength, it is possible to provide a liquid crystal display device having wide viewing angle characteristics and small color shift. It has been tried for reducing color shift of a conventional liquid crystal display device to adjust wavelength dispersion characteristics of retardation of the optical compensation film (Japanese Laid-open Patent publication No. 2002-221622). It has also been tried for balancing displayed colors to vary an in-plane retardation value Re of each of colors of color filers (JPA No. hei 5-196931).

### SUMMARY OF THE INVENTION

However, the above-described conventional liquid crystal display device cannot be improved at all the wavelengths, and coloring cannot be sufficiently improved, as observed in an oblique direction.

Accordingly, it is an object of the present invention to provide a liquid crystal display device having excellent color reproducibility with wide viewing angle.

In the conventional liquid crystal display device, as observed in an oblique direction upon black display, a problem such as a so-called color shift to blue or red has not been solved.

Accordingly, it is another object of the present invention to provide a liquid crystal display device, wherein color shift is not observed, or color shift is reduced, even as observed in an oblique direction in a black state.

In one aspect, the present invention provides a liquid crystal display device comprising at least a liquid crystal cell, and a polarizing plate (a first polarizing plate) disposed on at least one side of the outsides of the liquid crystal cell,

wherein the liquid crystal cell comprises a pair of substrates which face each other, an electrode disposed on at least one of the pair of substrates, a liquid crystal layer sandwiched between the pair of substrates, and at least three pixel regions,

a color filter showing wavelength selectivity in transmissivity is disposed on each of the at least three pixel regions,

the thicknesses of the liquid crystal layers corresponding to a color filter showing a maximum transmissivity at a main wavelength λ₁, a color filter showing a maximum transmissivity at a main wavelength λ₂, and a color filter showing a maximum transmissivity at a main wavelength λ₃, provided that λ₁, λ₂, and λ₃ (unit: nm) are in an order from the smaller one, are d₁, d₂ and d₃ (unit: nm) respectively, and Relation (1) is satisfied:

d₂<d₃. (1):

As embodiments of the invention, there are provided the liquid crystal display device of claim 1, satisfying Relation (2):

d₁<d₂<d₃; (2):

the liquid crystal display device, wherein, among the thickness-direction retardation (Rth) of color filter disposed on the at least three pixel regions, those of at least two of them are different from each other; and

the liquid crystal display device of claim 1, wherein the color filter satisfies Relations (I) and (II):

|Re(630)|≦10, and, |Rth(630)|≦40 (I):

|Re(400)−Re(700)|≦10, and, (Rth(400)−Rth(700)|≦35 (II):

wherein in Relations (I) and (II), Re(λ) is an in-plane retardation value (nm) at a wavelength λ nm, and Rth(λ) is a thickness-direction retardation value (nm) at a wavelength λ nm.

The liquid crystal display device of the present invention may employ a VA-mode.

One embodiment (first embodiment) of the VA mode liquid crystal display devise may further comprise a first optically anisotropic layer satisfying Relations (III) and (IV):

0 nm<Rth(550)≦300 nm (III):

Rth(550)/Re(550)>10; and (IV):

a second optically anisotropic layer having at least one optical axis in the plane.

The first optically anisotropic layer may satisfy Relations (V) to (VII):

Rth(450)/Rth(550)≧1 (V):

Rth(630)/Rth(550)≦1 (VI):

−30 nm≦Rth(630)−Rth(450)≦0 nm. (VII):

The second optically anisotropic layer may satisfy Relations (VIII) and (IX):

55 nm≦Re(550)≦315 nm (VIII):

0 nm≦Rth(550)≦275 nm. (IX):

Another embodiment (second embodiment) of the VA-mode liquid crystal display device may comprise an optically anisotropic layer A disposed between the first polarizing plate and the liquid crystal cell; and the optical anisotropy layer A satisfies Relations (XV) and (XVI):

30 nm≦Re(550)≦80 nm (XV):

75 nm≦Rth(550)≦155 nm; and (XVI):

when a slow axis of the optically anisotropic layer A is projected on the same plane as an absorption axis of the first polarizing plate, the projected axis is parallel to the absorption axis.

The second embodiment may further comprise a second polarizing plate, the first and second polarizing plates sandwiching the liquid crystal cell therebetween, of which absorption axis is perpendicular to the absorption axis of the first polarizing plate; and

an optically anisotropic layer B disposed between the second polarizing plate and the liquid crystal cell,

wherein the optically anisotropic layer B satisfies Relations (XV) and (XVI), and, when a slow axis of the optically anisotropic layer B is projected on the same plane as an absorption axis of the second polarizing plate, the projected axis is parallel to the absorption axis.

According to the second embodiment, the thickness-direction retardation values at a wavelength of 550 nm, Rth(550), of the optically anisotropic layers A and B and Δn(550)×d of the liquid crystal layer may satisfy Relation (XVII):

0.7≦(2×Rth(550))/Δn(550)×d≦1.3 (XVII):

in which Δn (550) is a refractive-index anisotropy of the thickness direction of the liquid crystal layer at a wavelength of 550 nm, and d is an average thickness (nm) of the liquid crystal layer.

In the first and second embodiments, at least one of the optically anisotropic layers may comprise at least one polymer and at least one additive, and the at least one additive is a liquid crystalline compound; an amount of the liquid crystalline compound is from 0.1 to 30% by mass, and a mass ratio of the liquid crystalline compound to all additives is from 40 to 100% by mass; the at least one of the optically anisotropic layers may comprise two types of liquid crystalline compound in an amount of 0.1 to 30% by mass, and a mass ratio of the at least two types of liquid crystalline compound to all additives is 50 to 100% by mass; and the at least one of the optically anisotropic layers may comprise at least one compound represented by Formula (A):

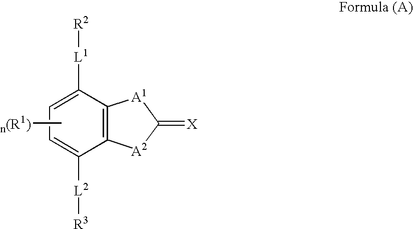

in which L¹ and L² independently represent a single bond or a divalent linking group; A¹ and A² independently represent a group selected from the group consisting of —O—, —NR— where R represents a hydrogen atom or a substituent, —S— and —CO—;R¹, R² and R³ independently represent a substituent; X represents a nonmetal atom selected from the groups 14-16 atoms, provided that X may bind with at least one hydrogen atom or substituent; and n is an integer from 0 to 2;

and at least one compound represented by Formula (a):

Ar¹-L¹²-X-L¹³-Ar² Formula (a):

in which Ar¹ and Ar² independently represent an aromatic group; L¹² and L¹³ independently represent —O—CO— or —CO—O—; and X represents 1,4-cyclohexylen, vinylene or ethynylene.

In the first and second embodiments, at least one of the optically anisotropic layers may be formed of a norbornene-based polymer film or a cellulose acylate-based film. An acyl substitution group of cellulose acylate as a main component in the cellulose acylate film may be selected from acetyl, propionyl, and butyryl.

In the first and second embodiments, at least one of the optically anisotropic layers may comprise at least one Rth enhancer; the Rth enhancer may comprise at least one compound having an absorption maximum at a wavelength ranging from 250 nm to 380 nm; and the Rth enhancer may comprise at least one compound represented by Formula (I):

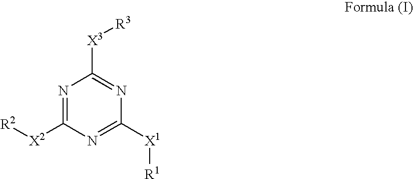

in which X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

The amount of the at least one compound represented by Formula (I) may be from 0.1 to 30% by mass.

In the first and second embodiments, the thickness of the optically anisotropic layer may be 30 to 200 μm.

The liquid crystal display device may employ an in-plane alignment type electrically controlled birefringence (ECB) mode, in which alignment of liquid crystal molecules is changed to be vertical to the surface of the substrate under an electric field thereby providing a low transmissivity state.

The liquid crystal display device may employ a bend alignment mode.

The liquid crystal display device may employ a TN mode.

### BRIEF DESCRIPTION OF THE DRAWINGS

FIG. 1 is a schematic view showing an embodiment of a liquid crystal display device according to the present invention.

FIG. 2 is a schematic view showing another embodiment of a liquid crystal display device according to the present invention.

FIGS. 3A and 3B are partial enlarged schematic cross-sectional views of examples of a liquid crystal cell employed in the embodiment of the liquid crystal display device shown in FIG. 2.

FIG. 4 is a view explaining an embodiment of an optical compensation mechanism in the embodiment of the liquid crystal display device shown in FIG. 2 on a Poincare sphere.

FIG. 5 is a view explaining an embodiment of an optical compensation mechanism in the embodiment of the liquid crystal display device shown in FIG. 2 on a Poincare sphere.

FIG. 6A is a view explaining an embodiment of an optical compensation mechanism in the embodiment of the liquid crystal display device shown in FIG. 2 on a Poincare sphere.

FIG. 7A is a view explaining an embodiment of an optical compensation mechanism in the embodiment of the liquid crystal display device shown in FIG. 2 on a Poincare sphere.

FIG. 8 is a schematic view showing another embodiment of a liquid crystal display device according to the present invention.

In the drawings, the reference numerals have the following meanings:

1: Upside Substrate of Liquid Crystal Cell

2: Rubbing Direction for Liquid Crystal Alignment of Upside Substrate

3: Downside Substrate of Liquid Crystal Cell

4: Rubbing Direction for Liquid Crystal Alignment of Downside Substrate

5, 5′: Liquid Crystal Layer (Liquid Crystal Molecule)

6a, 6b: Outside Protective Film of Polarizing Plate

7a, 7b: Slow Axis of Outside Protective Film of Polarizing Plate

8a, 8b: Polarizing Film

9a, 9b: Absorption Axis of Polarizing Film

10a, 10b: Transparent Support of Optically Anisotropic Layer

11a, 11b: Slow Axis of Transparent Support

12a, 12b: Optically Anisotropic Layer

13a, 13b: Rubbing Direction to be used for aligning liquid crystal molecules and preparing Optically Anisotropic Layer

14: First Optically Anisotropic Layer

16: Second Optically Anisotropic Layer

17: Slow Axis of Second Optically Anisotropic Layer

20a, 20b: Optically Anisotropic Layer

21a, 21b: Slow Axis of Optically Anisotropic Layer

P1, P1′, P1″, P2, P2′, P2″: Polarizing Plate

LC, LC′: Liquid Crystal Cell

### DETAILED DESCRIPTION OF THE INVENTION

In the following, the present invention will be explained with reference to the accompanying drawings. In the description, ranges indicated with “to” mean ranges including the numerical values before and after “to” as the minimum and maximum values.

At first, the terms to be used in the description will be described in details.

### (Retardations, Re and Rth)

In this description, Re(λ) and Rth(λ) are an in-plane retardation (nm) and a thickness-direction retardation (nm), respectively, at a wavelength of λ. Re(λ) is measured by applying light having a wavelength of λ nm to a film in the normal direction of the film, using KOBRA 21ADH or WR (by Oji Scientific Instruments).

When a film to be analyze by a monoaxial or biaxial index ellipsoid, Rth(λ) of the film is calculated as follows. Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (I) and (II):

$$\begin{matrix}Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( I ) \\ Rth = \{ ( nx + ny ) / 2 - nz \} \times d & ( II )\end{matrix}$$

wherein Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In the present description, with respect to an angle, “+” denotes a counter-clockwise direction, and “−” denotes a clockwise direction. When an upward direction of the liquid crystal display device is expressed as a twelve o'clock direction, and a downward direction is expressed as a six o'clock direction, a 0° direction of an absolute value of an angle direction denotes a three o'clock direction (a right direction of a screen). In addition, a slow axis denotes a direction having a maximum refractive index. A visible light region denotes a region ranging from 380 nm to 780 nm. Further, the wavelength of light used for measuring refractive index is a value at λ=550 nm in the visible light region unless otherwise specified.

Regarding descriptions of disposition or crossing angle between each axis and direction given in this specification, the terms “parallel”, “vertical”, and “45°” each denote “substantially parallel”, “substantially vertical”, and “substantially 45°”, and are not used in a strict sense. Some deviation is acceptable within a range of providing respective effects. For example, the term “parallel” indicates that a crossing angle is substantially 0°, and is in a range of −10° to 10°, preferably −5° to 5°, and more preferably −3° to 3°. The term “vertical” indicates that a crossing angle is substantially 90°, and is in a range of 80° to 100°, preferably 85° to 95°, and more preferably 87° to 93°. “45°” indicates that a crossing angle is substantially 45°, and is in a range of 35° to 55°, preferably 40° to 50°, and more preferably 42° to 48°.

In the present description, although a “polarizing film” and a “polarizing plate” are independently used, the “polarizing plate” indicates a lamination having a transparent protective film for protecting the polarizing film on at least one surface of the “polarizing film”.

The present invention relates to a liquid crystal display device in which the thicknesses of the liquid crystal layers corresponding to a color filter showing a maximum transmissivity at a main wavelength λ₁, a color filter showing a maximum transmissivity at a main wavelength λ₂, and a color filter showing a maximum transmissivity at a main wavelength λ₃, provided that λ₁, λ₂, and λ₃ (unit: nm) are in an order from the smaller one, are d₁, d₂ and d₃ (unit: nm) respectively, and Relation (1) is satisfied:

d₂<d₃. (1):

According to the present invention, the coloring, that is, color shift, in a black state is improved by varying the thickness of the liquid crystal layer of the liquid crystal cell among the pixel regions.

In the present invention, it is preferred to satisfy Relation (2).

d₁<d₂<d₃ (2):

If an optical compensation film of which an optical property is set to an optimal value for each light wavelength is used, it is possible to provide a liquid crystal display device having wide viewing angle characteristics and low color shift. However, it is difficult to industrially manufacture an ideal optical compensation film. In the present invention, a retardation of each pixel region of the liquid crystal layer of the liquid crystal cell is designed according to retardation wavelength dependency of a conventional optical compensation film.

Specifically, the present inventors have found that, many optical compensation films have larger in-plane retardation at shorter visible wavelengths, and that the preferred effect can be obtained when the relationship of Relation (1) is satisfied in the thicknesses of the liquid crystal layers among the pixels. A liquid crystal display device usually has at least three pixel regions (for example, R, G and B), and the thicknesses of the liquid crystal layers of each of the pixels can be independently adjusted by controlling the thicknesses of the color filters.

Hereinafter, an embodiment of an ECB mode liquid crystal display device according to the present invention will be described with reference to the accompanying drawings.

### (ECB Mode Liquid Crystal Display Device)

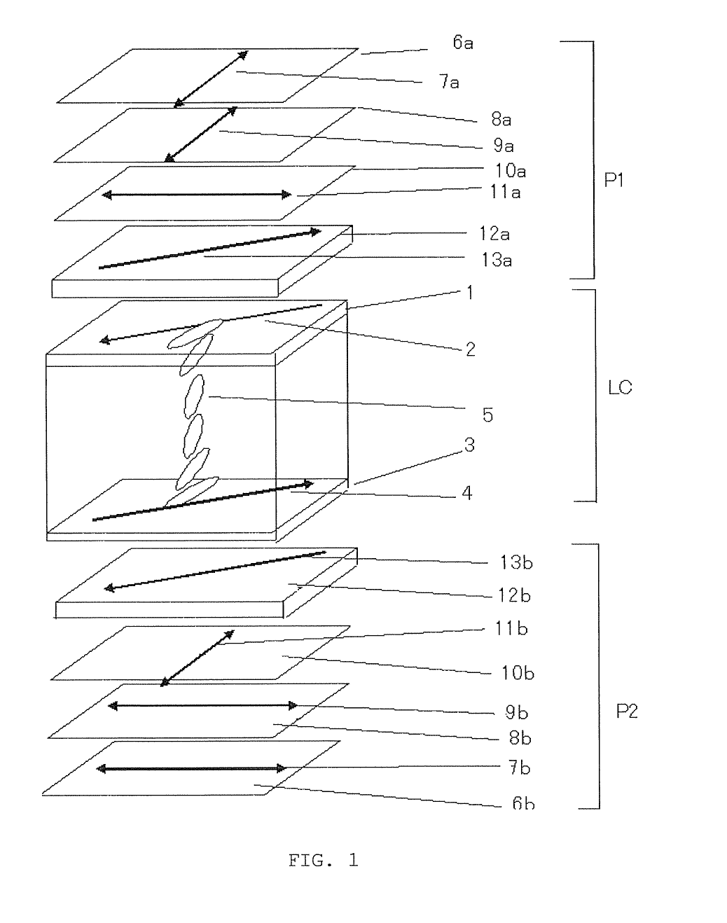

The ECB mode liquid crystal display device shown in FIG. 1 comprises a liquid crystal cell (LC) 1 to 5, and a pair of an upper polarizing plate P1 and a lower polarizing plate P2 which sandwiches the liquid crystal cell LC therebetween.

A rubbing direction 2 of an upper substrate 1 and a rubbing direction 4 of a lower substrate 3 of the liquid crystal cell LC are set to be parallel to each other, and a liquid crystal layer does not have a twist structure and is aligned in parallel. Each of the upper substrate 1 and the lower substrate 3 has an alignment film (not shown) and an electrode layer (not shown). The alignment film has a function for aligning liquid crystalline molecules 5. The electrode layer has a function for applying a voltage to the liquid crystalline molecules 5. The electrode layer is generally made of transparent indium tin oxide (ITO).

An example of a parallel mode liquid crystal layer may be a liquid crystal layer made of a liquid crystal (for example, MLC-9100 manufactured by Merck Ltd.) having a dielectric anisotropy Δε of about +8.5 and a refractive-index anisotropy about Δn=0.0854 (589 nm, 20° C.) between the upper and lower substrates. The thickness d of the liquid crystal layer may be set to about 3.5 μm. Here, the brightness at the time of white display varies depending on the level of a product Δn·d of the thickness d and the refractive-index anisotropy Δn. Accordingly, in order to obtain maximum brightness, it is preferable that the thickness d of the liquid crystal layer is set to be in a range of 0.2 to 0.4 μm.

Although the detailed structure is not shown in FIG. 1, the liquid crystal cell LC has three pixel regions, and the thickness of the liquid crystal layer varies depending on the pixel regions. A method for changing the thickness of the liquid crystal layer according to the pixel regions is not specifically limited. For example, the thickness of at least one or two of layers formed on a facing surface of the liquid crystal cell, for example, the alignment layer, the electrode layer, an optically anisotropic layer, and a color filter layer varies depending on the pixel regions and the thickness of the liquid crystal layer varies depending on the pixel regions. Specifically, it is preferable that the thickness of the color filter layer varies depending on the pixel regions so that the thickness of the liquid crystal layer is changed. Specifically, it is preferable that an RGB color filter having different thicknesses of R, G, and B layers is formed, for example, on the facing surface of the substrate 1 or 3, and the thickness of the liquid crystal layer varies depending on the pixel region. It is also possible to vary the thickness of the liquid crystal layer depending on the positions corresponding to the pixel regions by employing a substrate that has a plurality of regions having different thicknesses as the substrate 1 or 3. It is also possible to prepare the liquid crystal cell which satisfies Relation (1) and preferably Relation (2) by employing one or more layers other than a color filter, formed on the inner surface of the substrate, for example, a top coat film, having a plurality of thickness according to the positions corresponding to the colored layers of the pixel regions.

In FIG. 1, the upper polarizing plate P1 disposed at the outside of the liquid crystal cell is an elliptic polarizing plate having a polarizing film 8a, protective films 6a and 10a disposed on the surface of the polarizing film 8a, and an optically anisotropic layer 12a. Similarly, the lower polarizing plate P2 disposed at the outside of the liquid crystal cell is an elliptic polarizing plate having a polarizing film 8b, protective films 6b and 10b disposed on the surface of the polarizing film 8b, and an optically anisotropic layer 12b. The angles between absorption axes 9a and 9b of the polarizing plates and the liquid crystal cell alignment direction (rubbing directions 2 and 4) are 45° around; and the angles between the absorption axes 9a and 9b of the upper and lower polarizing plates are 90° around. The optically anisotropic layers 12a and 12b compensate retardation which remains in the liquid crystal layer in the black state so as to improve the contrast. The optically anisotropic layers 12a and 12b may be formed of a composition containing a liquid crystalline compound. In particular, the optically anisotropic layers 12a and 12b are preferably formed of a composition containing a discotic liquid crystalline compound. For example, the optically anisotropic layers 12a and 12b may be produced as follows. A composition containing a discotic liquid crystalline compound is prepared as a coating liquid; the coating liquid is applied to a rubbing surface having rubbing axis 11a or 11b; and the molecules of the discotic compound are aligned along the rubbing axes 11a and 11b and fixed in the alignment state. In FIG. 1, the protective films 10a and 10b also function as supports of the optically anisotropic layers 12a and 12b. An optical compensation sheet having a support formed of a polymer film and an optically anisotropic layer may be employed in the device separately from the polarizing plate.

A case where light is incident from a backlight (not shown) disposed at the outside of the lower polarizing plate P2 is considered. In a non-driving state in which a driving voltage is not applied to transparent electrodes (not shown) of the liquid crystal cell substrates 1 and 3, the liquid crystalline molecules 5 of the liquid crystal layer are substantially aligned in parallel to the surfaces of the substrates 1 and 3. The light, which is given a polarization state by the polarizing film 8b, changes its polarization state by birefringence of the liquid crystalline molecules 5, and as a result, passes through the polarizing film 8a. The value of Δn·d of the liquid crystal layer may be set in the above range in this state so that the amount of transmitted light becomes maximal. On the other hand, a driving state in which the driving voltage is applied to the transparent electrodes (not shown), the liquid crystalline molecules 5 substantially tend to align in a direction vertical to the surfaces of the substrates 1 and 3 according to the level of the applied voltage. Although the liquid crystalline molecules 5 are substantially aligned in a direction vertical to the surfaces of the substrates in the central portion in the thickness direction between the substrates, they are aligned in a direction parallel to the surfaces of the substrates in the vicinities of the interfaces of the substrates, and are continuously obliquely aligned in the portions between the central and the interfaces portions. In this state, it is difficult to obtain a complete black state. Furthermore, an average alignment of the liquid crystalline molecules which are obliquely aligned in the vicinities of the interfaces of the substrates is changed according to the observed directions, and the viewing angle dependency, namely the dependency of the transmissivity and the brightness on viewing angles occurs. According to the liquid crystal display device shown in FIG. 1, the optically anisotropic layers 12a and 12b are employed for compensating a remaining retardation of the liquid crystal layer in the vicinities of the interfaces of the substrates, and the complete black state is obtained and a front contrast ration is improved. In the liquid crystal display device shown in FIG. 1, since the thickness of the liquid crystal cell LC varies depending on the pixel regions so that Relation (1) (preferably Relation (2)) is satisfied, the transmissivity of the black state is reduced with respect to R and B lights, as well as the light G incident in an oblique direction, coloring does not occur, and the color reproducibility is more improved.

As described in JPA No. 2002-221622, the viewing angle characteristics may be improved by providing an optical film for compensating for the liquid crystal layer which is continuously obliquely aligned.

Since the liquid crystalline molecules 5 are obliquely aligned in the halftone state, birefringence of the liquid crystalline molecules 5 is different in between an oblique direction and a reverse direction thereof, and a difference in brightness or color tone occurs. Employing a multi-domain structure, in which a pixel of the liquid crystal display device is divided into a plurality of regions, the viewing angle characteristics of the brightness or the color tone are averaged and improved. Specifically, each pixel is divided into at least two (preferably 4 or 8) regions having different initial alignment states of the liquid crystalline molecules, and is averaged such that the deviation of the brightness or the color tone depending on the viewing angle can be reduced. Even when each pixel is divided into at least two different regions of which the alignment directions of the liquid crystalline molecules are continuously changed in a state of applying the voltage, the same effect is obtained.

The present invention is effect even in a vertical alignment (VA) mode liquid crystal display device. The VA mode is a simple structure in which a black/white response speed of ON-OFF is high and an alignment process such as a rubbing treatment is unnecessary. A preferred embodiment (hereinafter also referred to as a “first embodiment”) of the VA mode liquid crystal display device may be a VA mode liquid crystal display device comprising a first optically anisotropic layer that satisfies Relations (III) and (IV), and a second optically anisotropic layer having at least one optical axis in a plane.

0 nm<Rth(550)≦300 nm (III):

Rth(550)/Re(550)>10. (IV):

The second optically anisotropic layer may be an optical compensation film which is generally referred to as an A plate and, as a preferred embodiment, is an optically anisotropic layer satisfying Relations (VIII) and (IX).

55 nm≦Re(550)≦315 nm (VIII):

0 nm≦Rth(550)≦275 nm. (IX):

According to the VA mode liquid crystal display device of the present embodiment, the birefringence which occurs in the oblique direction of the liquid crystal cell in the black state is compensated by Rth of the first optically anisotropic layer. However, for such a compensation mechanism, in order to achieve ideal compensation, it is required that the first optically anisotropic layer exhibits strong regular wavelength dispersion characteristics regarding Rth. Here, a tendency in which Rth is decreased as the wavelength is increased is referred to as “regular wavelength dispersion characteristics of retardation”. And, the “strong regular wavelength dispersion characteristics of retardation” indicates that the gradient |ΔRth/Δλ| thereof is large. However, in order to prepare the optically anisotropic layer having the strong regular wavelength dispersion characteristics of Rth, the material is restricted and/or the wavelength dispersion characteristics of Rth is hard to be controlled to a desired range or an optically anisotropic layer having desired characteristics may not prepared by using any conventional material. According to the present invention, since the liquid crystal cell satisfies Relation (1), even when a regular wavelength dispersion characteristics regarding Rth of the first optically anisotropic layer is not as strong as that conventionally required, it may be compensated by the wavelength dispersion characteristics regarding thickness-direction birefringence of the liquid crystal cell, and the ideal optical compensation may be achieved.

In another preferred embodiment (hereinafter also referred to as a “second embodiment”) of the VA mode liquid crystal display device, the optically anisotropic layers, each of which satisfies Relation (XV) and (XVI), are disposed between the liquid crystal cell and the upper and lower polarizing films one by one, so that absorption axes of the polarizing films and the slow axes of the optically anisotropic layers adjacent to them, which are projected to the same plane, are parallel to each other.

30 nm≦Re(550)≦80 nm (XV):

75 nm≦Rth(550)≦155 nm (XVI):

In addition, it is preferable that the Rth(550) of the optically anisotropic layers disposed on the upper and lower sides of the liquid crystal cell satisfy Relation (XVII) in a relationship with the liquid crystal layer.

0.7≦(2×Rth(550))/Δn(550)×d≦1.3 (XVII):

wherein Δn(550) denotes the refractive-index anisotropy at 500 nm in the thickness direction of the liquid crystal layer, and d denotes an average thickness (nm) of the liquid crystal layer. In the present invention, since the thickness of the liquid crystal layer varies depending on the pixel regions, the thickness of (XVII) is the average thickness.

According to the VA mode liquid crystal display device of the second embodiment, the birefringence which occurs in the oblique direction of the liquid crystal cell in the black state is compensated by Re and Rth of the two optically anisotropic layers disposed at the symmetrical positions with respect to the center of the liquid crystal cell, but, in such a compensation mechanism, in order to achieve ideal compensation, the wavelength dispersion characteristics of Rth of the two optically anisotropic layers disposed symmetrically are required to be adjusted to cancel the wavelength dispersion characteristics of the birefringence of the liquid crystal layer. However, in order to adjust the wavelength dispersion characteristics of Rth to desired characteristics, the material used for preparing the optically anisotropic layer is restricted and/or the wavelength dispersion characteristics of Rth is hard to be controlled to a desired degree. According to the present invention, since the liquid crystal cell satisfies Relation (1), the birefringence of the liquid crystal layer is flattened. Accordingly, even when the regular wavelength dispersion characteristics regarding Rth of the two optically anisotropic layers is not as strong as the degree conventionally required, for example, even when the optically anisotropic layers, hardly exhibiting the wavelength dispersion characteristics regarding Rth, namely exhibiting the uniform Rth at visible light wavelengths, are employed, ideal optical compensation may be achieved.

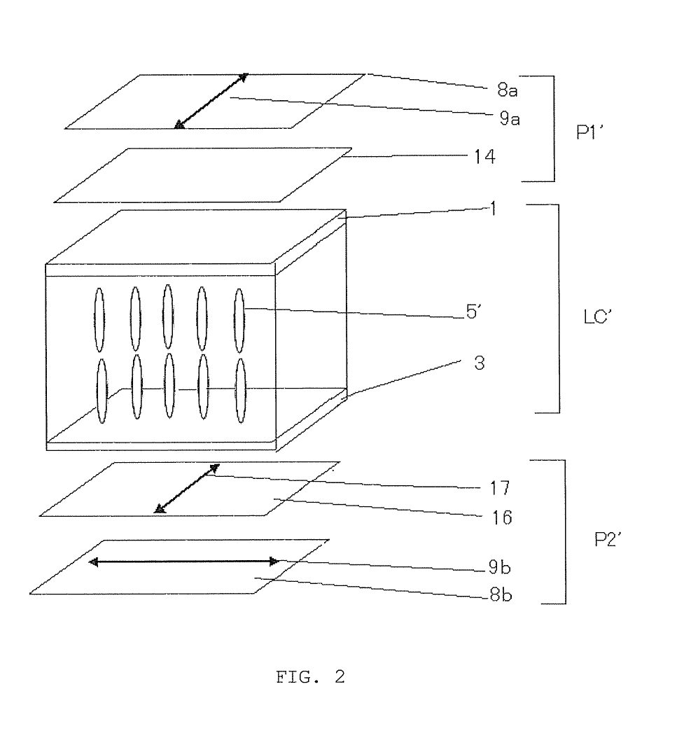

Hereinafter, the operation and the effect of the embodiments of the VA mode liquid crystal display device will be described with reference to the accompanying drawings. In FIG. 2, the configuration example of the first embodiment of the VA mode liquid crystal display device of the present invention is schematically shown. The same members as FIG. 1 are represented by the same reference numerals, and thus the detailed description thereof will be omitted. An upper side of FIG. 2 is defined as a viewer side, and a lower side thereof is defined as a backlight side.

The liquid crystal display device shown in FIG. 2 comprises a liquid crystal cell (LC′) 1, 3 and 5′, and a pair of an upper polarizing film P1′ and a lower polarizing film P2′ which sandwiches the liquid crystal cell LC′ therebetween. The polarizing film is generally provided in the liquid crystal display device as a polarizing plate having protective films disposed on both surfaces thereof, but, in FIG. 2, the protective films disposed at the outside of the polarizing films are omitted for simplification of the drawing.

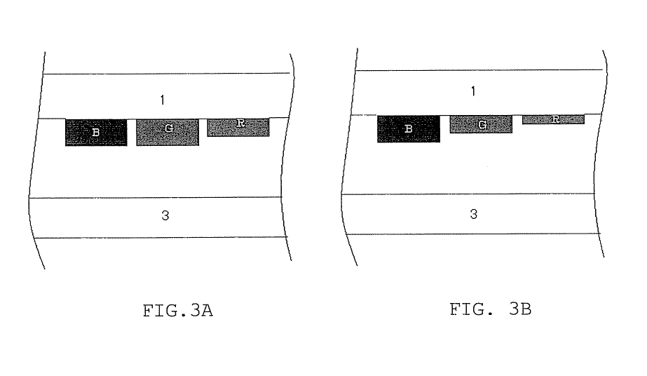

In FIG. 2, the liquid crystal cell LC′ is a VA mode liquid crystal cell and the liquid crystal layer 5′ is homeotropically aligned in the black state as shown in FIG. 2. Each of an upper substrate 1 and a lower substrate 3 has an alignment films (not shown) and an electrode layers (not shown), and a color filter layer is formed on the inner surface of the substrate 1 of the viewer side. Although the detailed structure is not shown in FIG. 2, the color filter formed on the inner surface of the substrate 1 includes three pixel regions of R, G and B and the thickness of the liquid crystal layer 5′ varies depending on the pixel regions. For example, as shown in FIG. 3A, the RGB color filter is formed on the inner surface of the substrate 1 and the thickness of the R layer is smaller than those of the B layer and the G layer and the thickness of the liquid crystal layer satisfies d_{G}<d_{R} and d_{B}<d_{R}. In a more preferred embodiment, as shown in FIG. 3B, the thicknesses of the B layer, the G layer and the R layer are decreased in this order and, as a result, the thicknesses of the liquid crystal layers corresponding to the B layer, the G layer and the R layer are increased in this order such that Relation (2) is satisfied.

In FIG. 2, a first optically anisotropic layer 14 satisfying Relations (III) and (IV) is sandwiched between the upper substrate 1 and the upper polarizing film 8a and a second optically anisotropic layer 16 satisfying Relations (VIII) and (IX) is sandwiched between the lower substrate 3 and the lower polarizing film 8b. The second optically anisotropic layer 16 is disposed so that an in-plane slow axis 17 thereof is perpendicular to an absorption axis 9b of the lower polarizing film 8b. If the second optically anisotropic layer 16 and the first optically anisotropic layer 14 are formed of a polymer film or comprise a polymer film layer, the second optically anisotropic layer 16 and the first optically anisotropic layer 14 also function as the protective films of the polarizing films 8a and 8b. Protective films may be separately sandwiched between the second optically anisotropic layer 16 and the first optically anisotropic layer 14 and the polarizing films 8a and 8b, and, if the protective films are disposed, for example, an isotropy film of which retardation is substantially 0, such as a cellulose acylate film disclosed in JPA No. 2005-138375, is preferably used.

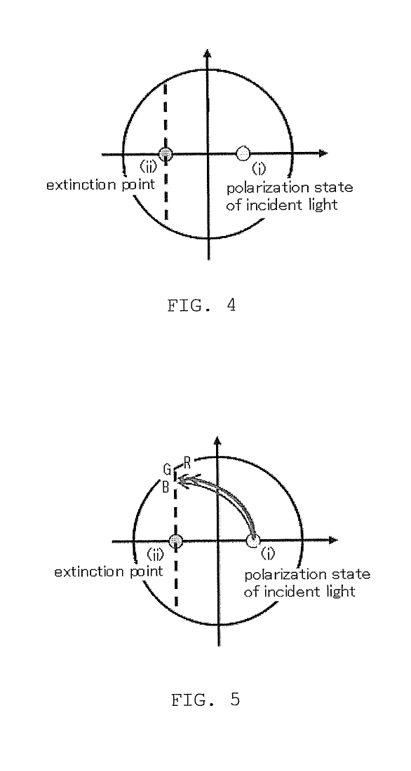

Next, the optical compensation operation of the liquid crystal display device shown in FIG. 2 will be described. FIGS. 4 to 7 show views showing Poincare spheres when viewed in a positive direction of an axis S2. The Poincare sphere is a three-dimensional map which describes a polarization state, and an equator of the sphere is in a polarization state of linear polarization in which an ellipticity is 0. A point (i) of FIG. 4 shows the polarization state in which the light incident to the liquid crystal display device shown in FIG. 2 in the oblique direction in the black state is linearly polarized by the polarizing film 8b. If the polarization state point (i) is converted into a polarization state point (ii) which is an extinction point of the axis S1 when the light is obliquely incident to the liquid crystal display device shown in FIG. 2, the deterioration in contrast is suppressed and the coloring is reduced. Accordingly, the birefringence is adjusted such that the polarization state is converted from the point (i) to the point (ii) by passing through the second optically anisotropic layer 16, the liquid crystal layer 5′ and the first optically anisotropic layer 14. The conversion of the polarization state due to the passage of the retardation region is represented on the Poincare sphere by a specific-angle rotation around a specific axis determined according to the optical characteristics of the retardation region. The level of the rotation angle is proportional to a retardation of the passing retardation region and is inversely proportional to the wavelength of the incident light.

By the light passing through the second optically anisotropic layer 16 satisfying Relations (VIII) and (IX) after passing through the polarizing film 8b, the polarization states of R, G and B lights are converted in the manner represented as an arrow of FIG. 5 into the states having S1 coordinate points same as that of the distinction point (ii).

As described above, since the magnitude of the rotation angle on the Poincare sphere is proportional to the inverse number of the wavelength of the incident light, R, G and B lights have a difference in the polarization state after conversion. In order to reduce the difference and obtain the polarization state in which the distinction point (ii) is matched to the S1 coordinate, in the second optically anisotropic layer 16, it is preferable that both Re and Rth exhibit reversed wavelength dispersion characteristics. Specifically, it is preferable that Relations (X) to (XIII) are satisfied.

0.6≦Re(450)/Re(550)≦1.0 (X):

1.0≦Re(630)/Re(550)≦1.25 (XI):

0.6≦Rth(450)/Rth(550)≦1.0 (XII):

1.0≦Rth(630)/Rth(550)≦1.25 (XIII):

Next, if the light passes through the liquid crystal layer 5′ which is homeotropically aligned in the black state, the conventions in the polarization states of R, G and B lights are expressed as the rotation of the S1 axis along with a trace represented by an arrow 5′ going from the top to the bottom in FIG. 6A.

In the embodiment having the color filter comprising the R layer, the G layer and the B layer, the three pixel regions become the RGB regions and the main wavelengths λ_{R}, λ_{G}, and λ_{B} having maximum transmissivities of the R region, the G region and the B region are arranged in order of λ_{B}, λ_{G}, λ_{R} from the smallest wavelength, namely λ_{B}<λ_{G}<λ_{R}. Here, the thicknesses of the liquid crystal layers of the R region, the G region and the B region are represented by d_{R}, d_{G} and d_{B}, and the refractive-index anisotropy of the wavelength λ of the liquid crystal layer in the thickness direction is represented by Δn(λ). Usually, Δn(λ_{B})>Δn(λ_{G})>Δn(λ_{R}) is satisfies in a liquid crystal display device. If the liquid crystal display device has a color filter in which colored layers have a same thickness, a relationship of Δn(λ_{B})×d_{B}>Δn(λ_{G})×d_{G}>Δn(λ_{R})×d_{R} is satisfied among the phase distances Δn(λ) of the thickness directions of the pixel regions of the liquid crystal display device. The rotation angles (the length of the arrow) of the polarization states of R, G and B lights by the passage of the liquid crystal layer satisfying the above relationship are proportional to retardation of the passing the retardation regions and are proportional to the inverse numbers of the wavelengths, the polarization states of R, G and B lights are largely separated by the passage of the liquid crystal layer (see FIG. 6B).

Meanwhile, according to the embodiment of the present invention, in the liquid crystal layer 5′, the thicknesses of the R layer, the G layer and the B layer of the color filter are different from one another as shown in FIG. 3B and, as a result, d_{B}<d_{G}<d_{R}, Relation (2), is satisfied. Accordingly, if the conversion of the polarization state by the passage of the liquid crystal layer 5′ is expressed by the rotation on the Poincare sphere, in terms of that the magnitudes of the rotation angles are proportional to the inverse numbers of the wavelengths, the magnitudes of the rotation angles are decreased as the wavelengths are increased. Meanwhile, since Relation (2) is satisfied, in terms of that the magnitudes of the rotation angles are proportional to retardation at the wavelength, the magnitudes of the rotation angles are increased as the wavelengths are increased. As a result, the difference between the magnitudes of the rotation angles depending on the wavelengths (the difference between the lengths of the arrows) is reduced as described in FIG. 6A.

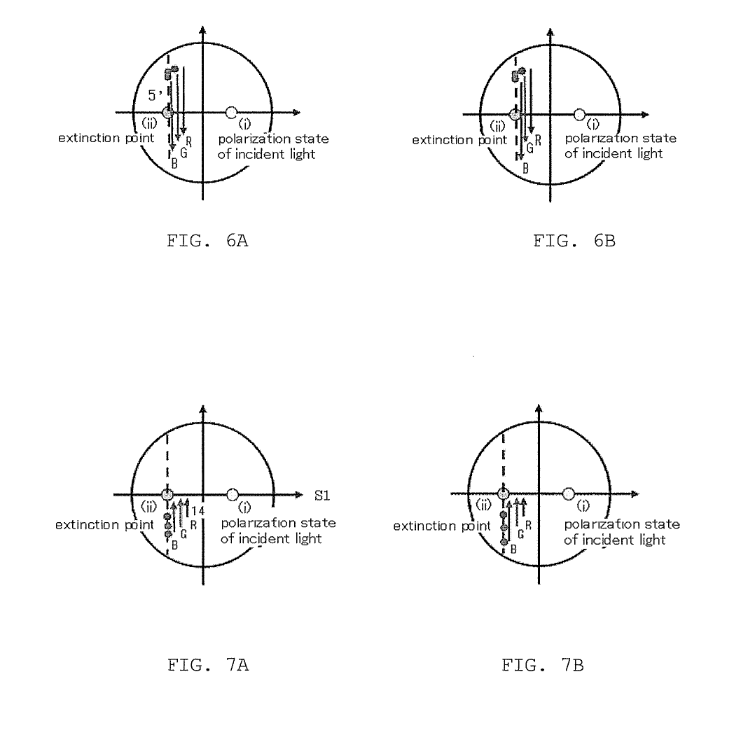

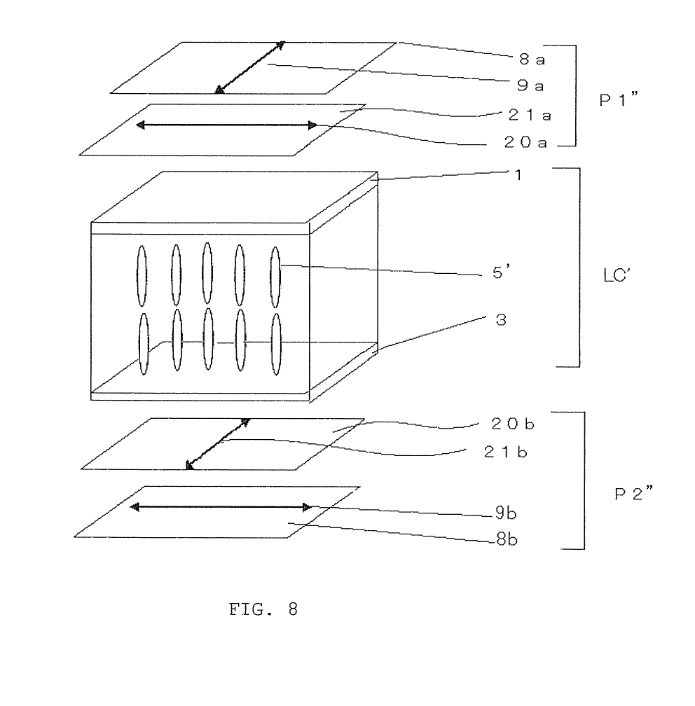

Since the incident light passes through the first optically anisotropic layer 14 which satisfies Relations (III) and (IV), the conversion of the polarization state thereof is represented by the movement in the normal direction of the plane S1-S2 represented by an arrow 14 going from the bottom to the top of the FIG. 7A, similar to the passage of the liquid crystal layer 5′. Conventionally, it is difficult to move the polarization state by the movement in the normal direction of the plane S1-S2, which is separated depending on the wavelength by the passage of the homeotropic liquid crystal layer onto the S1 axis as shown in FIG. 7B. Therefore, conventionally, the optically anisotropic layer is designed such that only G light is converted onto the S1 axis. Or conventionally, in order to adjust Rth of the first optically anisotropic layer to the strong regular wavelength dispersion characteristics, it is necessary to reduce the selection range of the material used for manufacture or strictly control a manufacturing condition. According to the present embodiment, as shown in FIG. 6A, the separation of R, G and B lights are reduced by the passage of the liquid crystal layer 5′. Since the magnitude of the rotation angle is proportional to the inverse number of the wavelength, and the rotation angles of B, G and R lights increase in this order, the conversion of the polarization states of all of B, G and R lights by the passage of the first optically anisotropic layer 14 is represented by movements onto the S1 axis on the Poincare sphere.

According to the first embodiment, it is more preferable that the liquid crystal cell satisfies Relation (2) and Rth of the first optically anisotropic layer exhibits any regular wavelength dispersion characteristics. In addition, it is more preferable that the liquid crystal cell satisfies Relation (2) and the degree of the regular wavelength dispersion characteristics of Rth of the first optically anisotropic layer satisfies Relations (V) to (VII).

Rth(450)/Rth(550)≧1 (V):

Rth(630)/Rth(550)≦1 (VI):

−30 nm≦Rth(630)−Rth(450)≦0 nm. (VII):

The polymer film of which Rth exhibits the regular wavelength dispersion characteristics regarding represented by Relations (V) to (VII) can be easily produced and, as a result, the selection range of the material to be used for preparing the first optically anisotropic layer can widen.

Although, in FIGS. 4 to 7, the embodiment that the light passes through the second optically anisotropic layer 16, the liquid crystal cell 5′, and the first optically anisotropic layer 14 in this order is described, the light may pass through the first optically anisotropic layer 14, the liquid crystal cell 5′, and the second optically anisotropic layer 16 in this order. Even in this case, the same effect is obtainable.

FIG. 8 schematically shows a configuration example of the second embodiment of the VA mode liquid crystal display device of the present invention. The same members as FIGS. 1 and 2 are represented by the same reference numerals and the detailed description thereof will be omitted. An upper side of FIG. 8 is defined as a viewer side and a lower side thereof is defined as a backlight side.

The liquid crystal display device shown in FIG. 8 comprises a liquid crystal cell (LC′) 1, 3 and 5′ and a pair of an upper polarizing film P1− and a lower polarizing film P2″ which sandwiches the liquid crystal cells LC′ therebetween. The polarizing film is generally provided in the liquid crystal display device as a polarizing plate having protective films that are disposed on both surfaces. However, in FIG. 8, the protective films disposed at the outside of the polarizing films are omitted for simplification of the drawing.

The liquid crystal cell LC′ shown in FIG. 8 is equal to the liquid crystal cell LC′ shown in FIG. 2 and the description thereof will be omitted.

Optical anisotropy layers 20a and 20b are sandwiched between an upper substrate 1 and an upper polarizing film 8a and between a lower substrate 3 and a lower polarizing film 8b, respectively. The optically anisotropic layers 20a and 20b satisfy Relations (XV) and (XVI) and are the optically anisotropic layers in which Re and Rth are equal to each other. The optically anisotropic layers 20a and 20b are disposed such that in-plane slow axes 21a and 21b are parallel to the absorption axes 9a and 9b of the upper polarizing film 8a and the lower polarizing film 8b. That is, the optically anisotropic layers 20a and 20b are disposed such that the slow axes are perpendicular to each other. If the optically anisotropic layers 20a and 20b are formed of a polymer film or include a polymer film layer, the optically anisotropic layers also function as the protective films of the polarizing films 8a and 8b. Protective films may be separately sandwiched between the optically anisotropic layers 20a and 20b and the polarizing films 8a and 8b, and, if the protective films are formed, for example, an isotropy film of which retardation is substantially 0, such as a cellulose acylate film disclosed in JPA No. 2005-138375, is preferably used.

Even in the present embodiment, similar to the first embodiment, the thickness of the R layer of the RGB color filter in the liquid crystal cell LC′ is smaller than those of the B layer and the G layer and the thicknesses of the liquid crystal layers at the positions corresponding thereto satisfy d_{G}<d_{R} and d_{B}<d_{R} such that the color shift in the oblique direction can be reduced.

Although the ECB mode and the VA mode are described above, the liquid crystal display device of the present invention is not limited to the liquid crystal display devices employing these modes. The liquid crystal cell performs display by changing the alignment state of the liquid crystal by an electric field, but may be classified as a display mode by the difference in the alignment state in a state in which the electric field is not applied. There are a parallel alignment type electrically controlled birefringence (ECB) mode in which liquid crystal molecules are initially aligned parallel to the substrate, a hybrid aligned nematic (HAN) mode in which portions of the liquid crystal molecules are longitudinally aligned and the other portions thereof are aligned in parallel, an optical compensation bend (OCB) mode in which the liquid crystal molecules are aligned in parallel in the vicinities of the substrates and are longitudinally aligned in a middle layer between the substrates, a band mode, a twisted nematic (TN) mode in which the liquid crystal molecules are aligned in parallel to the substrate and the alignment directions of the upper and lower substrates are different from each other and the liquid crystal molecules have a twisted structure, a super twisted nematic (STN) mode in which a twist angle of a general TN mode is in a range of 0 to 100 degrees and the liquid crystal molecules are twisted by 180 to 270°, and a cholesteric liquid crystal mode having a twist structure of 270° or more.

The display modes such as an in-plane switching (IPS) mode in which the liquid crystal molecules are aligned parallel to the substrate, and the liquid crystal alignment is changed in the surface of the substrate by a lateral field which is parallel to the surface of the substrate, and a ferroelectric liquid crystal (FLC) mode in which the display is changed by changing the in-plane alignment direction by an electric field vertical to the surface of the substrate similar to the IPS mode, are suggested. The liquid crystal display device of the present invention may be any one of the above-described modes.

The display modes have respective features. For example, the IPS mode and the FLC mode have a wide viewing angle, the OCB mode has a high response speed in all gradation displays, and the FLC mode and the cholesteric liquid crystal mode can give a memory property and has low power consumption. The TN mode has high transmissivity and a simplified manufacturing process.

The liquid crystal display device of the present invention is preferably of an ECB mode, a TN mode, a VA mode, an IPS mode, a band mode, or an OCB mode.

As described above, even in the liquid crystal display device of any display mode, if the multi-domain in which a pixel is divided into a plurality of regions is used, the viewing angle characteristics in all directions are averaged, and the display quality is preferably improved.

The liquid crystal display device is classified into an active matrix liquid crystal display device using a three-terminal or two-terminal semiconductor element such as a thin film transistor (TFT) and a metal insulator metal (MIM), and a passive matrix liquid crystal display device representative of an STN type referred to as time-division driving, according to the driving methods. The present invention is effective in both types of the liquid crystal display devices.

Hereinafter, various members to be used in the liquid crystal display device according to the present invention will be described in detail.

### [Color Filter]

The color filter is preferably disposed on the facing surface of one side of the pair of substrates of the liquid crystal cell of the liquid crystal display device of the present invention. The color filter is not specifically limited, but the color filter comprising at least the red (R) layer, the green (G) layer, and the blue (B) layer, is preferably provided. The RGB color filter of R, G and B and RGBW color filter including an R layer, a G layer, a B layer, and a white (W) layer are preferred.

As described above, in the liquid crystal display device of the present invention, the liquid crystal cell comprises three pixel regions, and the thicknesses of the liquid crystal layers corresponding to at least two pixel regions are different from each other. As one of preferred means for achieving this configuration, the thicknesses of the color layers disposed in at least two pixel regions among the at least three pixel regions are different from each other.

Among the Rth values of the color filter disposed in the three pixel regions, the Rth values of the color filter disposed in at least two pixel regions are different from each other, and the object of the present invention can be more efficiently achieved.

The color filter may be produced, for example, by the following method. First, the colored pixels in red, green and blue are formed on a transparent substrate. As a method of forming the colored pixels of red, green and blue on the transparent substrate, a dying method, a printing method, a coloring resist method of coating a colored photosensitive resin solution by a spin coater and patterning the colored photosensitive resin solution by a photolithography method, or a lamination method may be properly used. For example, in the forming method including the coating process, the color filter including RGB layers having different thicknesses may be formed by controlling the coating amount. If the lamination method is used, the color filter including RGB layers having different thicknesses may be formed by using transfer materials with different thicknesses.

It is preferable that a black matrix is formed using a black photosensitive resin after the colored pixels are formed. If the black matrix is first formed, since only the surface of the black photosensitive resin having a high optical concentration is cured, the uncured resin is molten (referred to as side etch) by a development process which is next performed and more particularly the development process which is repeatedly performed in order to form the colored pixels. As a worst case, the formed matrix may be stripped.

In contrast, if the black matrix is finally formed, since the periphery of the black matrix is surrounded by the colored pixels and a development solution is hard to penetrated from the cross section, the side etch is hard to be caused and the black matrix having the high optical concentration can be formed.

In a case where the colored layers for forming the colored pixels are formed by the lamination method, if the black matrix is first formed, since a place in which the colored pixels will be formed is closed by the black matrix in a lattice shape, bubbles are susceptible to be formed at the time of lamination. In contrast, if the black matrix is formed later, such a problem is not caused.

In a case where the light transmissivity of the colored pixels for a photosensitive wavelength to a photosensitive wavelength region of the black photosensitive resin exceeds 2%, it is preferable that the transmissivity is set to equal to or less than 2% by previously adding an optical absorber to the colored pixels. The optical absorber used at this time may use various known compounds. For example, a benzophenone derivative (Michler's ketone or the like), a merocyanine-based compound, metal oxide, a benzotriazole-based compound, or a coumalin-based compound may be used. Among them, it is preferable that a light absorption property is good and light absorption capability of 25% or more is maintained even after a heat treatment of 200° C. or more. Specifically, titanium oxide, zinc oxide, the benzotriazole-based compound and the coumalin-based compound may be used. Among them, the coumalin-based compound is particularly preferable in view of a heat resistance property and a light absorption property. The heat treatment of 200° C. or more is performed for curing after the pixels are formed.

Next, the black photosensitive resin layer is disposed on the entire surface of the transparent substrate by a pixel pattern. In this case, a method of coating a black photosensitive resin solution by a spin coater or a roll coater or a method of previously coating a black photosensitive resin solution on a temporary support to prepare an image forming material and transferring the black photosensitive resin layer on the pixel pattern may be used.

Next, the black photosensitive resin layer is exposed through a photomask and the black photosensitive resin layer of a light shielding portion (black matrix) in which the colored pixels are not formed is cured. The colored pixels are influenced by an alignment error of an exposure apparatus or thermal expansion of the substrate such that a positional deviation occurs. Since the pixels may be thick or thin, the interval or the size is not set according to a design dimension. In particular, this tendency is increased in a large-sized substrate. Accordingly, if the exposure is performed by the photomask according to the designed pixel interval, a portion in which the black matrix overlaps a pixel or a portion in which a gap between the pixel and the black matrix occurs is generated. The overlapping portion becomes a protrusion and the portion having the gap causes light leakage, both of which are not preferable.

The color filter preferably satisfies the following conditions.

0≦Re(630)≦10, and |Rth(630)|>25 (I):

|Re(400)−Re(700)|≦10, and, |Rth(400)−Rth(700)|≦35 (II):

In Relations (I) and (II), Re_{(λ)} denotes an in-plane retardation value (nm) of a wavelength λ nm and Rth_{(λ)} denotes a retardation value (nm) of a film thickness direction of the wavelength (nm).

Here, Re denotes the in-plane retardation and is preferably close to 0 because this value does not deteriorate a front contrast ratio. Even when Re is not 0, it is preferable that the slow axis of Re is parallel to or perpendicular to the absorption axis of the polarizing film.

Rth means thickness-direction retardation, does not have influence on the deterioration in the front contrast ratio, and contributes to the improvement of the viewing angle of the color tone in the oblique direction. By applying Rth of the above condition to the color filter, the optical compensation of the viewing angle can be more completely performed for each pixel and thus the coloring phenomenon of the oblique direction in the liquid crystal display device of each display mode can be improved (reduced).

Retardation of the color filter may be controlled by adding a retardation increasing agent or decreasing agent to a photosensitive layer or a colored layer which is a configuration layer of a transferring material, if the color filter is produced using the transfer material.

As a representative example of the retardation increasing agent, a compound represented by the following formula, and a compound analogous thereto may be used.

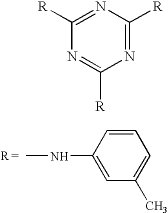

As an example of the retardation decreasing agent, there is a compound represented by the following formula (13).

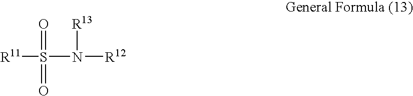

In the general formula 13, R¹¹ represents an alkyl group or an aryl group, and R¹² and R¹³ each independently represent a hydrogen atom, an alkyl group or an aryl group. In particular, it is preferable that the total sum of carbon atoms of R¹¹, R¹², and R¹³ is 10 or more. R¹¹, R¹², and R¹³ may have a substitution group and, as the substitution group, a fluorine atom, an alkyl group, an aryl group, an alkoxy group, a sulfone group, and a sulfonamide group are preferable. Among these, an alkyl group, an aryl group, an alkoxy group, a sulfone group, and a sulfonamide group are more preferable. The alkyl group may be a straight-chained, branched, or cyclic alkyl group, and the number of carbon atoms is preferably 1 to 25, more preferably 6 to 25, and most preferably 6 to 20 (for example, a methyl group, an ethyl group, a propyl group, an isopropyl group, a butyl group, an isobutyl group, a t-butyl group, an amyl group, an isoamyl group, a t-amyl group, a hexyl group, a cyclohexyl group, a heptyl group, an octyl group, a bicyclooctyl group, a nonyl group, an adamantly group, a decyl group, a t-octyl group, an undecyl group, a dodecyl group, a tridecyl group, a tetradecyl group, a pentadecyl group, a hexadecyl group, a heptadecyl group, an octadecyl group, a nonadecyl group, and a didecyl group). As the aryl group, the number of carbon atoms is preferably 6 to 30, and more preferably 6 to 24 (for example, a phenyl group, a biphenyl group, a terphenyl group, a naphthyl group, a binaphthyl group, and a triphenylphenyl group).

### [Liquid Crystal Cell And]

The brightness, the contrast, and the color tone of the display color of the liquid crystal display device vary according to the level of a product And of the cell gap of the liquid crystal cell and the refractive-index anisotropy Δn of the liquid crystal layer. Accordingly, an optimal Δnd is controlled for each display mode. In the ECB mode, Δn·d is set to 0.15 to 0.35 μm. The optimal value of Δn·d is 0.2 to 0.3 μm. In this range, since the brightness of the white display is high, and the brightness of the black display is low, a display device having high brightness and high contrast is obtained. Such an optimal value is a value of the transmission mode. Since the optical path in the liquid crystal cell is doubled in a reflection mode, the optimal value of Δnd becomes a half of the above value. In the other display mode, if Δn·d is set to 0.15 to 5 μm in the IPS mode or the VA mode, to 0.2 to 0.5 μm in the TN mode, and to 0.4 to 1.2 μm in the OCB mode, good display characteristics are obtained.

### [Backlight]

The liquid crystal display device performs display by ON or OFF of the light passing through the liquid crystal cell. If a transmissive liquid crystal display device is used, since a backlight using a cold cathode or hot cathode fluorescent tube, a light emitting diode, a field emission element, or an electroluminescence element as a light source can be disposed on the rear surface of the liquid crystal display device, the liquid crystal display device becomes a bright clear display device.

Examples of the backlight include a side edge type backlight used in a display device which is used in a mobile terminal, a notebook type personal computer, and a direct backlight used in a display device such as a television receiver. Since the side edge type backlight has one or two fluorescent lamps formed on an end of a light guide plate, the thickness of the backlight can be decreased. Meanwhile, in the direct backlight, the number of fluorescent lamps can be increased according to the required brightness, and high brightness can be easily obtained.

In order to improve the light emission efficiency of the backlight, a light condensing sheet (film) with brightness improvement, having a prism shape or a lens shape, maybe laminated, or a polarization reflection type sheet (film) with brightness improvement for improving the light loss by absorption of a polarizing plate may be laminated between the backlight and the liquid crystal cell. A diffusion sheet (film) for equalizing the light source of the backlight may be laminated, or a sheet (film) having a reflection/diffusion pattern with an in-plane distribution formed in the light source by printing may be laminated.

### [Field Sequential]

A full-color display method of the liquid crystal display device includes a spatial mixing method or a time difference mixing method. The time difference mixing method is referred to as a field sequential method.

In the spatial mixing method, an additive color mixing method of overlapping lights of wavelength regions of red (R), green (G) and blue (B) is used as a basic principle. In the LCD, any color light is obtained by adjacently disposing pixels of R, G and B, changing the brightness of each pixel and optionally mixing the colors. In the LCD using the spatial mixing method, the color filter is generally used. However, since the color filter performs color display by the absorption of light, transmissivity is low. Accordingly, in view of the power consumption, a field sequential backlight is excellent.

The field sequential method is a color display method using mixed color by time division. That is, if at least two color lights are continuously switched and emitted, and the speed of the switching is a speed exceeding temporal resolution of human's eyes, the human recognizes a mixture of at least two colors.

In the full-color LCD of the field sequential method, the backlight can emit one of three color lights of R, G and B for each field of a moving image display, the color lights of R, G and B are continuously switched and emitted (in time division) for each field, and the speed of switching is sufficiently set to be high, thereby obtaining any color light.

### [Application]

The liquid crystal display device according to the present invention includes liquid crystal display devices of an image direct-view type, an image projection type, and an optical modulation type. As the image direct-view type liquid crystal display device, there are an OA apparatus such as a notebook personal computer, and a monitor for a personal computer, a multimedia display such as a television set, and a small-size display device of a mobile telephone or a mobile terminal. There are a display device of an amusement apparatus, and a vertical or bottom large display device for conference.

As the image projection type, there are a front projector type for directly projecting an image on a screen and a rear projector type for projecting a rear surface of a screen. A mobile projector using an LED light source can be used.

As the light modulation type, a display device referred to as a three-dimensional display or a high-presence type display can be used. For example, a three-dimensional display using two liquid crystal cells or a cylindrical three-dimensional display composed of a plurality of rear projectors can be used.

### [Optical Compensation Sheet]

The liquid crystal display device of the present invention may comprise an optical compensation sheet. The optical compensation sheet is used in various liquid crystal display devices in order to increase the viewing angle, or to solve the image coloring. As the optical compensation sheet, a stretched birefringence polymer film has been conventionally used. Instead of the optical compensation sheet formed of the stretched birefringence film, an optical compensation sheet having an optically anisotropic layer formed of a low-molecular or high-molecular liquid crystalline compound on a transparent support has been suggested. Since the liquid crystalline compound has various alignment states, it is possible to achieve an optical property, which could not be obtained by a conventional stretched birefringence polymer film, by using the liquid crystalline compound. The optical compensation film also functions as a protective film of a polarizing plate. The optical compensation film may also function as an optical compensation sheet of a plastic substrate.

The optical property of the optical compensation sheet is determined according to an optical property of a liquid crystal cell, particularly a difference in a display mode. If the liquid crystalline compound is used, it is possible to prepare an optical compensation sheet having various optical properties corresponding to the various display modes of the liquid crystal cell. Various optical compensation sheets using a rod-like liquid crystalline compound, a spheroidal liquid crystalline compound or a discotic liquid crystalline compound corresponding to the various display modes has been suggested. For example, the optical compensation sheet for the TN mode liquid crystal cell may compensate a state in which the liquid crystal molecules are obliquely aligned with respect to the surface of the substrate while solving the twisted structure by applying a voltage, and improves the visual characteristics of the contrast by preventing light from being leaked in an oblique direction in the black state. The optical compensation sheet for the VA mode or the IPS mode may compensate the viewing angle-dependence of the polarizing plate, reduces the brightness of the black display in all orientations, and improves the visual characteristics of the contrast.

The optical property of the optical compensation sheet is set to an optimal value for each light wavelength and a liquid crystal display device having wide viewing angle characteristics and low color change. In particular, a multi-gap or a multi-domain can be combined.

It is possible to decrease the viewing angle such that the display can be observed in a specific direction, in stead of increasing the viewing angle.

Examples of the optical compensation sheet may include an optically anisotropic layer formed of a composition containing a liquid crystalline compound, and an optical compensation sheet having a support for supporting the optically anisotropic layer. Hereinafter, the optical compensation sheet in this aspect will be described in detail.

### <<Optically Anisotropic Layer>>

The optically anisotropic layer is preferably designed such that a liquid crystal compound in the liquid crystal cell upon black display of the liquid crystal display device is compensated. The alignment state of the liquid crystal compound in the liquid crystal cell upon black display varies depending on the modes of the liquid crystal display device. The alignment state of the liquid crystal compound in the liquid crystal cell is disclosed in IDW′00, FMC7-2, and P411 to 414. The optically anisotropic layer may be formed by providing the composition containing the liquid crystalline compound on the surface, for example, the surface which is subjected to a rubbing process according to a predetermined rubbing axis, aligning the molecules of the liquid crystalline compound according to the rubbing axis, and fixing the molecules in the alignment state.

Examples of the liquid crystalline compound used for forming the optically anisotropic layer include a rod-like liquid crystalline compound and a discotic liquid crystalline compound. Examples of the rod-like liquid crystalline compound and the discotic liquid crystalline compound may include a high molecular liquid crystal, a low molecular liquid crystal, and a liquid crystal which does not exhibit liquid crystallinity by the cross-linking of the low molecular liquid crystal. If the rod-like liquid crystalline compound is used to prepare the optically anisotropic layer, it is preferable that the rod-like liquid crystalline molecules are aligned such that an average direction of an axis when a long axis thereof is projected on the surface of the support is parallel to an alignment axis and are fixed in this state. If the discotic liquid crystalline compound is used for producing the optically anisotropic layer, it is preferable that the discotic liquid crystalline molecules are aligned such that an average direction of an axis when a short axis thereof is projected on the surface of the support is parallel to an alignment axis and are fixed in this state. The alignment state defined by the angle between the rod-like liquid crystalline molecules or the discotic liquid crystalline molecules and the surface of the substrate may be any one of a horizontal (homogeneous) alignment, a vertical alignment and a uniform tilt alignment, but a hybrid alignment in which the angle (tilt angle) between the molecules and the surface of the substrate varies in a depth direction is preferable.

### <<Rod-Like Liquid Crystal Compound>>

Examples of the rod-like liquid crystal compound include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles.

Examples of the rod-like liquid crystal compounds further include metal complexes of liquid crystal compounds. Liquid crystal polymers comprising one or more repeating units having a rod-like liquid crystal structure can also be used in the present invention. Namely, the rod-like crystal compounds bonded to a polymer may be use in the present invention.

Rod-like liquid crystal compounds are described in fourth, seventh and eleventh chapters of “Published Quarterly Chemical Review vol. 22 Chemistry of Liquid Crystals (Ekisho no Kagaku)” published in 1994 and edited by Japan Chemical Society; and in third chapter of “Handbook of liquid Crystal Devices (Ekisyo Debaisu Handobukku)” edited by the 142 th committee of Japan Society for the Promotion of Science.

The rod-like crystal compounds desirably have a birefringence index of 0.001 to 0.7.

The rod-like crystal compounds desirably have one or more polymerizable groups for fixing themselves in an alignment state. The polymerizable group is desirable selected from polymerizable groups capable of radical or cation polymerization, and specific examples of the polymerizable group and the polymerizable liquid crystal compound include those described in Japanese Laid-open Patent publication No. 2002-62427, [0064] to [0086].

### <<Discotic Liquid Crystal Compound>>

Examples of discotic liquid-crystal compounds include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al.

Examples of the discotic liquid crystal compounds also include compounds having a discotic core and substituents, radiating from the core, such as a linear alkyl or alkoxy group or substituted benzoyloxy groups. The orientational compounds of which molecules or molecular assemblies have a rotational symmetry are preferred. In the optically anisotropic layer, molecules of the discotic liquid crystal compound may exhibit no liquid-crystallinity. For example, when a low-molecular-weight liquid crystal compound, having a reacting group initiated by light and/or heat, is employed in preparation of an optically anisotropic layer, polymerization or cross-linking reaction of the compound is initiated by light and/or heat, and carried out, to thereby form the layer. The polymerized or cross-linked compounds may no longer exhibit liquid crystallinity. Preferred examples of the discotic liquid crystal compound include those described in Japanese Laid-open Patent publication No. Hei 8-50206 (1996-50206). The polymerization of discotic liquid-crystal compounds is described in Japanese Laid-open Patent publication No. Hei 8-27284 (1996-27284).

It is necessary to bond a polymerizable group as a substituent to the disk-shaped core of a discotic liquid-crystal molecule to better fix the discotic liquid-crystal molecules by polymerization. The discotic liquid-crystal molecules desirably have a linking group between the disk-shaped core and the polymerizable group, and such compounds may maintain alignment during polymerization reaction. Examples of the compound include those described in Japanese Laid-open Patent publication No. 2000-155216, [0151] to [0168].

In the hybrid alignment, an angle between the discotic surface of the discotic liquid crystalline molecules and the surface of the support is in a depth direction of the optically anisotropic layer, and is increased or decreased as a distance from the surface of the support is increased. It is preferable that the angle is increased as the distance is increased. The change in angles maybe any type of continuous increase, continuous decrease, intermittent increase, intermittent decrease, change including the continuous increase and the continuous decrease or intermittent change including increase and decrease. The intermittent change includes a region in which the tilt angle is not changed in the thickness direction. Although the region includes the region in which the angle is not changed, the angle may be increased or decreased as a whole. It is preferable that the angle is continuously changed.

The average direction of the long axis of the discotic liquid crystalline molecules at the side of the support can be usually controlled by selecting the discotic liquid crystalline molecules or the material of the alignment film, or by selecting a rubbing method. The discotic surface direction of the discotic liquid crystalline molecules at the side of the surface (air side) can be usually controlled by selecting the type of the discotic liquid crystalline molecules or an additive used together with the discotic liquid crystalline molecules. Examples of the additive used together with the discotic liquid crystalline molecules may include a plasticizer, a surfactant, a polymerizable monomer, and a polymer. The degree of the change in the alignment direction of the long axis can be also controlled by selection of the liquid crystalline molecules and the additive.

### <<Other Additives of Optically Anisotropic Layer>>

A plasticizer, a surfactant, and a polymerizable monomer are added together with the liquid crystalline compound such that the uniformity of a coated film, the strength of the film and the alignment of the liquid crystal molecules can be improved. It is preferable that these additives are compatible with the liquid crystal molecules, do not change the tilt angle of the liquid crystalline molecules, and do not deteriorate the alignment.

The polymerizable monomer includes a radical polymerizable compound or a cation polymerizable compound. Preferably, the polymerizable monomer is a polyfunctional radical polymerizable monomer and is preferably copolymerizable with a liquid crystal compound containing a polymerizable group. For example, the polymerizable monomer is disclosed in the paragraphs [0018] to [0020] of JPA No. 2002-296423. The additive amount of the compound is usually in a range of 1 to 50% by mass and is preferably in a range of 5 to 30% by mass with respect to the discotic liquid crystalline molecules.

As the surfactant, a known compound may be used, and more particularly a fluorine-based compound is preferable. Specifically, the surfactant is disclosed in the paragraphs [0028] to [0056] of JPA No. 2001-330725.

It is preferable that the polymer which is used together with the discotic liquid crystalline molecules changes the tilt angle of the discotic liquid crystalline molecules.

An example of the polymer may be cellulose ester. A preferred example of the cellulose ester is disclosed in the paragraph [0178] of JPA No. 2000-155216. In order to prevent the alignment of the liquid crystalline molecules from deteriorating, the additive amount of the polymer is preferably in a range of 0.1 to 10% bymass, andmore preferably in a range of 0.1 to 8% by mass for the liquid crystalline molecules. A discotic nematic liquid crystalline phase-solid phase transition temperature of the discotic liquid crystalline molecules is preferably in a range of 70 to 300° C. and is more preferably in a range of 70 to 170° C.

### <<Formation of Optically Anisotropic Layer>>

The optically anisotropic layer may be produced by preparing a composition containing a liquid crystalline compound, and if necessary, a polymerizable initiator or any additive on an alignment film.

The composition may be prepared as a coating liquid. The solvent which is used for preparing the coating liquid is desirably selected from organic solvents. Examples of the organic solvent include amides such as N,N-dimethylformamide, sulfoxides such as dimethylsulfoxide, heterocyclic compounds such as pyridine, hydrocarbons such as benzene or hexane, alkyl halides such as chloroform or dichloromethane, esters such as methyl acetate or butyl acetate, ketones such as acetone or methylethyl ketone and ethers such as tetrahydrofuran or 1,2-dimethoxyethane. Among these, alkyl halide or ketones are preferred. Plural types of organic solvents may be used in combination.

The coating liquid may be applied to a surface according to various techniques (e.g., wire bar coating, extrusion coating, direct gravure coating, reverse gravure coating and die coating).

According to the present invention, the optically anisotropic layer desirably has a thickness of 0.1 to 20 micrometers, preferably of 0.5 to 15 micrometers, and more preferably of 1 to 10 micrometers.

### <<Fixing of Liquid-Crystalline Molecules in Alignment State>>

After being aligned in an alignment state, the liquid crystalline molecules may be fixed in the alignment state without disordering the state. Fixing is preferably carried out by the polymerization reaction of the polymerizable groups contained in the liquid-crystalline molecules. Examples of the polymerization reaction include thermal polymerization reactions using a thermal polymerization initiator and photo-polymerization reactions using a photo-polymerization initiator. Photo-polymerization reactions are preferred. Examples of photo-polymerization initiators include alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in Japanese Laid-Open Patent Publication (Tokkai) syo No. 60-105667 and U.S. Pat. No. 4,239,850) and oxadiazole compounds (described in U.S. Pat. No. 4,212,970).

The amount of the photo-polymerization initiators to be used is preferably 0.01 to 20%, more preferably 0.5 to 5% with respect to the mass of solids in the coating liquid.

Irradiation for polymerizing the liquid-crystalline molecules preferably uses UV rays. The irradiation energy is preferably 20 mJ/cm² to 50 J/cm², more preferably 20 to 5000 mJ/cm² and much more preferably 100 to 800 mJ/cm². Irradiation may be carried out under heating to accelerate the photo-polymerization reaction.

A protective layer may be formed on the optically anisotropic layer.

### <<Support>>

The support of the optical compensation sheet is preferably transparent, and is preferably formed of at least one polymer film. The transparent support may be made of a plurality of polymer films. In the optical anisotropy of the support, in more detail, it is preferable that an Re retardation value, as measured with light having a wavelength of 632.8 nm, is 10 to 70 nm, and an Rth retardation value, as measured with light having a wavelength 632.8 nm, is 50 to 400 nm. If two optical anisotropy polymer films are used in the liquid crystal display device, the Rth retardation value of one film is preferably 50 to 200 nm. If one optical anisotropy polymer film is used in the liquid crystal display device, the Rth retardation value of the film is preferably 70 to 400 nm.

An average value of the angles of slow axes of the polymer film is preferably 3° or less, more preferably 2° or less, and most preferably 1° or less. A direction of the average value of the angles of the slow axes is defined as an average direction of the slow axes. A standard deviation of the angles of the slow axes is preferably 1.5° or less, more preferably 0.8° or less, and most preferably 0.4° or less. The angle of the slow axis in the surface of the polymer film is defined as an angle between the slow axis and a reference line when the stretch direction of the polymer film is the reference line (0°). When the roll-type film is stretched in a width direction, the width direction is defined as the reference line and, when the film is stretched in a longitudinal direction, the longitudinal direction is defined as the reference line.

The polymer film preferably has light transmissivity of 80% or more. The polymer film preferably has a photoelastic coefficient of 60×10⁻¹² m²/N or less.

In the transmissive liquid crystal display device using the optical compensation sheet, “frame-like display unevenness” may be observed in a peripheral part of the screen when certain time passes after the display is applied with energized. The frame-like unevenness is attributable to an increase in transmittance at the peripheral part of the screen, and is significant especially in the black state. A transmissive liquid crystal display device, employing a backlight, is heated by the backlight, and has a temperature distribution in the plane of the liquid crystal cell. Variations of optical characteristics (retardation values and the angle of the slow axis) of the optical compensation sheet attributable to the temperature distribution are causes of the “frame-like display unevenness” on the screen. The variations in the optical characteristics of the optical compensation sheet are caused by elastic deformation of the optical compensation sheet which is attributable to the fact that expansion or contraction of the optical compensation sheet resulting from a temperature rise is suppressed by its adhesion to the liquid crystal cell or the polarizing plate.

In order to reduce “frame-like display unevenness” generated in the transmissive liquid crystal display device, a polymer film having a high thermal conductivity is preferably used as the transparent support of the optical compensation sheet. Examples of the polymer having a high thermal conductivity include a cellulose type polymer such as cellulose acetate (thermal conductivity (omitted in the below): 0.22 W/(mK)), a polyester type polymer such as polycarbonate (0.19 W/(mK)), and a cyclic olefin polymer such as a norbornene type polymer (0.20 W/(mK)).

As the polymer which is commercially available, norbornene-based polymer (ARTON manufactured by JSR Corporation, ZEONOR manufactured by ZEON Corporation, ZEONEX manufactured by ZEON Corporation) may be used. A polycarbonate-based copolymer is disclosed in JPA Nos. hei 10-176046 and 2001-253960.

The polymer film used as the support of the optical compensation sheet is preferably a cellulose polymer film, more preferably a cellulose ester film, and most preferably a film of lower fatty acid ester of cellulose. The low fatty acid is a fatty acid having 6 or less carbon atoms. The number of carbon atoms is preferably 2 (cellulose acetate), 3 (cellulose propionate), or 4 (cellulose butyrate). Mixed fatty acid ester such as cellulose acetate propionate and cellulose acetate butyrate may be used.

Specifically, cellulose acetate (cellulose diacetate or cellulose triacetate) is preferable. Cellulose triacetate having an acetic acid content of 59.0 to 61.5% is most preferable. The acetic acid content means the amount of acetic acid bonded per the unit mass of cellulose. The acetic acid content is determined according to the Measurement and Calculation of Acetylation Degree described in ASTM: D-817-91 (test methods of cellulose acetate, etc.).

The viscosity average degree of polymerization (DP) of the polymer is preferably 250 or more, and more preferably 290 or more. The polymer preferably has a narrow molecular weight distribution, Mm/Mn (wherein Mm is a mass average molecular weight, and Mn is a number average molecular weight), as measured by gel permeation chromatography. Specifically, the Mm/Mn value is preferably from 1.00 to 1.70, more preferably from 1.30 to 1.65, and most preferably from 1.40 to 1.60.

An aromatic compound having at least two aromatic rings may be used as a retardation increasing agent so as to adjust retardation of the polymer film.

In the case of using the cellulose acylate film as a polymer film, the aromatic compound is used in an amount of 0.01 to 20 parts by mass, preferably from 0.05 to 15 parts by mass, and more preferably from 0.1 to 10 parts by mass, per 100 parts by mass of the cellulose acetate. Two or more aromatic compounds may be used in combination.

The aromatic ring of the aromatic compound includes an aromatic hydrocarbon ring and an aromatic heterocyclic ring.

The molecular weight of the retardation increasing agent is preferably 300 to 800.

The retardation increasing agent is disclosed in JPA Nos. 2000-111914, 2000-275434, and 2001-166144, and International Patent Publication No. WO00/02619.

The polymer film is preferably produced by a solvent cast method. In the solvent cast method, the film is produced using a solution (dope) in which polymer is dissolved into an organic solvent. The organic solvent contains a solution selected from an ether having 2 to 12 carbon atoms, a ketone having 3 to 12 carbon atoms, an ester having 2 to 12 carbon atoms, and a halogenated hydrocarbon having 1 to 6 carbon atoms.

The ether, ketone, and ester may have a cyclic structure. A compound having at least two functional groups of the ether, ketone, and ester (that is, —O—, —CO—, and —COO—) may be used as the organic solvent. The organic solvent may have another functional group such as an alcoholic hydroxy group.

Examples of the ether may include diisopropyl ether, dimethoxymethane, dimethoxyethane, 1,4-dioxane, 1,3-dioxolane, tetrahydrofuran, anisole, and phenetole. Examples of the ketone may include acetone, methyl ethyl ketone, diethyl ketone, diisobutyl ketone, cyclohexanone, and methyl cyclohexanone. Examples of the ester may include ethyl formate, propyl formate, pentyl formate, methyl acetate, ethyl acetate, and pentyl acetate. Examples of the organic solvent having at least two functional groups may include 2-ethoxyethylacetate, 2-methoxyethanol, and 2-butoxyethanol. The halogenated hydrocarbon preferably has 1 or 2 carbon atoms, and more preferably 1 carbon atom. The halogen of the halogenated hydrocarbon is preferably chlorine. The ratio of substitution of hydrogen atoms of the halogenated hydrocarbon with halogen is preferably 25 to 75 mol %, more preferably 30 to 70 mol %, still more preferably 35 to 65 mol %, and most preferably 40 to 60 mol %. Methylene chloride is a representative halogenated hydrocarbon.

A mixture of at least two organic solvents may be used.

A polymer solution (dope) may be prepared by a common method. The common method means a treatment at a temperature of 0° C. or higher (at room temperature, or a higher temperature). The preparation of the solution may be performed using a method and apparatus for preparing a dope using an ordinary solvent cast method. In the common method, a halogenated hydrocarbon (more particularly, methylene chloride) is preferably used as the organic solvent. The amount of the polymer is adjusted such that it will be contained in the obtained solution in an amount of 10 to 40% by mass. The amount of polymer is more preferably 10 to 30% by mass. The below-described additive may be added to the organic solvent (main solvent). The solution may be prepared by stirring the polymer and the organic solvent at an ordinary temperature (0 to 40° C.). To obtain a solution of a higher concentration, the stirring may be carried out under a higher pressure and at a higher temperature. Specifically, the polymer and the organic solvent are enclosed in a pressure vessel and then stirred under a high pressure while being heated within a temperature range equal or higher than the boiling point of the solvent at an ordinary temperature and below the temperature at which the solvent will boil. The heating temperature is usually 40° C. or higher, preferably 60 to 200° C., and more preferably 80 to 110° C.

The ingredients may be roughly mixed before putting them in the vessel. Alternatively, the ingredients maybe put in the vessel in series. The vessel may be configured to allow the stirring to be performed. The vessel may be pressurized by injecting an inert gas such as nitrogen gas into the same. Alternatively, the pressurization may be carried out utilizing an increase in the vapor pressure of the solvent as a result of heating. The ingredients may alternatively be added under a pressure after the vessel is sealed.

In a case of performing the heating, the vessel is preferably heated from outside. For example, a jacket type heating apparatus may be used. Alternatively, a plate heater may be provided outside the vessel, and a tube may be provided to heat the vessel as a whole by circulating a liquid.

The stirring is preferably carried out using a stirring wing provided in the vessel. The stirring wing is preferably long enough to reach the neighborhood of the wall of the vessel. A scratching wing is preferably provided at the end of the stirring wing to new the solution in the form of a film remaining on the wall of the vessel.

The vessel may be provided with a meter such as a manometer or thermometer. The ingredients are dissolved into the solvent in the vessel. The dope thus prepared is taken out of the vessel after cooling. Alternatively, the dope may be cooled using a heat exchanger after taking it out.

The polymer solution (dope) may be prepared according to a cooling dissolution method. First, the polymer is gradually added to an organic solvent while stirring them at a temperature near room temperature (−10 to 40° C.). When a plurality of solvents is used, there is no particular limitation on the order in which they are added. For example, after adding the polymer to a main solvent, the remaining solvents (e.g., a gelatinized solvent of alcohol) may be added. Conversely, the main solvent may be added after wetting the polymer with the gelatinized solvent, which is advantageous in preventing non-uniform dissolution. The polymer is preferably prepared such that it will be included in the mixture in an amount of 10 to 40% by mass.

The amount of polymer is more preferably 10 to 30% bymass. Further, an arbitrary additive, which will be described later, may be added to the mixture.

The mixture is then cooled to a temperature in the range of −100 to −10° C. (preferably in the range of −80 to −10° C., further preferably in the range of −50 to −20° C., and much more preferably in the range of −50 to −30° C.). For example, the mixture may be cooled in a dry ice/methanol bath (−75° C.) or in a cooled diethylene glycol solution (−30 to −20° C.). The mixture of the polymer and the organic solvent is solidified by cooling it in such a manner. There is no particular limitation on the cooling rate. However, in the case of batch type cooling, since the viscosity of the polymer solution increases as cooling proceeds to reduce the efficiency of cooling, it is required to use a dissolving oven which can efficiently achieve a predetermined cooling temperature.

According to the cooling dissolution method, after the polymer solution is swelled, it may be transported in a short time in the cooling apparatus which has been cooled to a predetermined cooling temperature. Although the cooling rate is preferably as high as possible, there is a theoretical upper limit of 10000° C. per second, a technical upper limit of 1000° C. per second, and a practical upper limit of 100° C. per second. The cooling rate is a value obtained by dividing the difference between the temperature at which the cooling is started and the cooling temperature finally achieved by the time required to reach the final cooling temperature after starting the cooling. The mixture is warmed to a temperature in the range of 0 to 200° C. (more preferably in the range of 0 to 150° C., further preferably in the range of 0 to 120° C., and much more preferably in the range of 0 to 50° C.) to obtain a solution in which the polymer is mobile in the organic solvent. The mixture may be warmed by leaving it at room temperature or putting it in a hot bath.

A uniform solution is obtained as described above. When dissolution is insufficient, the cooling and warming operations may be repeated. It can be determined whether dissolution is sufficient or not simply by observing the solution with eyes. When the cooling dissolution method is used, it is desirable to use a sealed vessel to prevent contamination with moisture attributable to dew condensation during cooling. The dissolving time can be shortened by conducting cooling under a high pressure and conducting warming under a low pressure at the cooling and warming operations. It is desirable to use a pressure vessel to conduct the operations at high and low pressures.

When cellulose acylate (acetic acid content: 60.9%, viscosity average degree of polymerization: 299) is dissolved in methyl acetate using the cooling dissolution method to obtain a solution of 20 percent by mass, a pseudo phase transition point between sol and gel states exists at about 33° C. according to differential scanning calorimetry (DSC), and the solution is in a uniform gel state under the temperature. Therefore, the solution must be stored at a temperature equal to or higher than the pseudo phase transition temperature, preferably at a temperature that is about 10° C. higher than the pseudo phase transition temperature. The pseudo phase transition temperature depends on the acetic acid content of the cellulose acylate, the viscosity average degree of polymerization, the concentration of the solution, and the nature of the organic solvent used.

A polymer film is formed from the polymer solution (dope) thus prepared according to a solvent cast method. The retardation increasing agent is preferably added to the dope.

The dope is cast on a drum or band, and the solvent is evaporated to form a film. Prior to the casting, the concentration of the dope is preferably adjusted such that the solid content of the same is in the range of 10 to 40%, and more preferably in the range of 15 to 35%. The surface of the drum or band is preferably mirror-finished. Methods of casting and drying based on solvent casting are described in the specifications of U.S. Pat. Nos. 2,336,310, 2,367,603, 492,078, 2,492,977, 2,492,978, 2,607,704, 2,739,069, and 2,739,070, British Patent Nos. 640731 and 736892, Examined Japanese Patent Application (occasionally referred to as “JPB”) Nos. syo 45-4554 and syo 49-5614, JPA Nos. syo 60-176834, syo 60-203430, and syo 62-115035. The dope is preferably cast on a drum or band having a surface temperature of 40° C. or lower. After the casting, the dope is preferably dried by being exposed to a flow of air for 2 seconds or more. The film thus obtained is peeled off the drum or band, and the film may be further dried with hot air whose temperature is gradually changed from 100 to 160° C. to evaporate any residual solvent. Such a method is described in JPB No. hei 5-17844. The method makes it possible to shorten the time required for the process from casting up to peeling. In order to implement this method, the dope must be gelatinized by the surface temperature of the drum or band when the dope is cast.

A plurality of polymer solutions may be employed in the casting method.

When a plurality of polymer solutions are cast, the solutions including a polymer may be cast respectively from a plurality of casting holes provided at intervals in the transferring direction of the support to form layers one over another, whereby a film is fabricated (the method is described in JPA No. syo 61-158414, JPA No. hei 1-122419, and JPA No. hei 11-198285). A film can be also produced by casting polymer solutions from two casting holes (see JPB No. syo 60-27562, JPA No. syo 61-94724, JPA No. syo 61-947245, JPA No. syo 61-104813, JPA No. syo 61-158413, and JPA No. hei 6-134933). Further, a polymer film casting method may be employed, in which a flow of a highly viscous polymer solution is enclosed in a polymer solution having a lower viscosity and in which the polymer solutions of high and low viscosities are simultaneously extruded (the method is described in JPA No. syo 56-162617).

A method utilizing two casting holes may alternatively be implemented to fabricate a film, in which a film formed on a support using a first casting hole is peeled off and second casting is conducted on the side of the film which has been in contact with the surface of the support (the method is described in JPB No. syo 44-20235). The plurality of polymer solutions maybe identical in their nature. In order to provide a plurality of polymer layers with different functions, polymer solutions may be extruded from the respective casting holes according to the functions.

A polymer solution may be cast simultaneously with liquids applied to provide other functional layers (e.g., an adhesive layer, a dye layer, an anti-static layer, an anti-halation layer, a UV-absorbing layer, and a polarizing layer).

In the case of a single layer of liquid according to the related art, a polymer solution having high concentration and high viscosity must be extruded to achieve a film thickness that is required. In such a case, low stability of the polymer solution has frequently resulted in problems such as granular defects caused by the generation of solid particles and low planarity. As a solution to this, a plurality of polymer solutions may be cast from casting holes to extrude highly viscous solutions on a support simultaneously, which makes it possible to fabricate a high quality planar film having high planarity. Further, the use of a polymer solution of a high concentration allows the load of drying operation to be reduced and allows a film to be produced at a high speed.

A plasticizer may be added to the polymer film to improve the mechanical properties of the same and to improve the drying speed. A phosphoric ester or carboxylic ester is used as the plasticizer. Examples of such phosphoric esters include triphenyl phosphate (TPP) and tricresyl phosphate (TCP). Representative carboxylic esters are phthalic esters and citric esters. Examples of phthalic esters include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of citric esters include triethyl o-acetylcitrate (OACTE) and tributyl o-acetylcitrate (OACTB). Examples of other carboxylic esters include butyl oleate, methylacetyl ricinoleate, dibutyl sebacate, and various trimellitic esters. Phthalic ester type plasticizers (DMP, DEP, DBP, DOP, DPP, and DEHP) are preferably used. In particular, DEP and DPP are preferred.

The additive amount of a plasticizer is preferably 0.1 to 25 percent by mass, more preferably 1 to 20 percent by mass, and much more preferably 3 to 15 percent by mass with respect to the weight of the polymer.

A deterioration inhibitor (e.g., an antioxidizing agent, peroxide decomposer, radical inhibitor, metal inactivating agent, oxygen scavenger, or amine) may be added to the polymer film. Deterioration inhibitors are described in JPA Nos. hei 3-199201, hei 5-1907073, hei 5-194789, hei 5-271471, and hei 6-107854. The additive amount of the deterioration inhibitor is preferably 0.01 to 1 percent by mass, and more preferably 0.01 to 0.2 percent by mass of the solution (dope) to be prepared. When the additive amount is less than 0.01 percent by mass, the effect of the deterioration inhibitor is substantially unrecognizable. When the additive amount is in the excess of 1 percent by mass, the deterioration inhibitor may bleed out on the surface of the film. Butylated hydroxytoluene (BHT) and tribenzylamine (TBA) are particularly preferable deterioration inhibitors.

The polymer film thus produced may further be subjected to a stretching process to adjust retardation of the same. A preferable stretching rate is in the range of 3 to 100%. After the stretching, the thickness of the polymer film is preferably 20 to 200 μm and more preferably 30 to 100 μm. The standard deviation of the angle of the slow axis of the optical compensation sheet can be reduced by adjusting the stretching conditions. The stretching process may be conducted using a tenter. When a film produced according to a solvent cast method is laterally stretched using a tenter, the standard deviation of the angle of slow axis of the film can be reduced by controlling the condition of the film after stretching the same. Specifically, a stretching process is performed to adjust a retardation value of the film using a tenter. Immediately after the stretching, the polymer film is kept stretched at a rate between the maximum stretching rate and a stretching rate that is one-half of the maximum stretching rate at a temperature near the glass transition temperature of the film, which allows the standard deviation of the angle of slow axis to be reduced. When the film is held at a temperature lower than the glass transition temperature, the standard deviation increases.

When the film is longitudinally stretched between rolls, the standard deviation of the slow axis can be also reduced by increasing the distance between the rolls.

When the polymer film is to serve as a transparent protective film for a polarizing film in addition to the function provided by the film as a transparent support of an optical compensation sheet, a surface treatment is preferably performed on the polymer film.

As the surface treatment, a corona discharge treatment, glow discharge treatment, flame treatment, acid treatment, alkali treatment, or ultraviolet irradiation treatment is conducted. An acid treatment or alkali treatment is preferable, and an alkali treatment is more preferable. When the polymer is cellulose acylate, the acid treatment or alkali treatment may be conducted as a saponification treatment on the cellulose acylate.

### <<Alignment Layer>>

For aligning liquid-crystalline molecules in the optically anisotropic layer, an alignment layer is desirably used. The alignment layer is employed for controlling the alignment of liquid crystal molecules. Preferably, the surface of the alignment layer is subjected to a rubbing treatment. A coating liquid comprising a liquid crystal compound is applied to a rubbing surface, and dried; and then liquid crystal molecules are aligned depending on the rubbing axis.

However, according to the present invention, an alignment layer is not an essential element after fixing liquid-crystalline molecules because the molecules fixed in an alignment state once can keep the alignment without an alignment layer. Thus, after an optically anisotropic layer is formed on an alignment layer, only the optically anisotropic layer may be transferred from on the alignment layer to on a support, and in such case, the alignment layer is absent.

The alignment layer that can be employed in the present invention may be provided by rubbing a layer formed of an organic compound (preferably a polymer), oblique vapor deposition, the formation of a layer with microgrooves, or the deposition of organic compounds (for example, omega-tricosanoic acid, dioctadecyl methylammonium chloride, and methyl stearate) by the Langmuir-Blodgett (LB) film method. Further, alignment layers imparted with orientation functions by exposure to an electric or magnetic field or irradiation with light are also known.

The alignment layers formed by rubbing polymer layers are particularly desirable. The polymers used for preparing the alignment layers may basically have a molecular structure capable of aligning liquid-crystalline molecules. According to the present invention, the polymer is desirably selected from polymers having such a molecular structure and further having a structural feature in which a main chain bounds to side chains containing a crosslinkable group (such as a double bonding); or polymers having a structural feature in which a main chain bounds to side chains containing a crosslinkable function group capable of aligning liquid-crystalline molecules. The polymers may be selected from polymers capable crosslinking themselves or polymers to be crosslinked by any crosslinkable agent, and such polymers may be used in any combination.

Examples of the polymer used for preparing an alignment layer include methacrylate copolymers described in the column [0022] in JPA No. hei 8-338913, styrene copolymers, polyolefins, polyvinyl alcohols, modified polyvinyl alcohols, poly(N-methylol acrylamide), polyesters, polyimides, vinyl acetate copolymers, carboxymethylcelluloses and polycarbonates. Silane coupling agents are also used as a polymer. Water-soluble polymers such as poly(N- methylol acrylamide), carboxymethylcelluloses, gelatins, polyvinyl alcohols or modified polyvinyl alcohols are preferred; gelatins, polyvinyl alcohols and modified polyvinyl alcohols are more preferred; and polyvinyl alcohols and modified polyvinyl alcohols are much more preferred. Using plural polyvinyl alcohols or modified polyvinyl alcohols, they have a different polymerization degree each other, is especially preferred.

The saponification degree of the polyvinyl alcohol is desirably from 70 to 100%, and more desirably from 80 to 100%. The polymerization degree of the polyvinyl alcohol is desirably from 100 to 5000.

In usual, the side chain having a function capable of aligning discotic liquid-crystalline molecules may have a hydrophobic group as a function group. The types of the function group may be decided depending on various factors such as types of the liquid-crystalline compounds or desired alignment state. For example, the modified group can be introduced into the polyvinyl alcohol by copolymerization modification, chain-transfer modification or bloc-polymerization modification. Examples of the modified group include hydrophilic groups such as a carboxylic acid group, a sulfonic acid group, a phosphoric acid group, an amino group, an ammonium group, an amide group or a thiol group; C₁₀₋₁₀₀ hydrocarbon groups; hydrocarbon groups substituted with fluorine atoms; thioether groups, polymerizable groups such as an unsaturated polymerizable group, an epoxy group or an aziridile group; and alkoxysilyl groups such as tri-, di- or mono-alkoxysilyl group. Specific examples of such modified polyvinyl alcohols include those described in the columns [0022] to [0145] in JPA No. 2000-155216 and those described in the columns [0018] to [0022] in JPA No. 2002-62426.

It is possible to copolymerize a polymer in an alignment layer and a multi-functional monomer in an optically anisotropic layer, when the polymer in the alignment layer has a main chain bonding to side chains containing a crosslinkable functional group, or the polymer in the alignment layer has side chain being capable of aligning liquid-crystalline molecules and containing a crosslinkable functional group. In such case, not only between the multi-functional monomers but also between the polymers in the alignment layer and the multi-functional monomers and the polymers in the alignment layer, the covalent bonds are formed and the bonding strengths are improved. Thus, in such case, the strength of the optical compensation film can be remarkably improved.

The polymer in the alignment layer desirably has crosslinkable functional group containing a polymerizable group. Specific examples include those described in the columns of [0080] to [0100] in JPA No. 2000-155216. The polymer in the alignment layer may be crosslinked by a crosslinkable agent. Examples of the crosslinkable agent include aldehydes, N-methylol compounds, dioxane derivatives, compounds to act when being activated their carboxyl groups, active vinyl compounds, active halogen compounds, isoxazoles and dialdehyde starches. Single or plural type of crosslinkable agents may be used. Specific examples of the crosslinkable agent include the compounds described in the columns [0023] to [0024] in JPA No. 2002-62426. Aldehydes having a high reaction-activity are preferred, and glutaraldehydes are more preferred.

The amount of the crosslinkable agent is desirable from 0.1 to 20 mass %, and more desirably 0.5 to 15 mass %, with respect to the mass of the polymer. The residual amount of the unreacted crosslinkable-agent in the alignment layer is desirably not greater than 1.0 mass %, and more desirably not greater than 0.5 mass %. When the residual amount falls with in the range, the alignment layer has a sufficient durability, and even if the alignment is used in a liquid-crystal display for a long time, or is left under a high temperature and humidity atmosphere for a long time, no reticulation is appeared in the alignment layer.

The alignment layer may be prepared by applying a coating fluid, containing the above polymer, and, if necessary, the crosslinkable agent, to a surface of a support, drying under heating (crosslinking), and performing a rubbing treatment. The crosslinking reaction maybe carried out any time after applying the coating fluid to a surface. When a hydrophilic polymer such as polyvinyl alcohol is used for preparation of an alignment layer, the coating fluid is desirably prepared using a mixed solvent of an organic solvent such as methanol, exhibiting a deforming function, and water. The weight ratio of water to methanol is desirably from 0/100 to 99/1, and more desirably from 0/100 to 91/9. Using such a mixed solvent can prevent bubbles from generating, and can remarkably reduce defects in the surface of the alignment layer and the optically anisotropic layer.

The coating liquid may be applied by any known method such as a spin-coating method, a dip coating method, a curtain coating method, extrusion coating method, rod coating method, or roll coating method. The rod coating method is especially preferred. The thickness of the alignment layer after being dried is desirably from 0.1 to 10 micrometers. Drying may be carried out at 20 to 110° C. In order to form sufficient crosslinking, drying is desirably carried out at 60 to 100° C., and more desirably at 80 to 100° C. The drying may be continued for 1 minute to 36 hours, and desirably for 1 minute to 30 minutes. The pH is desirably set in a proper range for a crosslinkable agent to be used, and when glutaraldehyde is used, the pH is desirably set in a range from 4.5 to 5.5, and more desirably 5.

The alignment layer may be formed on a surface of a support such as a polymer film or a surface of an under coating layer which is optionally formed on a support. The alignment layer can be obtained by applying a rubbing treatment to the surface of the polymer layer after crosslinking the polymer layer.

The rubbing treatment may be carried out according to any known treatment used in a liquid-crystal alignment step of LCD. For example, the rubbing treatment may be carried out by rubbing the surface of a polymer layer with a paper, a gauze, a felt, a rubber, a nylon fiber, polyester fiber or the like in a direction. Usually, the rubbing treatment may be carried out by rubbing a polymer layer with a fabric in which fibers having a uniform length and line thickness are implanted averagely at several times.

Next, the liquid-crystalline molecules are aligned on the alignment layer. After that, if necessary, the reaction between the polymers in the alignment layer and the multi-functional monomers in the optical compensatory film may be carried out, or the crosslinking reaction of the polymers in the alignment layer with a crosslinkable agent may be carried out.

The thickness of the alignment layer is desirably from 0.1 to 10 micrometers.

[First and Second Optically Anisotropic Layers used in First Aspect of VA Mode Liquid Crystal Display Device]

As described above, if the present invention is applied to the VA mode liquid crystal display device, a first optically anisotropic layer which satisfies Relations (III) and (IV) and more preferably Relations (III) to (VII) and a second optically anisotropic layer which satisfies Relations (VIII) and (IX) and more preferably Relations (X) to (XIII) are preferably used. If the first and second optically anisotropic layers are polymer films, the first and second optically anisotropic layers are attached with polarizers. As an independent member, for example, an optical compensation film may be provided in a liquid crystal display device. As the material of the polymer films, a polymer which is excellent in optical capability, transparency, mechanical strength, thermal stability, moisture shielding property and isotropy is preferable, but any material may be used if the above-described condition is satisfied. For example, a polycarbonate-based polymer, a polyester-based polymer such as polyethylene terephthalate or polyethylene naphthalate, an acrylic-based polymer such as polymethylmethacrylate, or a styrene-based polymer such as polystyrene or an acrylonitrile-styrene copolymer (AS resin) maybe used. Polyolefin such as polyethylene or polypropylene, a polyolefin-based polymer such as an ethylene-propylene copolymer, a vinyl chloride-based polymer, an amide-based polymer such as nylon or aromatic polyamide, an imide-based polymer, a sulfone-based polymer, a polyether sulfone-based polymer, polyetherether ketone-based polymer, a polyphenylensulfide-based polymer, a vinylidene chloride-based polymer, a vinyl alcohol-based polymer, a vinyl butyral-based polymer, an acrylate-based polymer, a polyoxymethylene-based polymer, an epoxy-based polymer, or a polymer containing a mixture of the above polymers may be used.

As the material for forming the polymer film, thermoplastic norbornene-based resin may be preferably used. As the thermoplastic norbornene-based resin, ARTON manufactured by JSR Corporation and ZEONOR and ZEONEX manufactured by ZEON Corporation may be used.

As the material for forming the polymer film, a cellulose polymer (hereinafter referred to as cellulose acylate) which has been used as a transparent protective film of a conventional polarizing plate) may be preferably used. A representative example of cellulose acylate is triacetyl cellulose. A cellulose as a raw material for cellulose acylate is a cotton linter, a wood pulp (a needle leaf tree pulp or a broad leaf tree pulp), or the like. Cellulose acylate obtained from any raw material cellulose can be used. A plurality of raw material celluloses may be mixed as required. The raw material cellulose described in, for example, Maruzawa & Uda, Plastic Material Lecture (17) Cellulosic Resin, by Nikkan Kogyo Shinbun (1970); and Hatsumei Kyokai's Disclosure Bulletin No. 2001-1745 (pp. 7-8), can be used. There is no specific limitation on the raw material for the cellulose acylate film.

The cellulose acylate film for the first and second optically anisotropic layers is preferably composed of a composition containing cellulose acylate having at least two substitution groups. Preferred examples of cellulose acylate include mixed fatty acid ester of which an acylation degree is 2 to 2.9, and the carbon number of an acetyl group is 3 to 4. The acylation degree of the mixed fatty acid ester is more preferably 2.2 to 2.85 and still more 2.4 to 2.8. The acylation degree is preferably less than 2.5 and is more preferably less than 1.9. In a fatty acid ester residue, the aliphatic acyl group preferably contains 2 to 20 carbon atoms. Examples of the aliphatic acyl group include acetyl, propionyl, butyryl, isobutyryl, valeryl, pivaloyl, hexanoyl, octanoyl, lauroyl, and stearoyl. Preferred of them are acetyl, propionyl, and butyryl.

The cellulose acylate may be a mixed acid ester with a substituted or non-substituted aromatic acyl group, and a fatty acid acyl group.

A substitution degree of the aromatic acyl group is preferably 2.0 or less, and more preferably 0.1 to 2.0, with respect to a residual hydroxyl group in a case of cellulose fatty acid monoester, and is preferably 1.0 or less, and more preferably 0.1 to 1.0, with respect to a residual hydroxyl group in a case of a cellulose fatty acid diester (cellulose diacetate).

The cellulose acylate has preferably a mass average degree of polymerization of 350 to 800, and more preferably a mass average degree of polymerization of 370 to 600. The cellulose acylate used in the present invention has preferably an average molecular weight of 70000 to 230000, more preferably 75000 to 230000, and still more preferably 78000 to 120000.

The cellulose acylate can be synthesized using an acid anhydride or an acid chloride as an acylation agent. In a synthesizing method which is most general in the industry, the cellulose obtained from cotton linter or wood pulp is esterified to a mixed organic acid component containing an organic acid (acetic acid, propionic acid, or butyric acid) corresponding to other acyl groups and an acetyl group, or acid anhydride (acetic acid anhydride, propionic acid anhydride, or butyric acid anhydride) to synthesize the cellulose ester.

The cellulose acylate film is preferably produced by a solvent cast method. Examples of preparation of the cellulose acylate film using the solvent cast method may include U.S. Pat. Nos. 2,336,310, 2,367,603, 2,492,078, 2,492,977, 2,492,978, 2,607,704, 2,739,069, and 2,739,070, British Patent Nos. 640731 and 736892, JPB Nos. syo 45-4554 and syo 49-5614, and JPA Nos. syo 60-176834, syo 60-203430, and syo 62-115035. The cellulose acylate film may be stretched. A method of stretching the cellulose acylate film and the condition thereof are disclosed in JPA Nos. syo 62-115035, hei 4-152125, hei 4-284211, hei 4-298310, and hei 11-48271.

### <<Rth Enhancer>>

In order to prepare a cellulose acylate film which satisfies the condition of the first optically anisotropic layer, an Rth enhancer is preferably added to the cellulose acylate film. Here, the Rth enhancer is a compound having a property which enhances in-thickness-direction birefringence of the film.

As the Rth enhancer, a compound having large polarizability anisotropy having an absorption maximum in a wavelength range of 250 nm to 380 nm is preferred. The compounds represented by the formula (I) are preferably used as the Rth enhancer.

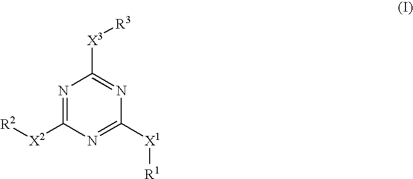

In the formula, X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, I-(1) to IV-(10), of the compound represented by the formula (I) include, but are not limited to, those shown below.

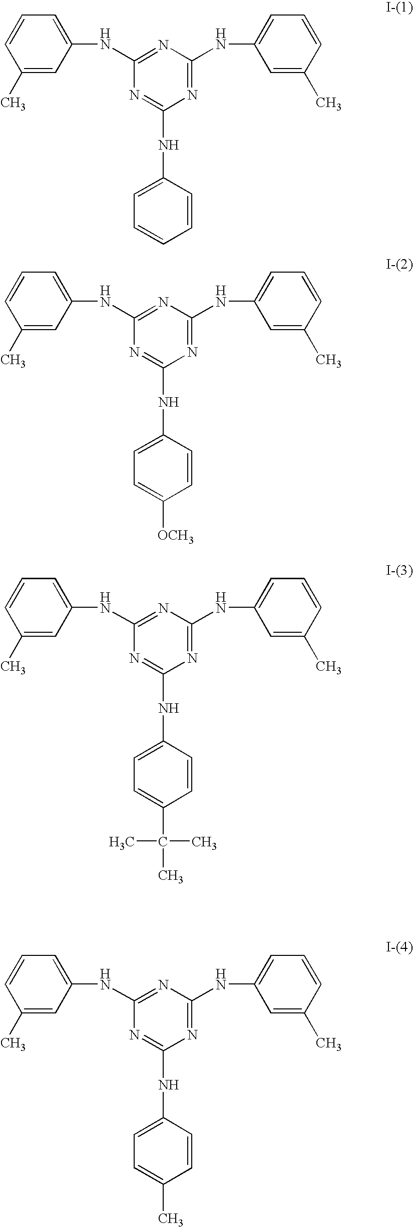

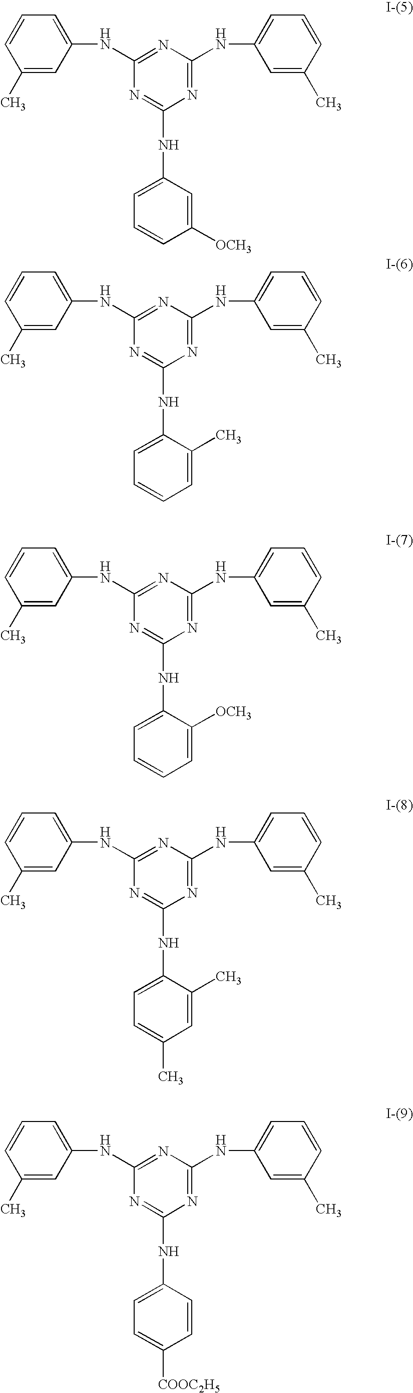

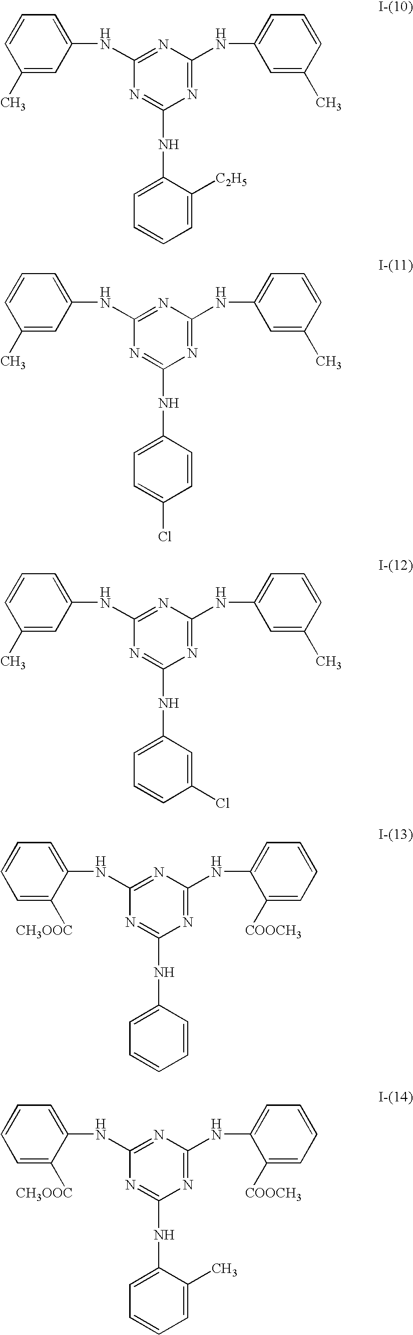

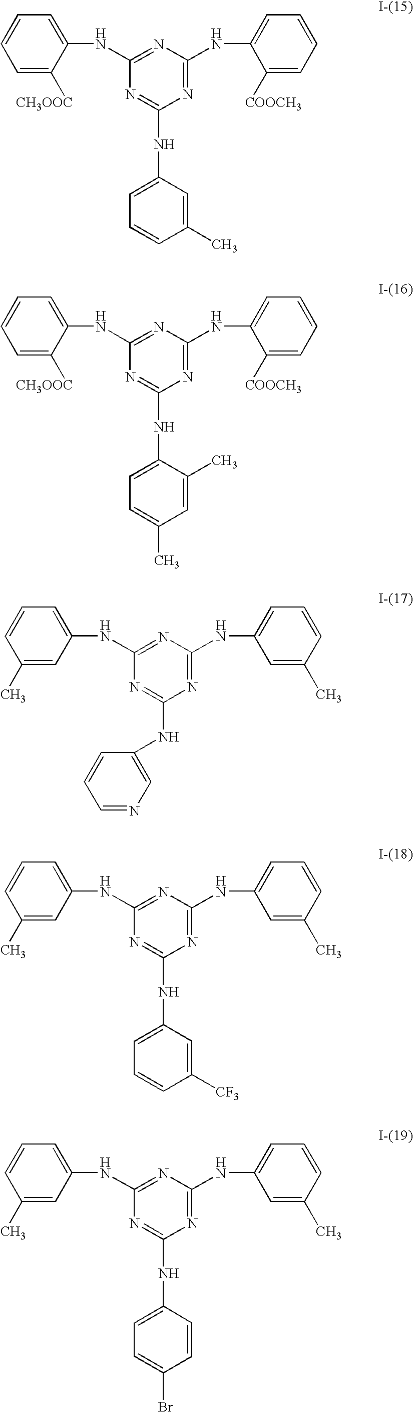

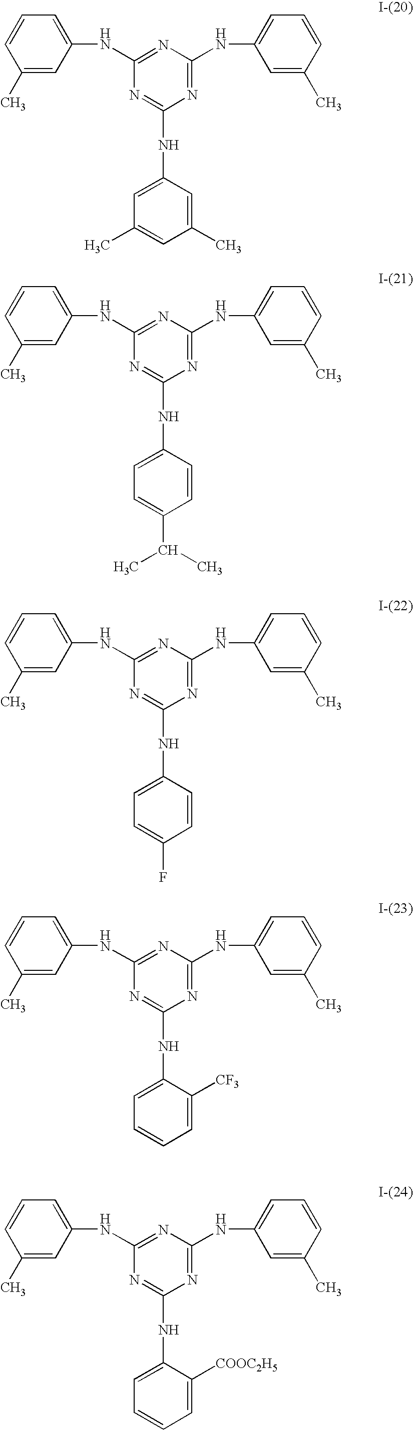

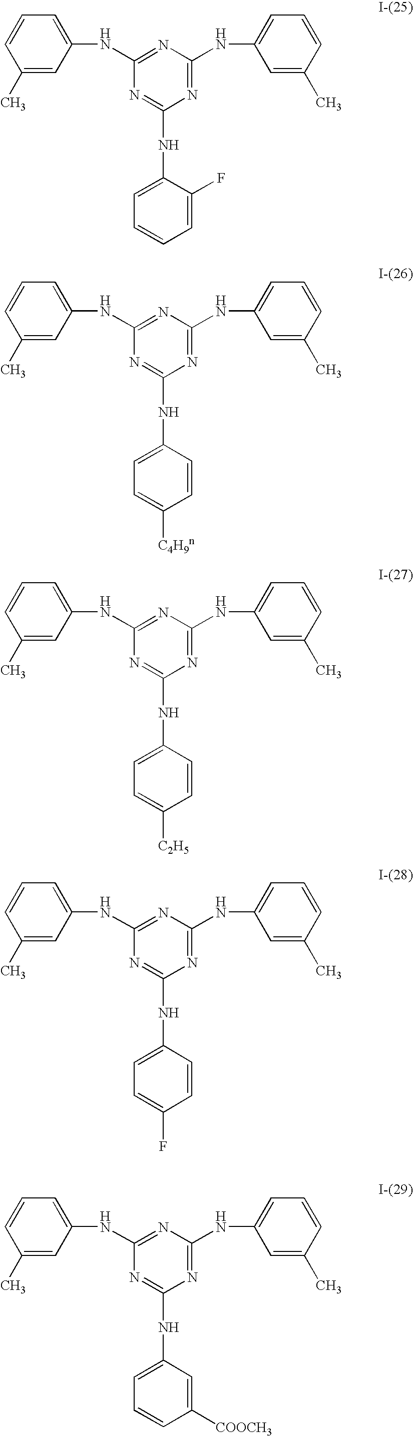

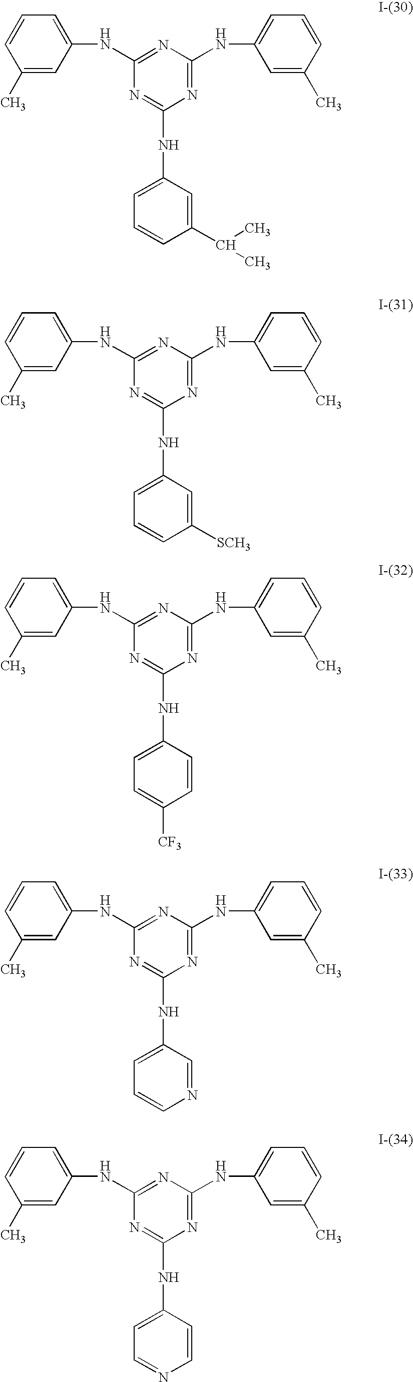

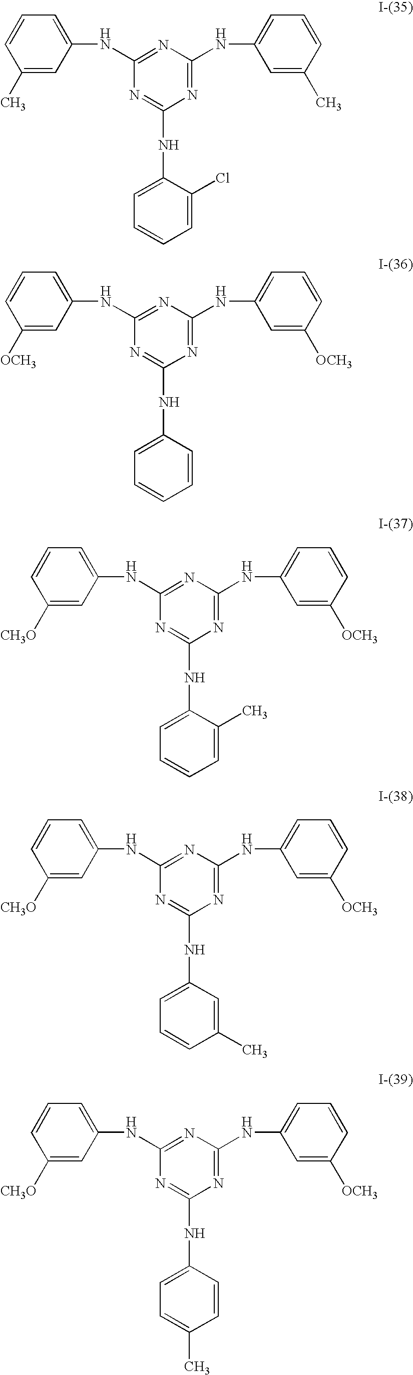

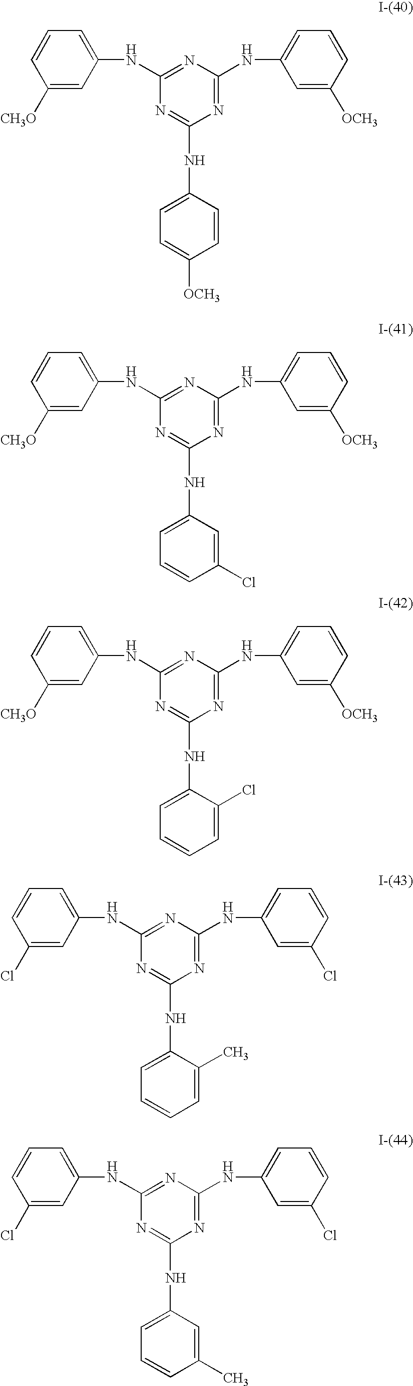

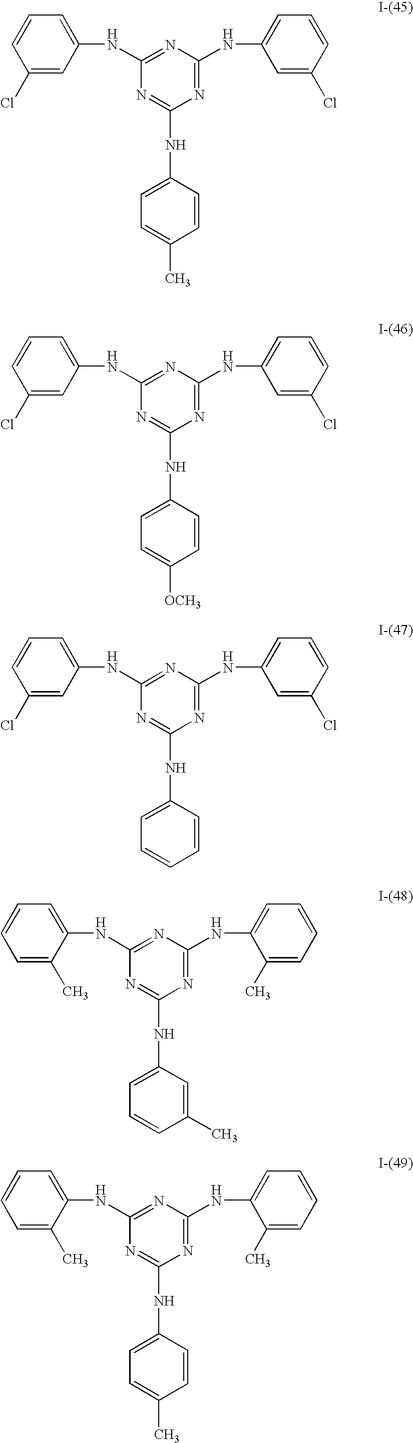

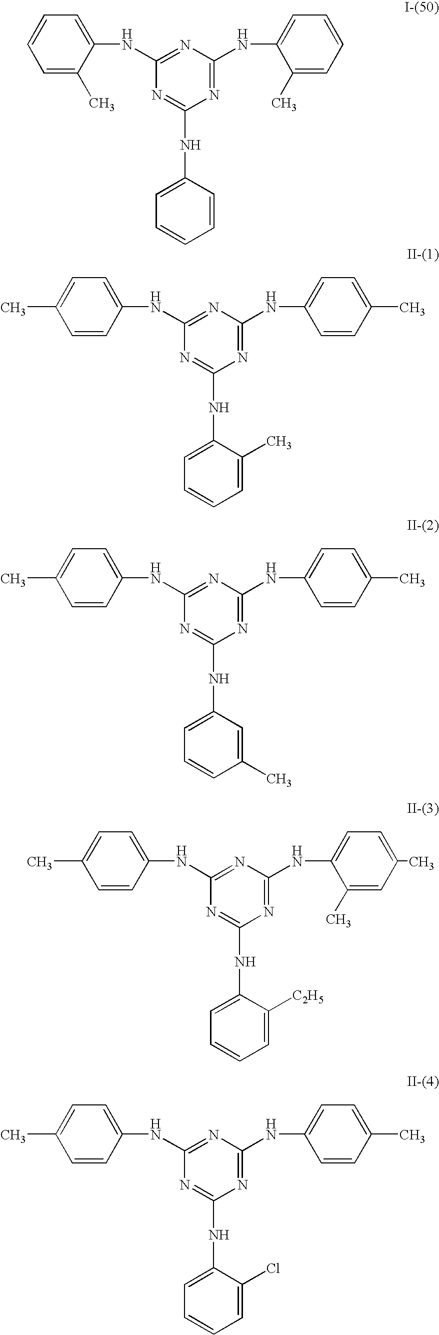

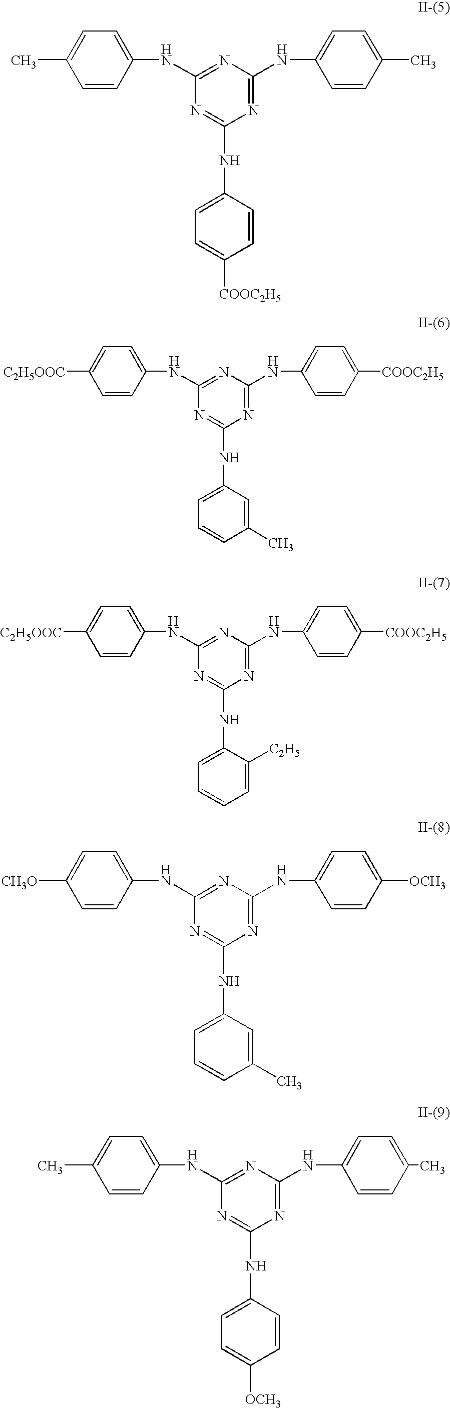

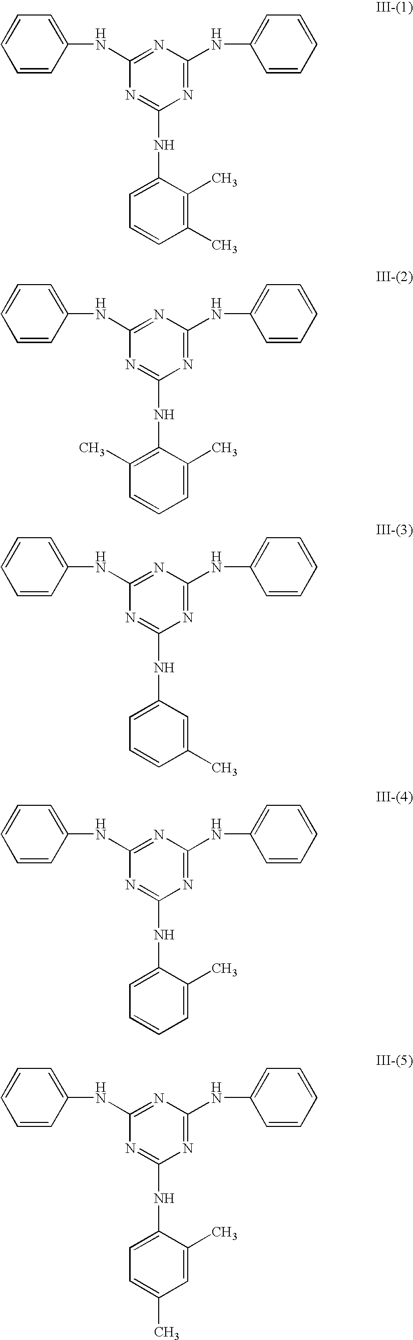

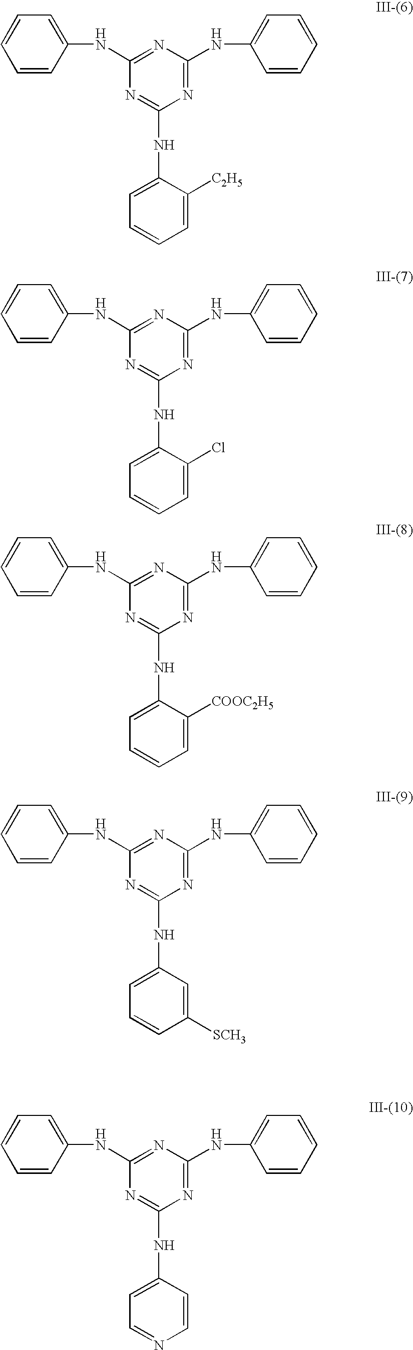

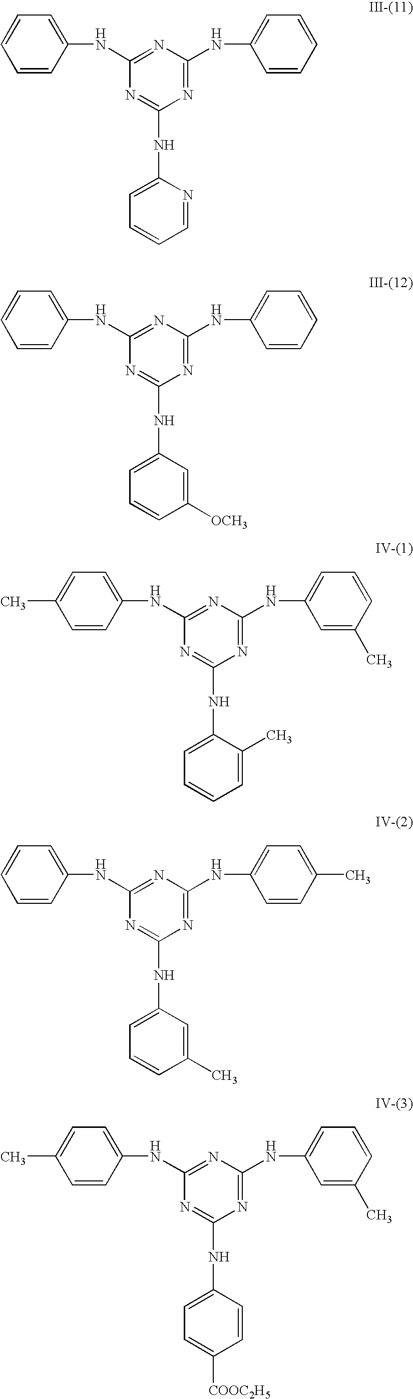

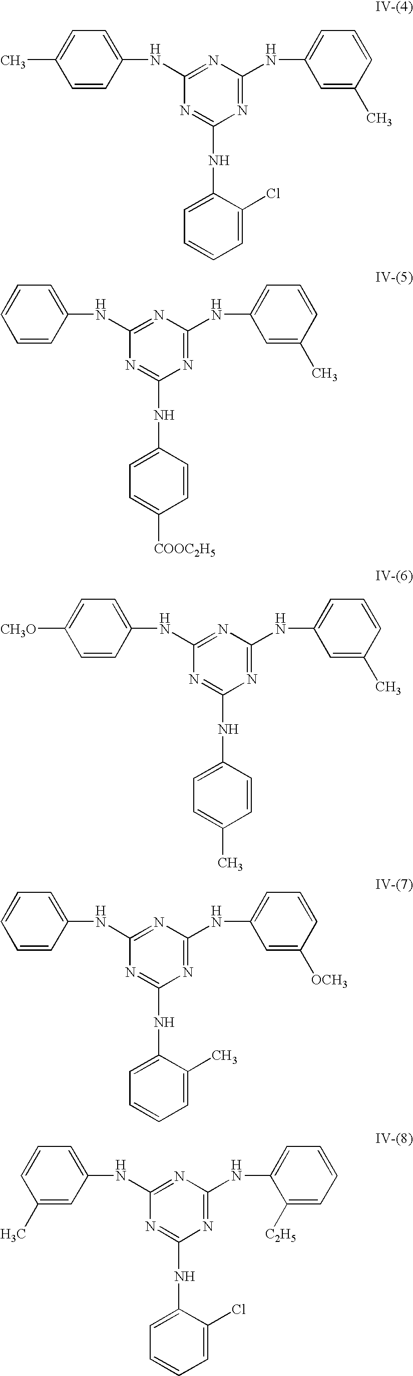

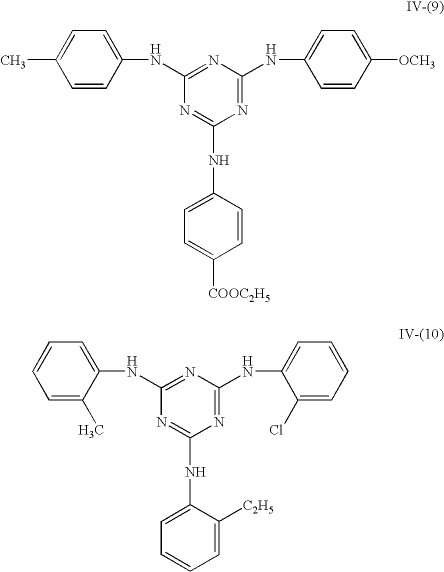

The compounds represented by the formula (III) are also preferable as the Rth enhancer. The formula (III) will be described in detail.

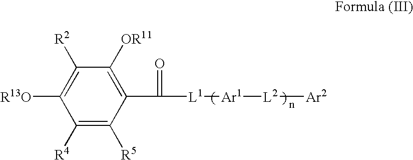

In the formula (III), R², R⁴ and R⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other. R¹¹ and R¹³ are different from each other, and the alkyl group represented by R¹³ doesn't include any hetero atoms.

In the formula (III), R², R⁴and R⁵respectively represent a hydrogen atom or a substituent. The substituent may be selected from Substituent Group T described later.

In the formula (III), R² preferably represents a hydrogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₋₈, the more preferred is C₁₋₆ and the specially preferred is C₁₋₄) alkoxy group; further much more preferably a hydrogen atom, a C₁₋₄ alkyl group or a C₁₋₄ alkoxy group; especially preferably a hydrogen atom, methyl or methoxy; and most preferably a hydrogen atom.

In the formula (III), R⁴ preferably represents a hydrogen atom or an electron donating substituent; more preferably a hydrogen atom, an alkyl group, an alkoxy group, an amino group or hydroxy; much more preferably a hydrogen atom, a C₁₋₄ alkyl group or a C₁₋₁₂ (the preferred is C₁₋₈, the more preferred is C₁₋₆ and the especially preferred is C₁₋₄) alkoxy group; and especially preferably a hydrogen atom, a C₁₋₄ alkyl group or a C₁₋₄ alkoxy group; and most preferably a hydrogen atom or methoxy.

In the formula (III), R⁵ preferably represents a hydrogen atom, a halogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₋₈, the more preferred is C₁₋₆ and the especially preferred is C₁₋₄) alkoxy group; especially preferably a hydrogen atom, methyl or methoxy; and most preferably a hydrogen atom.

In the formula (III), R¹¹ and R¹³ respectively represent a hydrogen atom or an alkyl group, provided that R¹¹ and R¹³ are different from each other and the alkyl group represented by R¹³ doesn't include any hetero atoms. The term “hetero atom” is used for any atoms other than hydrogen and carbon atoms and examples of the hetero atom include oxygen, nitrogen, sulfur, phosphorus, halogen (F, Cl, Br, I) and boron atoms.

The alkyl group represented R¹¹ or R¹³ may have a linear or branched chain structure or a cyclic structure, and be selected from not only non-substituted alkyl groups but also substituted alkyl groups. The alkyl group is preferably selected from substituted or non-substituted C₁₋₃₀ alkyl groups, substituted or non-substituted C₃₋₃₀ cycloalkyl groups, substituted or non-substituted C₅₋₃₀ bicycloalkyl groups, namely monovalent groups made of C₅₋₃₀ bicycloalkanes by removing a hydrogen atom therefrom, and tricycloalkyl groups.

Preferable examples of the alkyl group represented by R¹¹ or R¹³ include methyl, ethyl, n-propyl, isopropyl, n-butyl, sec-butyl, n-pentyl, iso-pentyl, n-hexyl, n-heptyl, n-octyl, tert-octyl, 2-ethylhexyl, n-nonyl, 1,1,3-trimethyl hexyl, n-decyl, 2-hexyldecyl, cyclohexyl, cycloheptyl, 2-hexenyl, oleyl, linoleyl, and linolenil. Examples of the cycloalkyl group include cyclohexyl, cyclopentyl, 4-n-dodecylcyclohexy; and examples of the bicycloalkyl group include bicyclo[1,2,2]heptane-2-yl and bicyclo[2,2,2]octane-3-yl.

R¹¹ preferably represents a hydrogen atom, methyl, ethyl, n-propyl or iso-propyl; and more preferably a hydrogen atom or methyl; and most preferably methyl.

R¹³ preferably represents a C₂ or longer alkyl group, and more preferably a C₃ or longer alkyl group. Among theses, branched or cyclic alkyl groups are preferred.

Specific examples (O-1 to O-20) of the alkyl group represented by R¹³ include, but are not limited to, those shown below. It is noted that “#” means the position of the oxygen atom side.

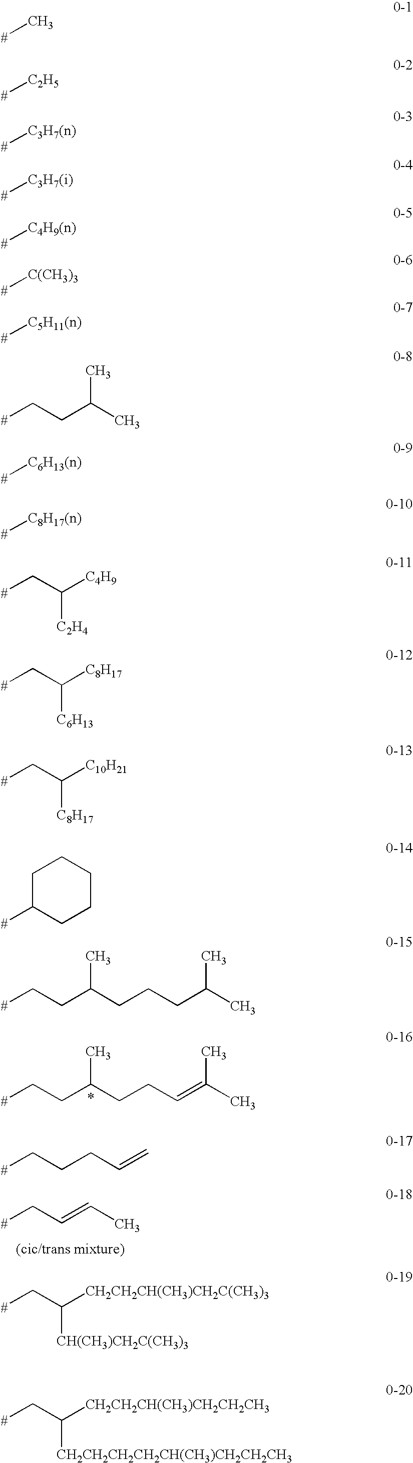

In the formula (III), Ar¹ represents an arylene group or an aromatic heterocyclic group and Ar¹ in each repeating unit may be same or different.

In the formula (III), Ar² represents an aryl group or an aromatic heterocyclic group.

The arylene group presented by Ar¹ in the formula (III) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar¹ is preferably selected from C₆₋₂₀, more preferably C₆₋₁₂ arylene groups, such as phenylene, p-methylphenylen and naphtylene.

The arylene group presented by Ar² in the formula (III) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar²is preferably selected from C₆₋₂₀, more preferably C₆₋₁₂ arylene groups, such as phenylene, p-methylphenylen and naphtylene.

The aromatic heterocyclic group represented by Ar¹ or Ar² in the formula (III) may be selected from the groups of aromatic rings in which at least one hetero atom selected from oxygen, nitrogen and sulfur atoms is embedded, and is preferably selected from the groups of 5- or 6-membered aromatic rings in which at least one of a nitrogen and sulfur atoms is embedded. The aromatic heterocyclic group may have at least one substituent. The substituent may be selected from Substituent Group T.

Examples of the aromatic heterocyclic group represented by Ar¹ or Ar² in the formula (III) include furan, pyrrole, thiophene, imidazole, pyrazole, pyridine, pyrazine, pyridazine, triazole, triazine, indole, indazole, purine, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenadine, tetrazole, benzimidazole, benzoxazole, benzthiazole, benztriazole, tetraza indeline, pyrrolotriazole and pyrazotriazole. Preferred examples of the aromatic heterocyclic group include benzimidazole, benzoxazole, benzthiazole and benztriazole.

In the formula (III), L¹ and L² independently represent a single bond or a bivalent linking group. L¹ and L² may be same or different from each other. And L² in each repeating unit may be same or different from each other.

The bivalent linking group is preferably selected from the group consisting of —O—, —NR— (R represents a hydrogen atom or a substituted or non-substituted alkyl or aryl group), —CO—, —SO₂—, —S—, an alkylene group, a substituted alkylene group, an alkenylene group, a substituted alkenylene group, an alkynylene group, a substituted alkynylene group and any combinations of tow or more selected therefrom; and more preferably from the group consisting of —O—, —NR—, —CO—, —SO₂NR—, —NRSO₂—, —CONR—, —NRCO—, —COO—, —OCO— and an alkynylene group. Preferably, R represents a hydrogen atom.

In the compound represented by the formula (III), Ar¹ binds to L¹ and L². For the compound having a phenylene as Ar¹, it is preferable that L¹-Ar¹-L² and L²-Ar¹-L² are in a para-position (1,4-position) relation.

In the formula (III), n is an integer equal to or more than 3, preferably from 3 to 7, more preferably from 3 to 6 and much more preferably from 3 to 5.

Preferable examples of the formula (III) include the compounds represented by the formula (IV) and formula (V) shown below.

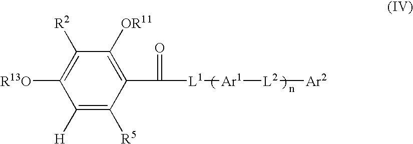

In the formula (IV), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (IV), the meanings of R², R⁵, R¹¹ and R¹³ are same as those in the formula (III); and preferred examples of R², R⁵, R¹¹ and R¹³ are same as those in the formula (III). In the formula (IV), the meanings of L¹, L², Ar¹ and Ar² are same as those in the formula (III); and preferred examples of L¹, L², Ar¹ and Ar² are same as those in the formula (III).

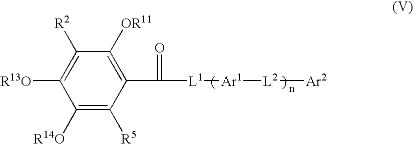

In the formula (V), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V), the meanings of R², R⁵, R¹¹ and R¹³ are same as those in the formula (III); and preferred examples of R², R⁵, R¹¹ and R¹³ are same as those in the formula (III). In the formula (V), the meanings of L¹, L², Ar¹ and Ar² are same as those in the formula (III); and preferred examples of L¹, L², Ar¹ and Ar² are same as those in the formula (III).

In the formula (V), R¹⁴ represents a hydrogen atom or an alkyl group; and examples of the alkyl group are same as those preferably exemplified as an alkyl group represented by R¹¹ or R¹³. In the formula, R¹⁴ preferably represents a hydrogen atom or a C₁₋₄ alkyl group, more preferably a hydrogen atom or a C₁₋₃ alkyl group, and much more preferably methyl. In the formula, R¹¹ and R¹⁴ maybe same or different from each other, and it is most preferred that both of R¹¹ and R¹⁴ are methyl.

Preferable examples of the compound represented by the formula (V) include the compounds represented by the formula (V-A) and (V-B).

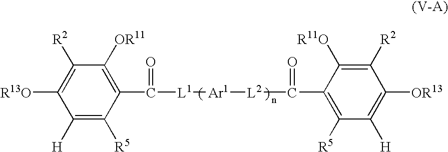

In the formula (V-A), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-A), the meanings and preferable examples of R², R⁵, R¹¹, R¹³, L¹, L², Ar¹ and n may be same as those in the formula (III).

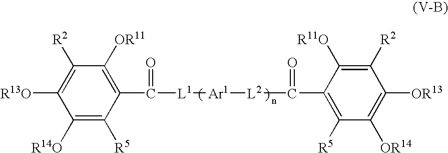

In the formula (V-B), R² and R⁵ independently represent a hydrogen atom or a substituent; R¹¹, R¹³ and R¹⁴ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-B), the meanings and preferable examples of R², R⁵, R¹¹, R¹³, R¹⁴, L¹, L², Ar¹ and n may be same as those in the formula (III).

“Substituent Group T” will be described below. Substituent Group T:

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo[1,2,2]heptane-2-yl and bicyclo[2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenyloxy, 2-methylphenoxy, 4-t-butylphenoxy, 3-nitrophenoxy and 2-tetradecanoyl phenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Same or different two or more substituents may be selected. If possible, the substituents may bond to each other to form a ring.

Preferable examples of the compound represented by the formula (V-A) include the compounds in which R¹¹ is methyl, both of R² and R⁵ are hydrogen atoms, R¹³ is a C₃ or longer alkyl group, L¹ is a single bond, —O—, —CO—, —NR—, —SO₂NR—, —NRSO₂—, —CONR—, —NRCO— (R is a hydrogen atom or a substituted or non-substituted alkyl or aryl group, and preferably a hydrogen atom), —COO—, —OCO— or an alkylene; L² is —O— or —NR— (R is a hydrogen atom or a substituted or non-substituted alkyl or aryl group, and preferably a hydrogen atom); Ar¹ is an arylene group, and n is an integer from 3 to 6.

Examples of the compound represented by the formulae (V-A) and (V-B) include, but are not limited to, those shown below.

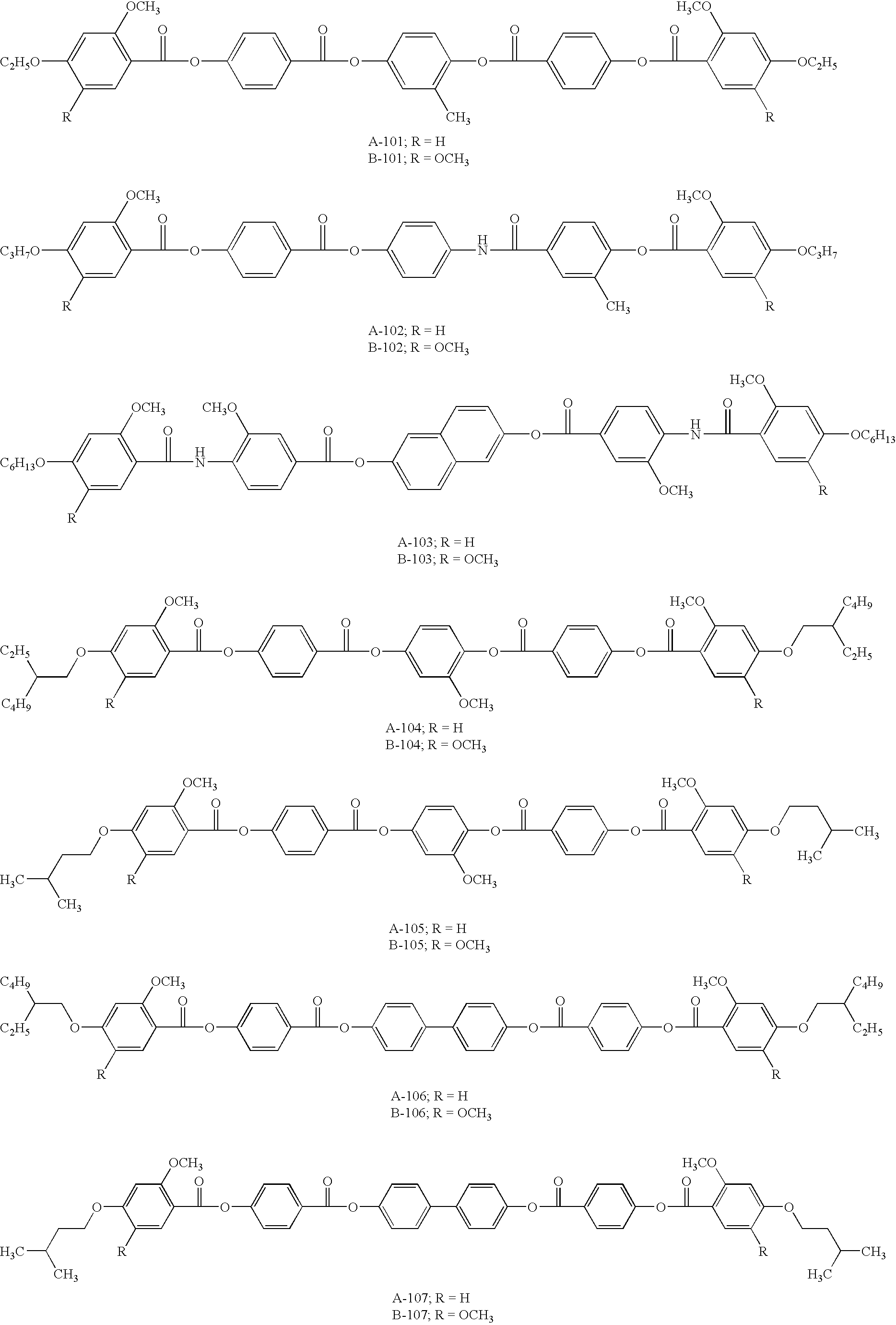

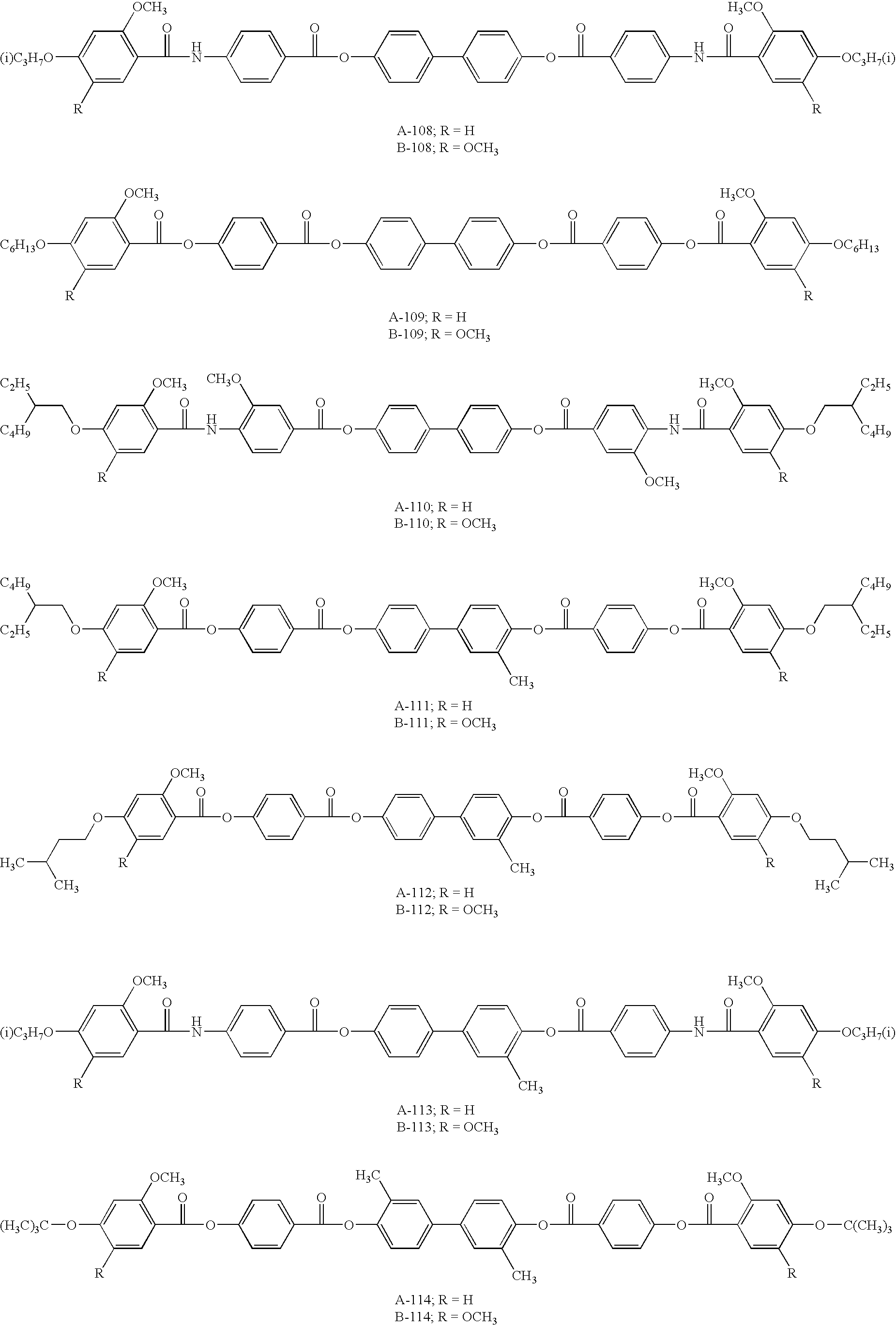

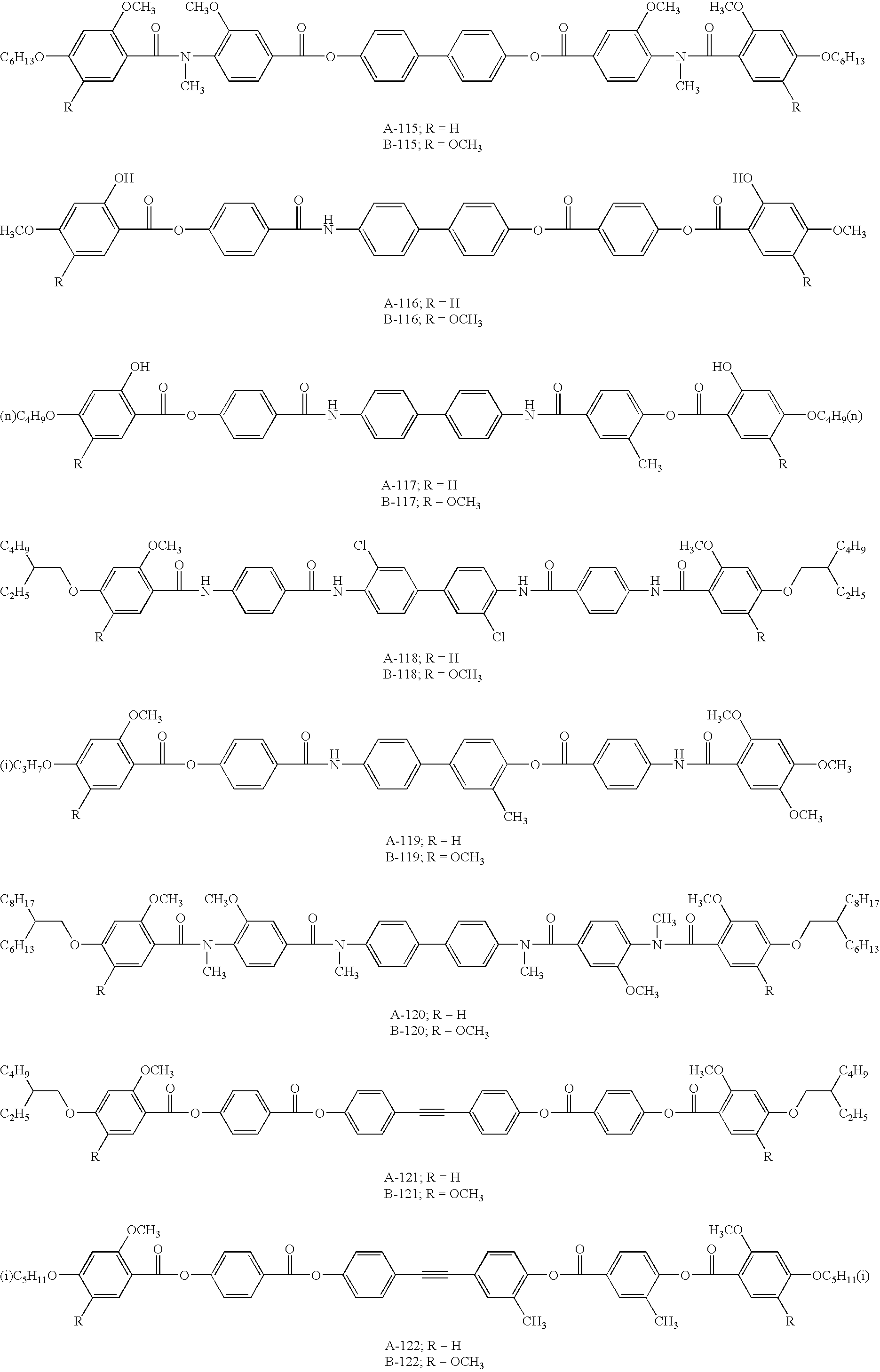

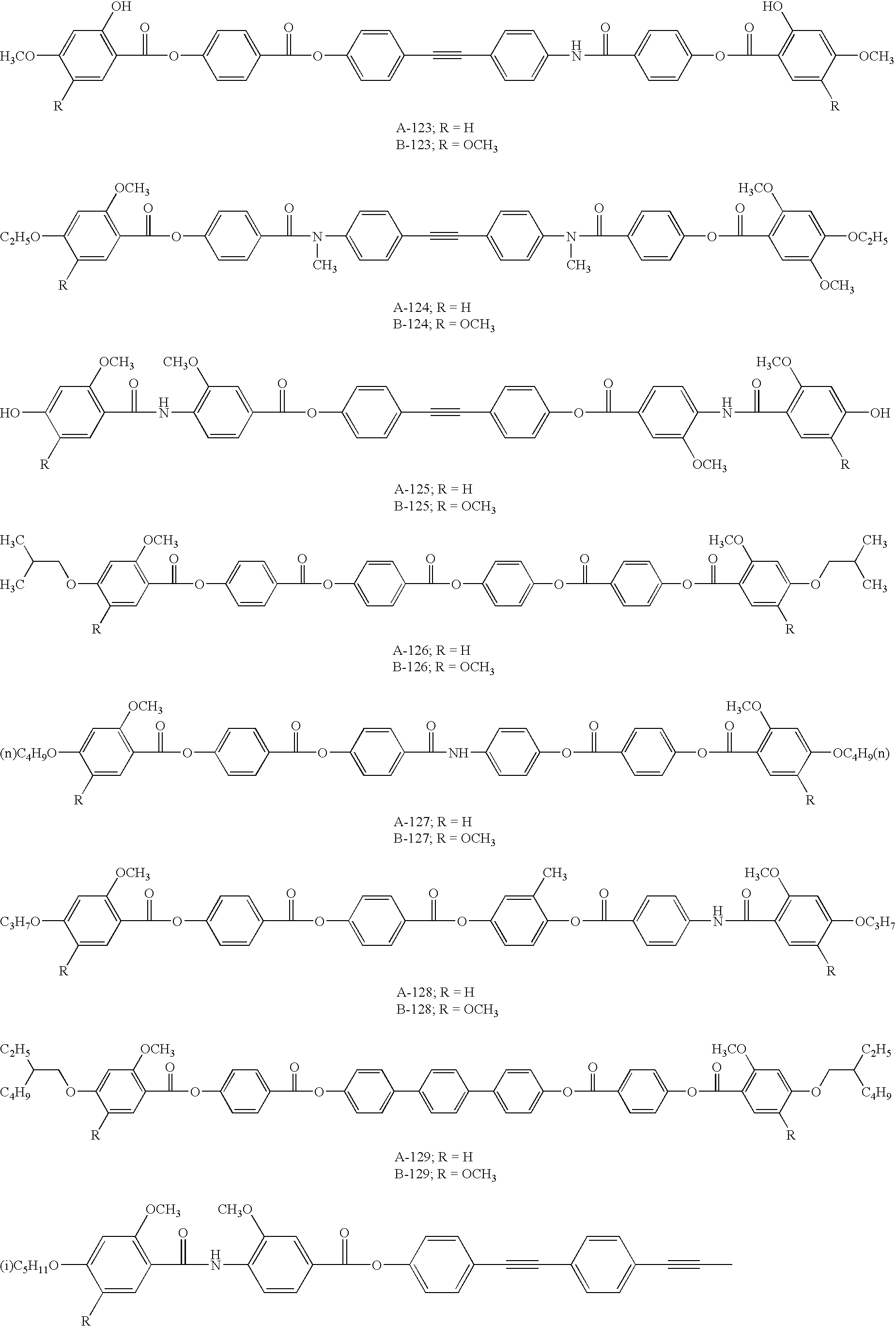

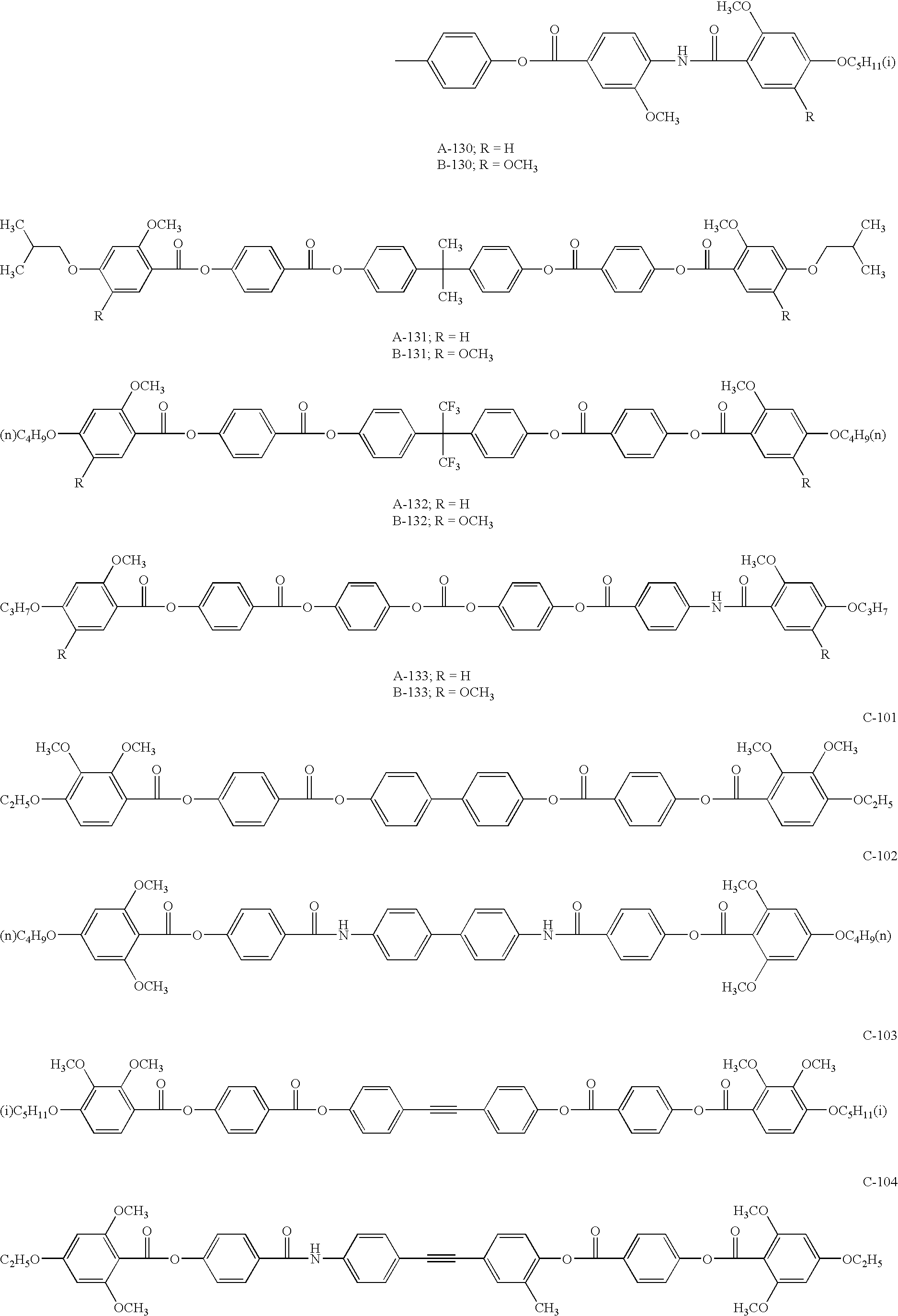

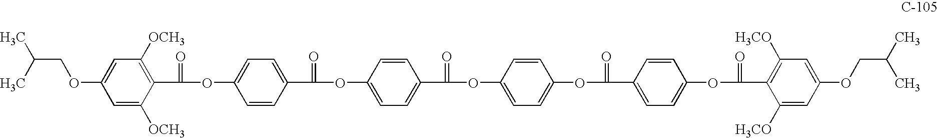

The compound represented by the formula (III) may be produced by a general esterification or a general amidation of a substituted benzoic acid, which may be synthesize previously, and a phenol derivative or a aniline derivative. The esterification or amidation may be carried out according to any method which can make an ester or amide bonding. For example, the compound may be produced as follows:

a substituted benzoic acid is converted into an acid halide, and, then, a condensation reaction of the acid halide and a phenol derivative or an aniline derivative is carried out; or

a dehydration condensation of a substituted benzoic acid and a phenol derivative or an aniline derivative is carried out in the presence of a condensation agent or catalyst.

The former method is preferred in terms of the production process.

Reaction solvent, which can be employed in the process of producing the compound represented by the formula (III), is preferably selected from the group consisting of hydrocarbon base solvents such as toluene and xylene; ether base solvents such as dimethylether, tetrahydrofuran and dioxane; ketone base solvents; ester base solvents; acetonitrile, dimethyl formamide and dimethylacetamide. One solvent or tow or more solvents may be employed. Among these, toluene, acetonitrile, dimethylformamide and dimethylacetamide are preferred.

The reaction temperature is preferably set within the range from 0 to 150° C., more preferably from 0 to 100° C., much more preferably from 0 to 90° C., and especially preferably from 20 to 90° C.

The reaction may be carried out with base or without base, the latter is preferred. Examples of the base include organic bases and inorganic bases, and organic bases such as pyridine and tertiary alkyl amine (e.g. triethyl amine and ethyl diisopropyl amine) are preferred.

The compound represented by the formula (V-A) or (V-B) can be produced according to any usual method. The compounds in which “n” is 4 may be produced as follows:

a reaction of a starting material having a following structure “A” with a derivative having a reactive site such as hydroxyl and amino is carried out to generate an intermediate B-2 shown below; a reaction of the intermediate B-2 with a compound “C” shown below to connect two molecules of the intermediate B-2 with a molecule of the compound “C” shown below; and then a compound represented by the formula (V-A) or (V-B) can be obtained.

The method to be employed for producing the compound is not limited to the above mentioned method.

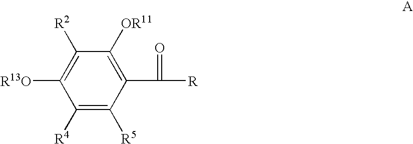

In the structure “A”, R represents a reactive group such as hydroxyl and a halogen atom; R¹¹, R², R¹³ and R⁵ are same as described above; and R⁴ represents a hydrogen atom or the above mentioned OR¹⁴.

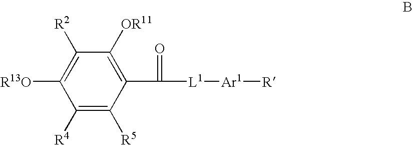

In the formula, R′ represents a reactive group such as carboxyl; R¹¹, R², R¹³, R⁴, R⁵, Ar¹ and L¹ are same as described above.

R—Ar²-L²-Ar²—R′c

In the formula, R and R′ represent a reactive group such as hydroxyl and amino; and Ar² and L² are defined as Ar¹ and L¹ are defined above.

The amount of the Rth enhancer is preferably from 0.1 to 30 mass %, more preferably from 1 to 25 mass % and much more preferably from 3 to 15 mass % with respect to the total mass of cellulose acylate.

When the cellulose acylate film is produced according to a solvent cast method, the Rth enhancer may be added to the dope. The addition of the Rth enhancer to the dope maybe conducted any stage, and for example, a solution of the Rth enhancer may be prepared by dissolving it in an organic solvent such as alcohol, methylene chloride or dioxolane and then added to the dope; or the Rth enhancer may be added to the dope directly.

According to the invention, one species or any combinations of plural species of the compound represented by any one of formulae (I), and (III) to (V) may be employed as the Rth enhancer. According to the invention, any combinations of two or more selected from the formulae (I) and (III) to (V) may be also employed as the Rth enhancer.

The cellulose acylate film to be used as the first optically anisotropic layer may comprise a UV absorbent. Some UV absorbents can function as an Rth enhancer. Examples of the UV absorbent include oxybenzophenone compounds, benzotriazole compounds, salicylate compounds, benzophenone compounds, cyanoacrylate compounds, and nickel complex compounds; and preferred are benzotriazole compounds causing little coloration. In addition, UV absorbents described in Japanese Laid-Open Patent Publication Nos. 10-182621 and 8-337574, and UV absorbent polymers described in Japanese Laid-Open Patent Publication No. 6-148430 are also preferably used herein. For the UV absorbent for the cellulose acylate film, preferred are those having an excellent ability to absorb UV rays having a wavelength of at most 370 nm, in terms of preventing degradation of polarizing elements and liquid crystals, and those not almost absorbing visible light having a wavelength of at least 400 nm in terms of the image display capability.

Examples of the benzotriazole-type UV absorbent usable in the invention are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazol-2-yl)phenol, 2-(2′-hydroxy-3′-tert-butyl-5′-methylphenyl)-5-chlorobenzotriazole, 2-(2H-benzotriazol-2-yl)-6-(linear or branched dodecyl)-4-methylphenol, a mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate, to which, however, the invention should not be limited. In addition, commercial products of TINUVIN 109, TINUVIN 171, TINUVIN 326 (all by Ciba Speciality Chemicals) are also preferably usable herein.

The amount of the Rth enhancer is preferably from 0.1 to 30 mass %, more preferably from 1 to 25 mass % and much more preferably from 3 to 15 mass % with respect to the total mass of cellulose acylate.

When the cellulose acylate film is produced according to a solvent cast method, the Rth enhancer may be added to the dope. The addition of the Rth enhancer to the dope maybe conducted any stage, and for example, a solution of the Rth enhance may be prepared by dissolving it in an organic solvent such as alcohol, methylene chloride or dioxolane and then added to the dope; or the Rth enhancer may be added to the dope directly.

### <<Wavelength Dispersion Adjusting Agent>>

In order to prepare a cellulose acylate film which satisfies the condition of the first optically anisotropic layer, an ultraviolet ray absorbent may be added to the cellulose acylate film. The ultraviolet ray absorbent can function as a wavelength dispersion adjusting agent. Examples of the ultraviolet ray absorbent include an oxybenzophenone-based compound, a benzotriazole-based compound, a salicylic acid ester compound, a benzophenone-based compound, a cyanoacrylate-based compound, and a nickel complex salt-based compound, but the benzotriazole-based compound having low coloration is preferred. The ultraviolet ray absorbent as described in JPA Nos. hei 10-182621, and hei 8-337574, and a high molecular ultraviolet ray absorbent as described in JPA No. hei 6-148430 are preferably used. In the cellulose acylate film, the ultraviolet ray absorbent has an excellent absorption capability of a ultraviolet ray having a wavelength of 370 nm or less in view of prevention of deterioration in the polarizer and the liquid crystal, and has low absorption capability of a visible light having a wavelength of 400 nm or more in view of a liquid crystal display property.

### <<Plasticizer>>

A plasticizer such as triphenyl phosphate or biphenyl phosphate may be added to the cellulose acylate film used as the first and second optically anisotropic layers.

The first optically anisotropic layer may be a layer formed of a liquid crystal composition or a lamination of such a layer and a polymer film. The liquid crystal composition contains at least one liquid crystalline compound. The liquid crystalline compound is preferably selected from a discotic liquid crystal having a discotic molecular structure. Preferred examples of the compound of the discotic liquid crystal and examples of the method of forming the optically anisotropic layer using the liquid crystal composition are as described on the preparation of the optical compensation sheet.

If the first optically anisotropic layer is formed of the liquid crystal composition, the first optically anisotropic layer is generally formed on the support such as the polymer film. An optical property required for the first optically anisotropic layer as a lamination may be satisfied actively using the birefringence of the polymer film which is the support or an optical property required for the second optically anisotropic layer may be satisfied only in the layer formed of the hardened liquid crystal composition using a film of which retardation is substantially 0 with respect to the support (for example, the cellulose acylate film described in JPA No. 2005-138375).

### <<Re Enhancer>>

In order to prepare a cellulose acylate film which satisfies the condition of the second optically anisotropic layer, an Re enhancer is preferably added to the cellulose acylate film. Here, the Re enhancer is a compound having a property capable of enhancing in-plane birefringence of the film.

The cellulose acylate film to be used as the second optically anisotropic layer may comprise at least one compound represented by the formula (A) as an Re enhancer.

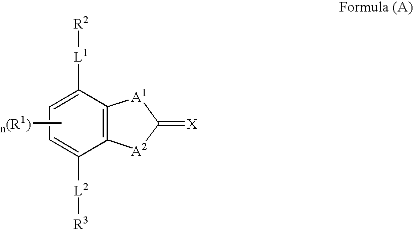

In the formula, L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

Among the compounds represented by the formula (A), the compounds represented by the formula (B) are preferred as a retardation enhancer.

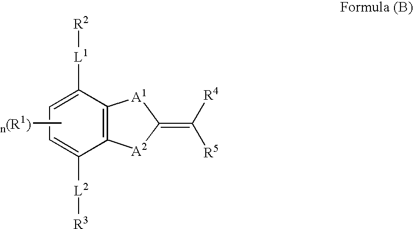

In the formula (B), L¹ and L² independently represent a single bond or a divalent group. A¹ and A² independently represent a group selected from the group consisting of —O—, —NR— where R represents a hydrogen atom or a substituent, —S— and —CO—. R¹, R² and R³ independently represent a substituent. And n is an integer from 0 to 2.

Preferred examples of the divalent linking group represented by L¹ or L² in the formula (A) or (B) include those shown below.

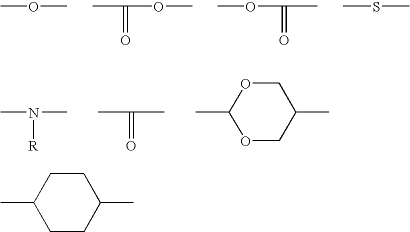

And further preferred are —O—, —COO— and —OCO—.

In the formulae (A) and (B), R¹ represents a substituent, if there are two or more R, they may be same or different from each other, or form a ring. Examples of the substituent include those shown below.

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo[1,2,2]heptane-2-yl and bicyclo[2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenyloxy, 2-methylphenoxy, 4-t-butylphenoxy, 3-nitrophenoxy and 2-tetradecanoylphenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls)methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, an alkoxy group, an acyloxy group, cyano or an amino group; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵ independently represent a substituent. Examples of the substituent include those exemplified above as examples of R¹. Preferably, R⁴ and R⁵ independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity-(Hammeto soku-Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)” on p. 217, published by TOKYO KAGAKU DOZIN CO. LTD., and written by Tadao Nakatani; and Chemical Reviews, Vol. 91, No. 2, pp. 165-195(1991).

In the formula, A¹ and A² independently represent a group selected from the group consisting of —O—, —NR— where R represents a hydrogen atom or a substituent, —S— and —CO—; and preferably, —O—, —NR— where R represents a substituent selected from those exemplified above as examples of R¹, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (A) or (B) include, but examples of the Re enhancer are not limited to, those shown below. Regarding the compounds shown below, each compound to which is appended (X) is referred to as “Example Compound (X)” unless it is specified.

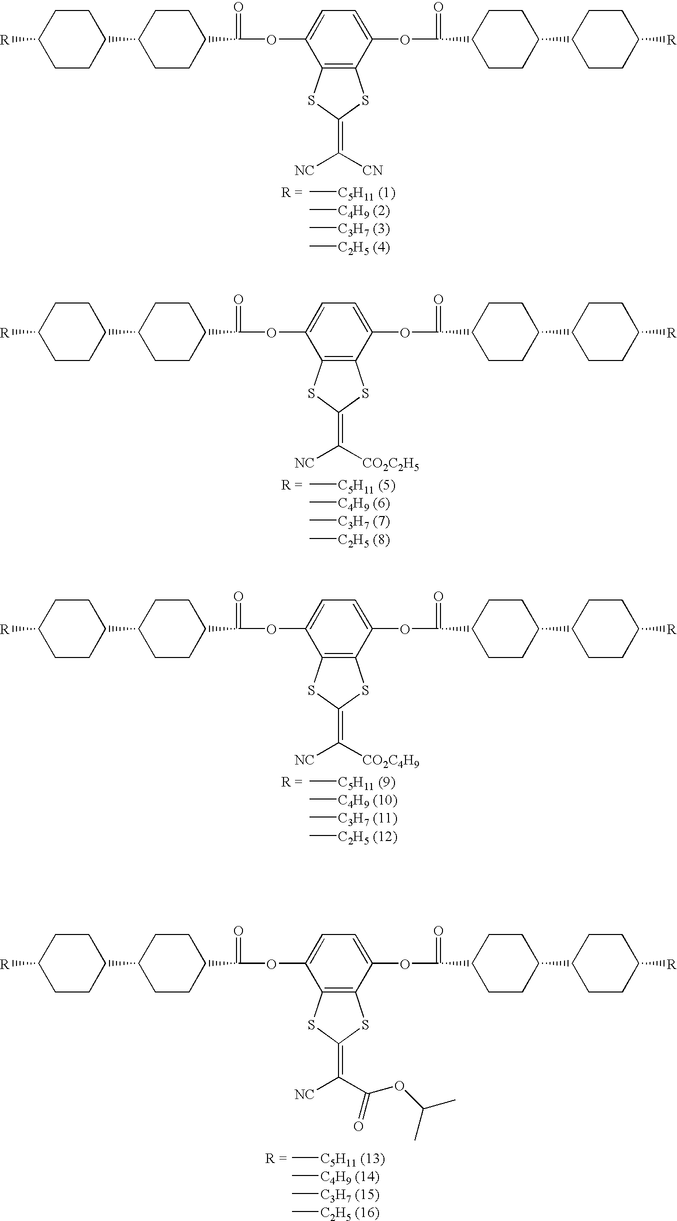

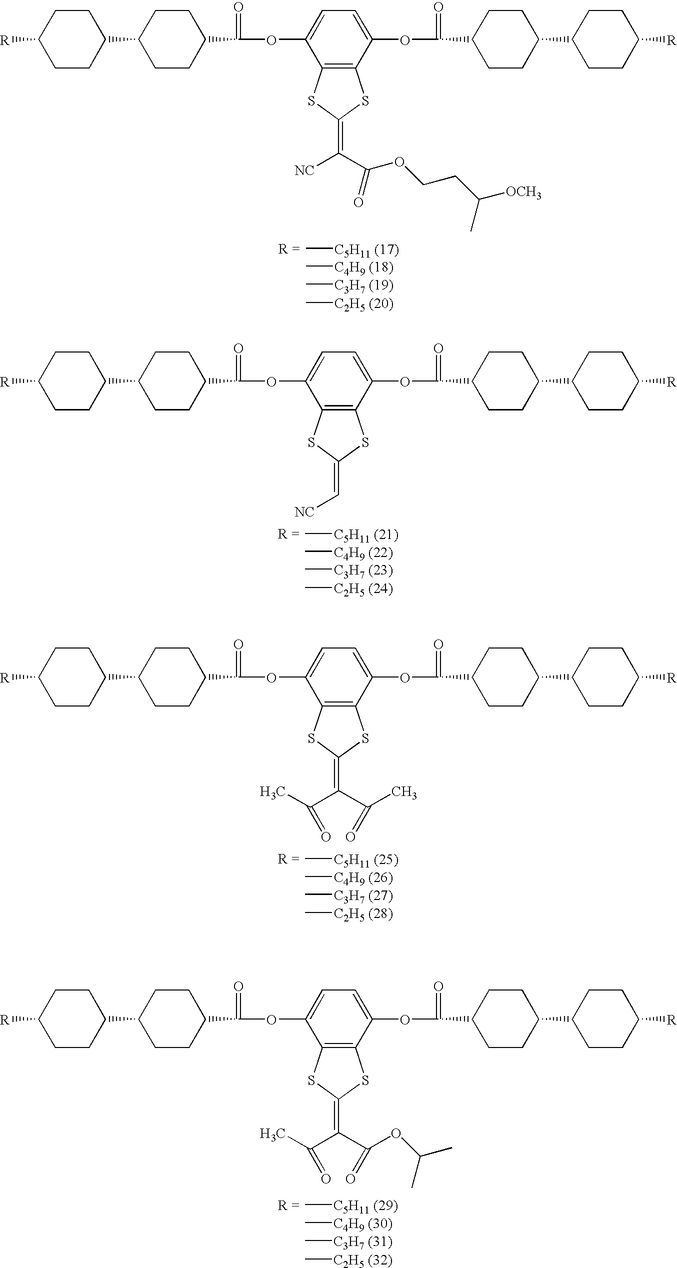

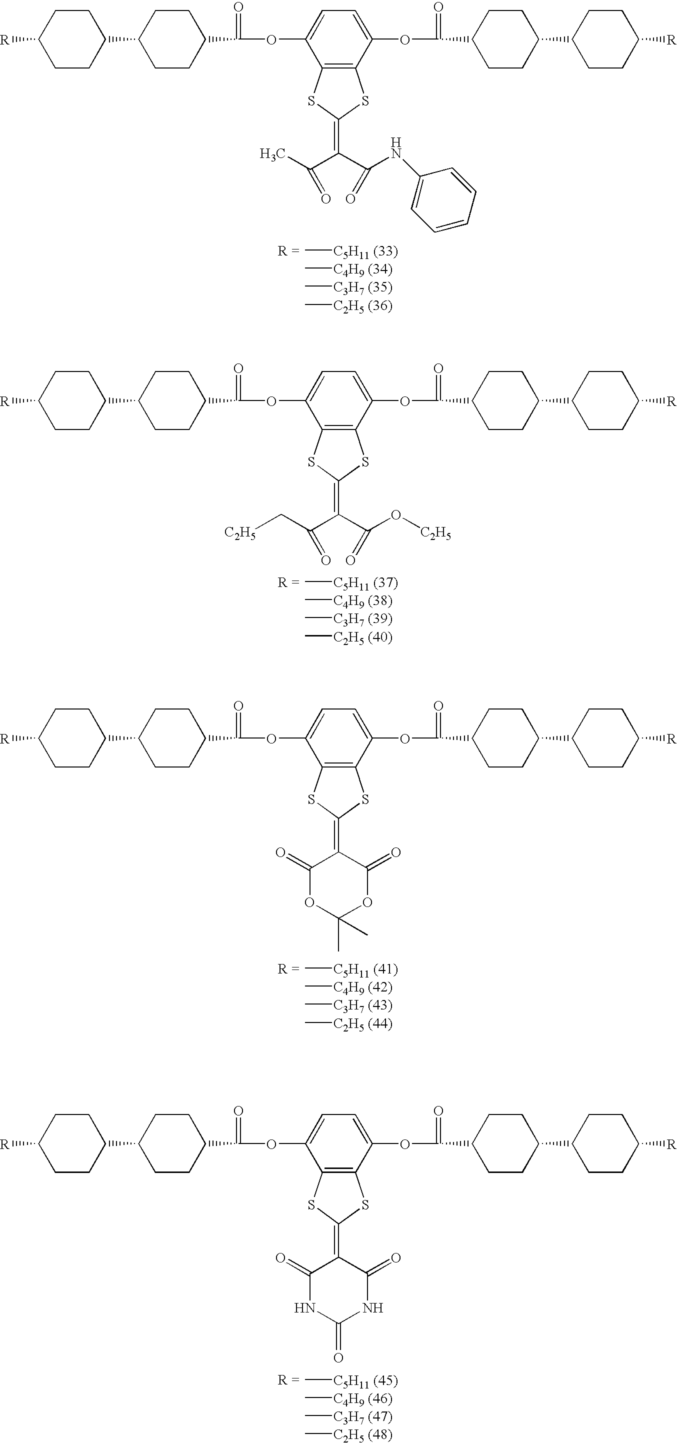

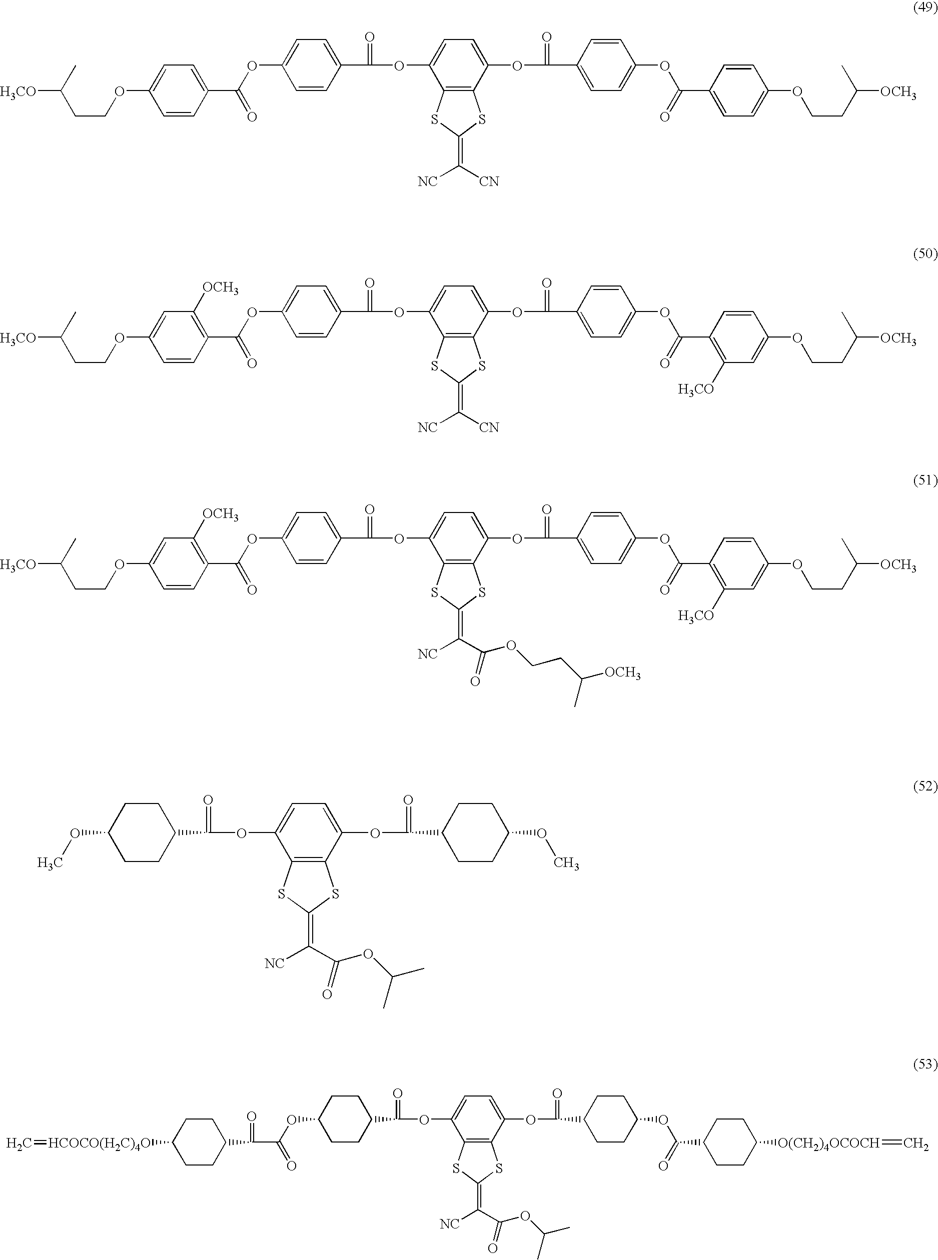

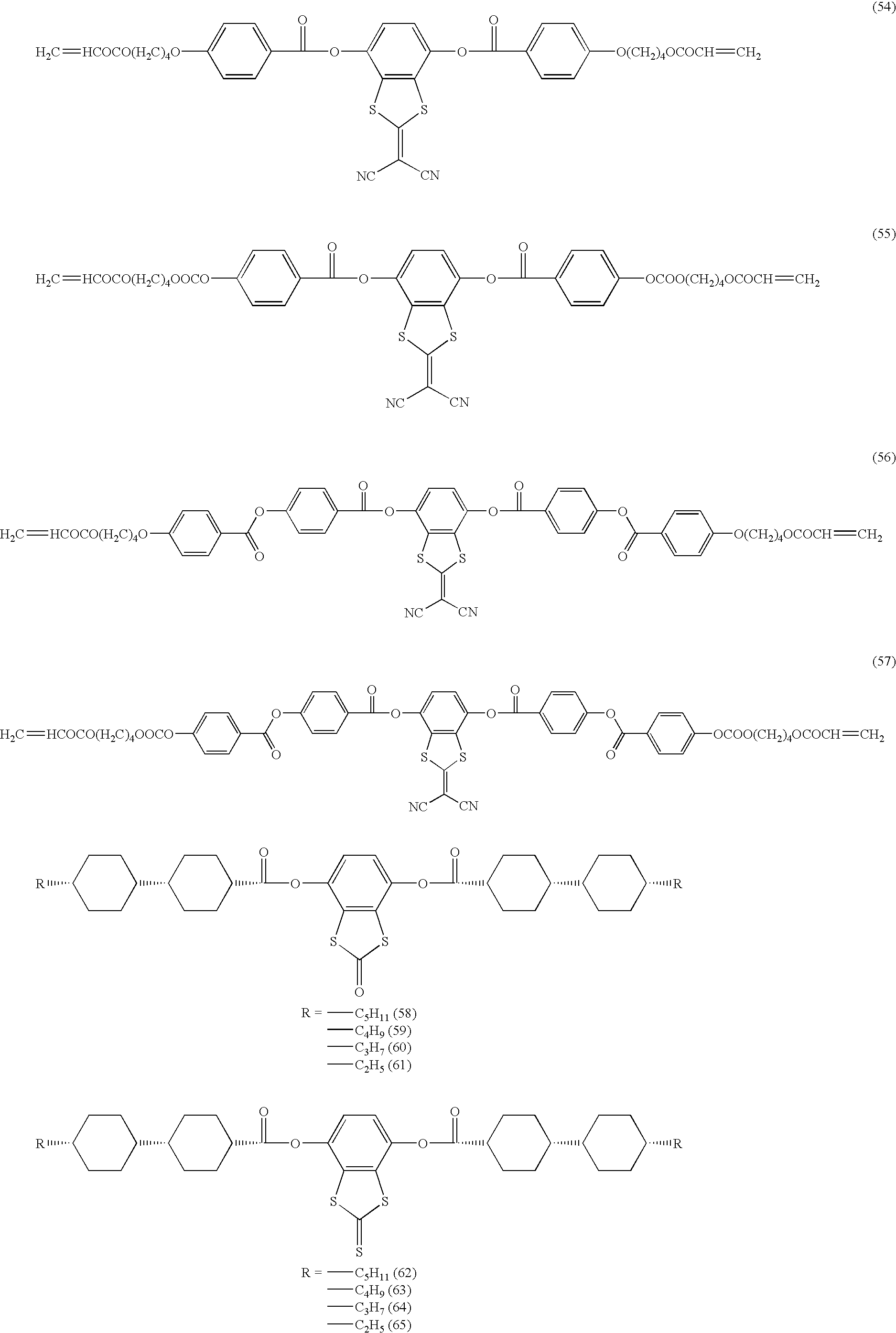

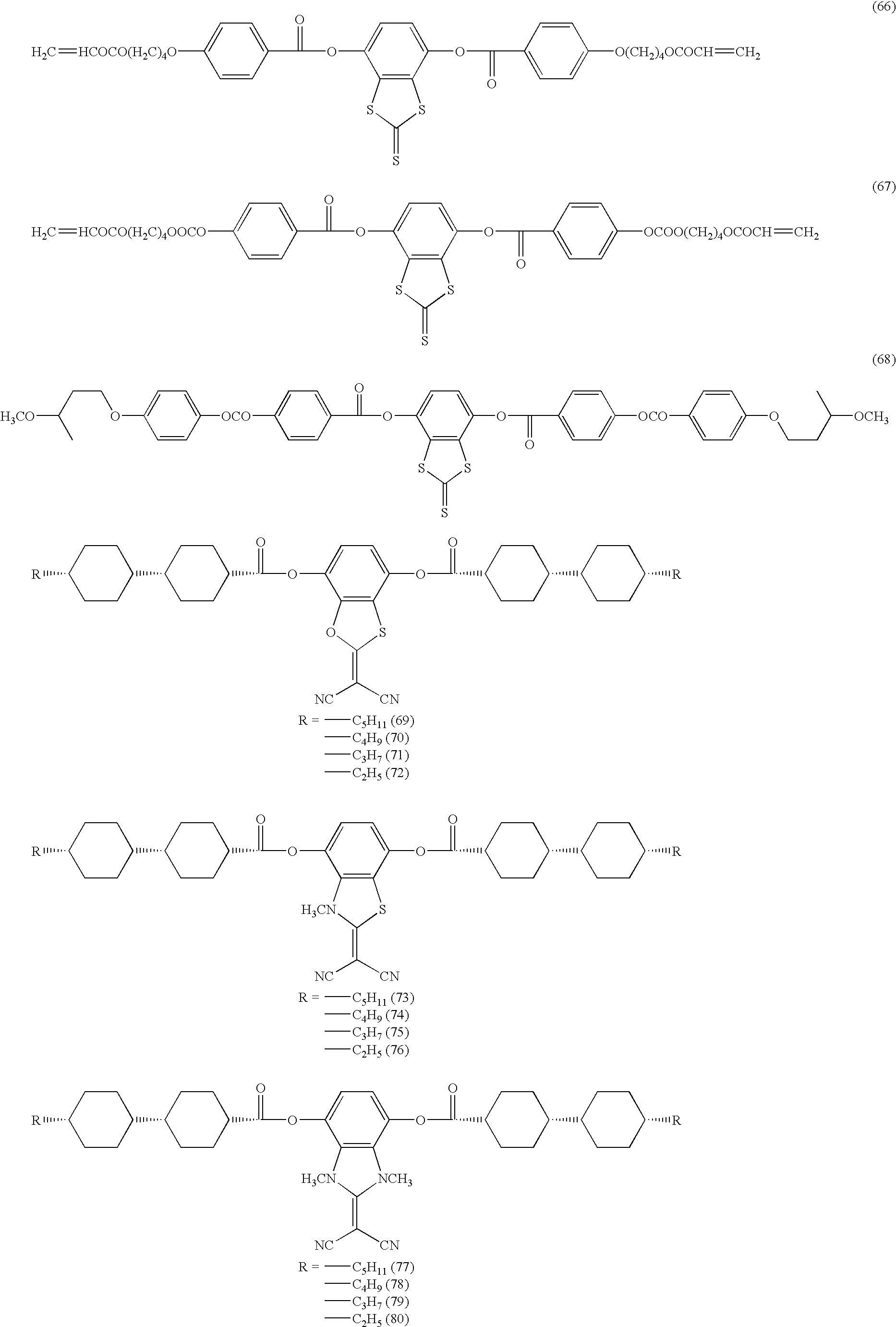

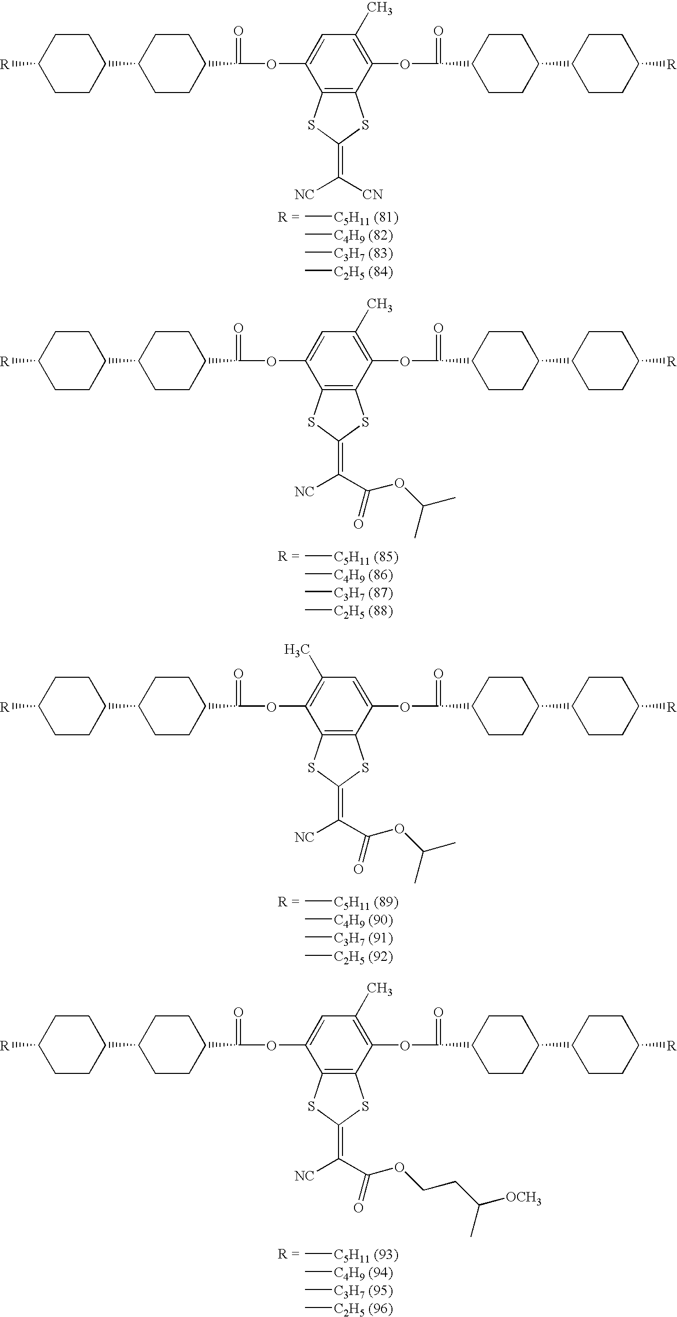

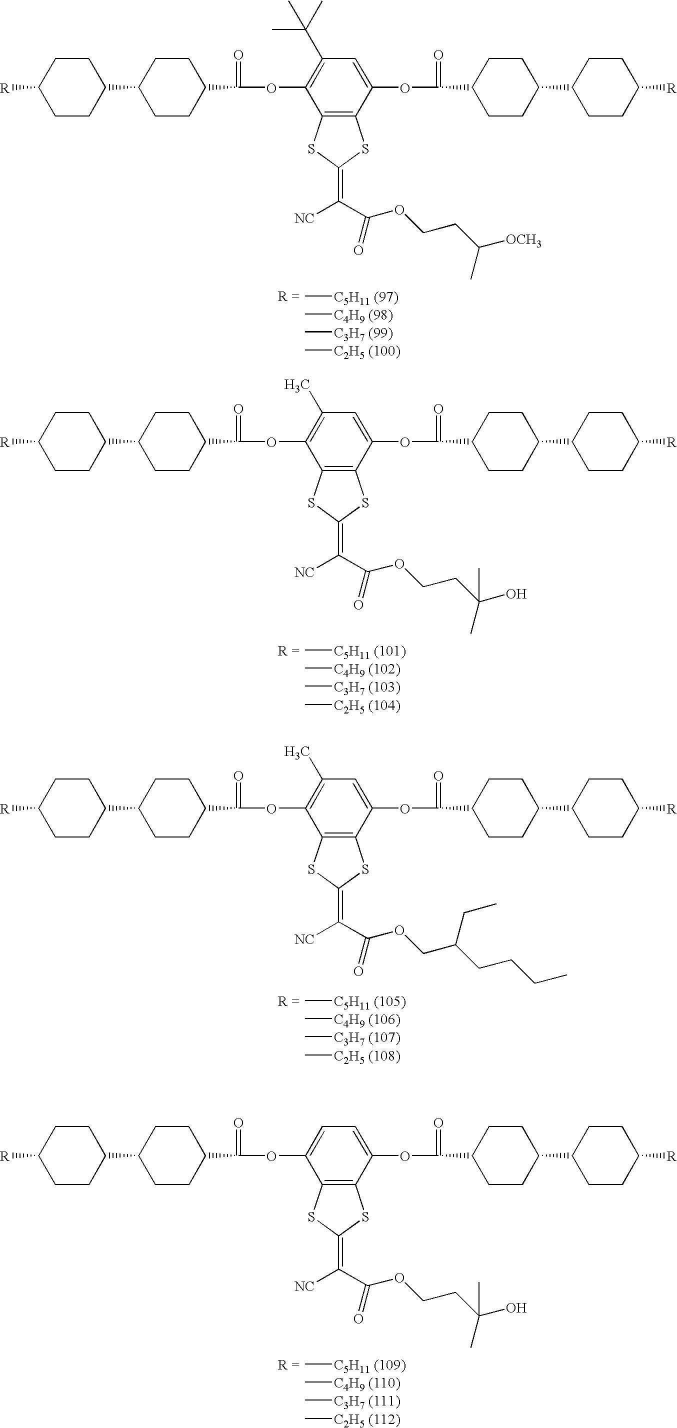

The compound represented by the formula (A) or (B) may be synthesized referring to known methods. For example, Example Compound (1) may be synthesized according to the following scheme.

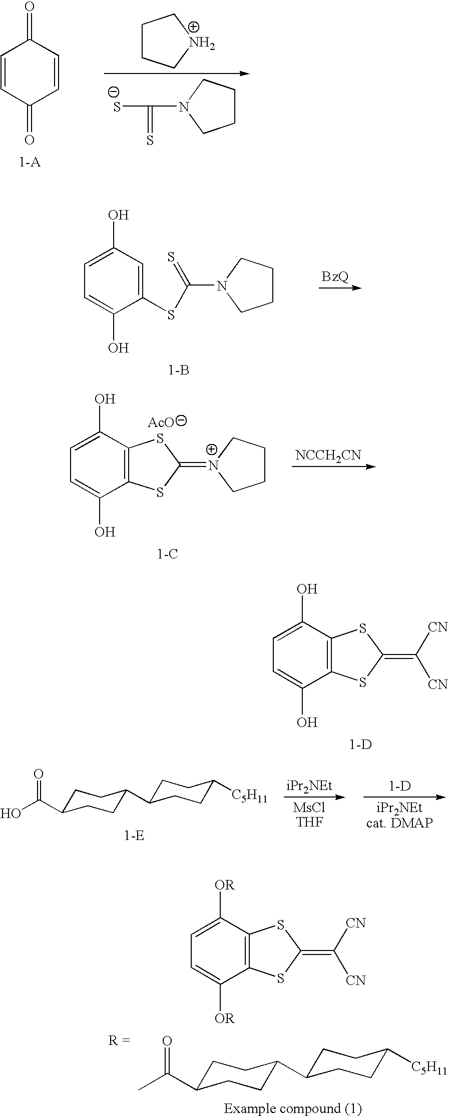

In the above scheme, the steps for producing Compound (1-d) from Compound (1-A) maybe carried out referring to the description in “Journal of Chemical Crystallography” (1997); 27(9); p. 515-526.

As shown in the above scheme, Example Compound (1) may be produced as follows. A tetrahydrofuran solution of Compound (1-E) is added with methanesulfonic acid chloride, added dropewise with N,N-di-iso-propylethylamine and then stirred. After that, the reaction solution is added with N,N-di-iso-propylethylamine, added dropewise with a tetrahydrofuran of Compound (1-D), and then added dropewise with a tetrahydrofuran solution of N,N-dimethylamino pyridine (DMAP).

The rod-like aromatic compounds described in Japanese Laid-open Patent publication No. 2004-50516, on pages 11-14, may be employed as the Re enhancer.

One species or two or more species of compounds may be used as the Re enhancer. Employing two or more species as the Re enhancer is preferable since it is possible to widening the adjustable retardation range and to facilitate adjustment of retardation within the preferred range.

The amount of the Re enhancer is preferably from 0.1 to 20 mass % and more preferably from 0.5 to 10 mass % with respect to 100 parts mass of cellulose acylate. When the cellulose acylate film is produced according to a solvent cast method, the Re enhancer may be added to the dope. The addition of the Re enhancer to the dope may be conducted any stage, and for example, a solution of the Re enhance may be prepared by dissolving it in an organic solvent such as alcohol, methylene chloride or dioxolane and then added to the dope; or the Re enhancer may be added to the dope directly.

Preferably, with the liquid crystal compound represented by the formula (A), the rod-like liquid crystal compound represented by the formula (a) is used together as the Re enhancer to be used for preparing the second optically anisotropic layer. Employing such the compound represented by the formula (A) in combination with the compound represented by the formula (a), it is possible to prepare an optically anisotropic layer of which reversed wavelength dependence in retardation (Re becomes smaller as wavelength is longer).

Ar¹-L¹²-X-L¹³-Ar² Formula (a):

In the formula (a), Ar¹ and Ar² independently represent an aromatic group; L¹² and L¹³ independently represent —O—CO— or —CO—O—; X represents 1,4-cyclohexylen, vinylene or ethynylene.

Examples of the aromatic group represented by Ar¹ or Ar² include any substituted or non-substituted aryl (aromatic hydrocarbon) groups and any substituted or non-substituted aromatic heterocyclic groups. Specific examples of the aryl group include phenyl and naphthyl. Preferably, the aromatic heterocyclic group is selected from the heterocyclic groups in which at least one hetero atom selected from nitrogen, oxygen and sulfur atoms is embedded. Preferably, the aromatic hetero ring is selected from 5-, 6- and 7-membered rings; and more preferably 5- and 6-membered rings.

The aromatic group represented by Ar¹ or Ar² may have at least one substituent if possible. Examples of the substituent include those exemplified above as the substituent represented by R¹ in the formula (A).

Examples of the liquid crystal compound represented by the formula (a) include rod-like aromatic compounds described in Japanese Laid-open patent publication No. 2004-50516, p. 11-14, [0040]-[0044].

The liquid crystal compound to be used as an Re enhancer may be added to the polymer composition, preferably cellulose acylate composition, if necessary, with other additives. The amount of the liquid crystal compound in the polymer composition is preferably from 0.1 to 30 mass %, and more preferably from 0.1 to 20 mass % with respect to the total mass of the composition. Adding the liquid crystal compound in the amount falling within the range may achieve preferred optical properties without generating bleed-out phenomena. And the amount of the liquid crystal compound is preferably from 40 to 100 mass %, and more preferably from 50 to 100 mass % with respect to the total mass of all additives in the composition. Adding the liquid crystal compound in the amount falling within the range may achieve preferred optical properties.

The ratio between the amounts of the liquid crystal compounds represented by the formulae (A) and (a) may be adjusted for producing the optical film satisfying the predetermined properties stably.

[Optically Anisotropic Layers A and B used for VA mode Liquid Crystal Display Device of Second Embodiment]

As described above, if the present invention is applied to the VA mode liquid crystal display device, the optically anisotropic layers A and B which satisfy Relations (XV) and (XVI) and more preferably Relations (XV) and (XVI) and have the same Re and Rth are preferably used. If the optically anisotropic layers A and B are polymer films, the optically anisotropic layers A and B may be attached with polarizers. As a single member, for example, the optically anisotropic layers are incorporated into the liquid crystal display device as a light compensation film. As the material of the polymer films, a polymer which is excellent in optical capability, transparency, mechanical strength, thermal stability, moisture shielding property and isotropy is preferable, but any material may be used if the above-described condition is satisfied. The detailed examples thereof are equal to the polymer materials which can be used for producing the first and second optically anisotropic layers used in the first embodiment of the VA mode liquid crystal display device.

For example, in a case where the optically anisotropic layers A and B are optically anisotropic layers of which Rth has low wavelength dispersion characteristics of retardation (a variation in Rth depending on a wavelength is low) in a visible light region while satisfying Relations (XV) and (XVI), a norbornene-based polymer film is preferably used. The detailed examples of the usable norbornene-based polymer film are equal to those of the norbornene-based polymer film which can be used for manufacturing the first and second optically anisotropic layers of the first aspect.

The optically anisotropic layers A and B may be formed of a cellulose acylate film. In particular, in a case where the optically anisotropic layers A and B are optically anisotropic layers of which Rth has reverse wavelength dispersion characteristics (a property in which Rth is increased as a wavelength is increased) in a visible light region while satisfying Relations (XV) and (XVI), a cellulose acylate film in which an acyl substitution group of cellulose acylate contained in the cellulose acylate film as a main component (a component of 50% by mass or more as a solid content) is at least one kind selected from acetyl, propionyl, and butyryl is preferably used.

In order to adjust wavelength dispersion of retardation and/or absolute values of retardation of the optically anisotropic layers A and B, an Re enhancer or decreasing agent and an Rth enhancer or decreasing agent may be added to any one polymer film. The Re enhancer or decreasing agent and the Rth enhancer or decreasing agent which can be used for manufacturing the optically anisotropic layers A and B are equal to materials which can be used for manufacturing the first and the second optically anisotropic layers.

For example, at least one kind of the Rth enhancers is preferably used for manufacturing the optically anisotropic layers A and B. In particular, in a case where the optically anisotropic layers A and B are optically anisotropic layers of which Rth has regular wavelength dispersion characteristics of retardation (a property in which Rth is increased as a wavelength is decreased) in a visible light region while satisfying Relations (XV) and (XVI), a compound having an absorption maximum in 250 nm to 380 nm is preferable as the Rth enhancer and the compound represented by following General Formula (I) is preferably used.

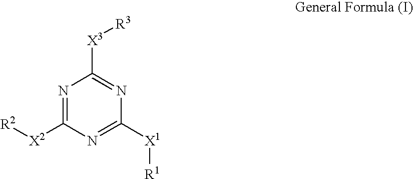

In this formula (I), the definition of the groups is described in the first embodiment.

At least one kind of compounds represented by Relation (I) as the Rth enhancer and a polymer composition containing a polymer (preferably, cellulose acylate) are prepared and a polymer film is obtained by a solution casting method and is preferably obtained as the optically anisotropic layers A and B. The compound represented by General Formula (I) is preferably added by 0.1 to 30% by mass with respect to the total mass (solid content) of the polymer compound.

In a case where the optically anisotropic layers A and B are optically anisotropic layers of which a Rega gradient has rapid reversed wavelength dispersion characteristics of retardation (a property in which Re is increased as a wavelength is increased) in a visible light region while satisfying Relations (XV) and (XVI) and having a relatively high Re, the preparation of the optically anisotropic layers A and B is equal to that of the second optically anisotropic layer in the first aspect. The liquid crystalline compound represented by General Formula (a) may be used as the Re enhancer together with the liquid crystalline compound represented by General Formula (A). The detailed and preferred examples of such a compound are described above.

The thickness of each optically anisotropic layer used in the first and second aspects of the VA mode liquid crystal display device is not specifically limited, but the thickness of each optically anisotropic layer is preferably 30 to 200 μm in order to respond to the request for the thinness while satisfying the optical property required for each optically anisotropic layer.

### [Elliptically Polarizing Plate]

The liquid crystal display device of the present invention may employ an elliptically polarizing plate integrating the optically anisotropic layer with a linear polarizing film. The elliptically polarizing plate can be prepared by laminating an external optical compensation film and a linear polarizing film (hereinafter, “polarizing film” used singly means “linear polarizing film”). The optical compensation film may also function as a protective film for the polarizing film.

The linear polarizing film is preferably a coated polarizing film as represented by a product of Optiva Inc., or a polarizing film formed by a binder and iodine or a dichroic dye. In the linear polarizing film, iodine or dichroic dye is aligned in the binder to exhibit a polarizing ability. The iodine or dichroic dye is preferably aligned along the binder molecules, or by an auto-texturing as in liquid crystal. The currently available commercial polarizer is generally prepared by immersing a stretched polymer film in a solution of iodine or a dichroic dye in a bath, thereby penetrating iodine or dichroic dye into the binder.

In the commercially available polarizing film, iodine or dichroic dye is distributed over about 4 μm from the polymer surface (about 8 μm in both sides), and a thickness of at least 10 μm is required for obtaining a sufficient polarizing ability. The level of penetration can be controlled by a concentration of iodine or dichroic dye in the solution, a temperature and an immersion time in the bath. A lower limit of the thickness of the binder is preferably 10 μm as described above. As to an upper limit, the binder thickness is preferably as small as possible in consideration of the light leak in the liquid crystal display apparatus. The thickness is preferably equal to or less than that of the current commercial polarizing plate (about 30 μm), more preferably 25 μm or less and further preferably 20 μm or less. With a thickness of 20 μm or less, the light leak is no longer observed in a 17-inch liquid crystal display apparatus.

The binder of the polarizing film may be crosslinked. The crosslinked binder may be obtained from a polymer which is crosslinkable by itself. The polarizing film may be formed by employing a binder constituted of a polymer having functional groups, or a binder obtained by introducing functional groups into a polymer, and by causing a reaction among such binder, by light, heat or pH change. Also a crosslinked structure may be introduced by a crosslinking agent into the polymer. The crosslinking can generally be executed, after coating a liquid containing polymer or a mixture of polymer and a crosslinking agent on a transparent substrate, by executing a heating. The crosslinking process may be executed in any step before obtaining the final polarizing plate, in order to secure the durability in such final product.

The binder of the polarizing film can be a polymer which is crosslinkable by itself, or a polymer which can be crosslinked by a crosslinking agent. Examples of such polymer are similar to those of the polymer described for the alignment film. Polyvinyl alcohol and denatured polyvinyl alcohol are most preferred. The denatured polyvinyl alcohol is described in JPA Nos. 8-338913, 9-152509 and 9-316127. Polyvinyl alcohol or denatured polyvinyl alcohol may be used in a combination of two or more kinds.

The crosslinking agent for the binder is preferably employed in an amount of 0.1 to 20 mass % with respect to the binder. Such amount can improve an alignment property of the polarizing element, and heat and moisture resistances of the polarizing film.

The alignment film contains, even after the crosslinking reaction, a certain amount of the crosslinking agent that has not been reacted. An amount of such residual crosslinking agent is preferably 1.0 mass % or less in the alignment film, more preferably 0.5 mass % or less. In this manner, the polarizing film does not lose the polarization degree when it is assembled in a liquid crystal display apparatus and used for a long time or let to stand for a prolonged period in an environment of high temperature and high humidity.

The crosslinking agent is described for example in U.S. Re-issued Pat. No. 23,297. Also a boron compound (such as boric acid or borax) may be employed as the crosslinking agent.

The dichroic dye can be an azo dye, a stilbene dye, a pyrazolone dye, a triphenylmethane dye, a quinoline dye, an oxazine dye, a thiazine dye or an anthraquinone dye. The dichroic dye is preferably water-soluble. Also the dichroic dye preferably has a hydrophilic substituent (such as sulfo, amino or hydroxyl). Examples of the dichroic dye include compounds described in the aforementioned Journal of Technical Disclosure, No. 2001-1745, p. 58.

In order to improve the contrast ratio of the liquid crystal display apparatus, the polarizing plate preferably has a transmittance as high as possible and a polarization degree as high as possible. The polarizing plate preferably has a transmittance at a wavelength of 550 nm within a range of 30 to 50%, more preferably 35 to 50% and most preferably 40 to 50%, and a polarization degree at a wavelength of 550 nm within a range of 90 to 100%, more preferably 95 to 100% and most preferably 99 to 100%.

### <<Preparation of Elliptically Polarizing Plate>>

In case of a stretching method, the stretching magnification is preferably 2.5-30.0 times, and more preferably 3.0 to 10.0 times. The stretching can be executed by a dry stretching in the air. It may also be realized by a wet stretching in a state immersed in water. The stretching magnification is preferably 2.5 to 5.0 times in case of a dry stretching, and 3.0 to 10.0 times in case of a wet stretching. The stretching process maybe divided into several steps, including an oblique stretching. Such several divided steps allow more uniform stretching even with a high stretching magnification. Prior to the oblique stretching, a certain stretching (in a level of preventing shrinkage in the transversal direction) may be executed in the longitudinal or transversal direction. The stretching can be realized by a step of executing a tenter stretching, employed in the biaxial stretching, in different levels at the left and right side. The biaxial stretching is similar to the stretching method employed in ordinary film forming process. In such biaxial stretching, since the stretching speed is different between the left and right sides, the binder film before stretching is required to have different thicknesses at the left and right sides. In the casting film formation, a tapered die may be employed to obtain a difference, in the flow rate of the binder solution, between the left and right sides.

In case of a rubbing method, a rubbing process widely employed as the liquid crystal aligning process in LCD can be utilized. More specifically, an alignment is obtained by rubbing the surface of the alignment film in a predetermined direction with paper, gauze, felt, rubber, nylon or polyester fibers, thereby obtaining an orientation. In general, it is executed by several rubbing strokes, with a cloth uniformly having fibers of uniform length and thickness. It is preferably executed with a rubbing roll having a circularity, a cylindricality and an eccentricity of 30 μm or less. A wrapping angle of the film on the rubbing roll is preferably 0.1 to 90°. It is however also possible to achieve a stable rubbing process with a wrapping of 360° or more, as described in JPA No. hei 8-160430.

In case of a rubbing process on a film of a continuous web form, the film is preferably conveyed by a conveying apparatus at a speed of 1 to 100 m/min under a constant tension. In order to obtain an arbitrary rubbing angle, the rubbing roll is preferably made arbitrarily rotatable in a direction parallel to the film advancing direction. The rubbing angle is preferably selected within a range of 0 to 60°.

The linear polarizing film is preferably provided, on a surface thereof opposite to the optically anisotropic layer, with a polymer (i.e. structure having optically anisotropic layer/polarizing film/polymer film).

The polymer film may also be provided, on an outermost surface thereof, with an antireflective film having a stain resistance and a scratch resistance. Any known antireflective film may be employed for this purpose.

### EXAMPLES

Paragraphs below will further specifically explain the present invention referring to Examples and Comparative Examples, without limiting the present invention. The lubricant compositions in Examples and Comparative Examples were evaluated according to the methods described below.

### Example 1

### (Preparation of Cellulose Acetate Solution)

A cellulose acetate solution was prepared by inserting the following ingredients into a mixing tank, and agitating and dissolving the compositions.

Ingredients of Cellulose Acetate Solution

| | | |
|---|---|---|
| Cellulose acetate having an acetic acid | 100.0 | parts by mass |
| content of 60.9% | | |
| Triphenyl phosphate (plasticizer) | 7.0 | parts by mass |
| Biphenyl diphenyl phosphate (plasticizer) | 4.0 | parts by mass |
| Dye as below | 0.0006 | parts by mass |
| Methylene chloride (first solvent) | 402.0 | parts by mass |
| Methanol (second solvent) | 60.0 | parts by mass |

Dye

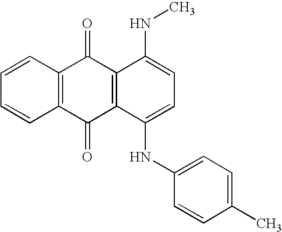

### (Preparation of Matting Agent Dispersion)

A matting agent dispersion was prepared by introducing the following ingredients into a dispersing machine, and agitating and dispersing the compositions.

Ingredients of Matting Agent Dispersion

| | |
|---|---|
| Silica particles having an average | 2.0 parts by mass |
| particle diameter of 16 nm (AEROSIL·R972 | |
| manufactured by Nippon Aerosil | |
| Corporation) | |
| Methylene chloride (first solvent) | 76.3 parts by mass |
| Methanol (second solvent) | 11.4 parts by mass |
| Cellulose acetate solution | 10.3 parts by mass |

### (Preparation of Retardation Increasing Agent Solution)

A retardation increasing agent solution was prepared by inserting the following ingredients into a mixing tank and agitating and dispersing the compositions while warming at 30° C.

Ingredients of Retardation Increasing Agent Solution

| | | |
|---|---|---|
| Retardation increasing agent as below | 20.0 | parts by mass |
| Methylene chloride (first solvent) | 58.3 | parts by mass |
| Methanol (second solvent) | 8.7 | parts by mass |
| Cellulose acetate solution | 12.8 | parts by mass |

Retardation Increasing Agent

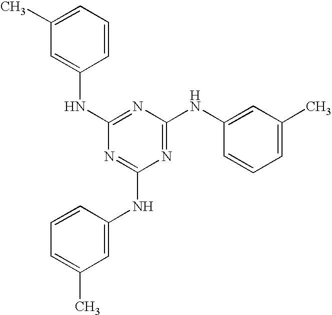

### (Preparation of Cellulose Acetate Film)

A cellulose acetate solution of 94.75 parts by mass, a matting agent dispersion of 1.30 parts by mass and a retardation increasing agent solution of 3.95 parts by mass were mixed after filtering and the mixed solution was cast using a band casting device. The weight ratio of the retardation increasing agent to the cellulose acetate was 4.8%. A film having a residual solvent amount of 30% by mass was stripped from the band. The film was horizontally stretched by a stretching ratio of 28% using the tenter at a temperature of 140° C. and was maintained at 140° C. for 20 seconds in a state in which the stretching ratio was decreased to 25% after stretching. At this time, the residual solvent amount at a maximum width increasing point was 14% by mass. Thereafter, a clip was detached and a cellulose acetate film was produced by drying the film at 130° C. for 45 minutes. The residual solvent amount of the produced cellulose acetate film was 0.2% by mass and the thickness thereof was 88 μm.

### (Measurement of Optical Characteristics)

With respect to the produced cellulose acetate film, the Re retardation value was measured with a light having a wavelength of 632.8 nm, using an ellipsometer (M-150, manufactured by JASCO Corporation). The retardation values Re (40°) and Re (−40°) were measured by tilting the in-plane slow axis by 40° and −40° as a tilt axis. A refractive index nx in the film thickness and slow axis directions were set as parameters, a fast-axis direction refractive index ny and a thickness-direction refractive index nz were calculated to be fitted to the measured values Re (632.8 nm), Re (40°) and Re(−40°), and the Rth retardation value was determined. The Re retardation value was measured with lights having a wavelength of 400 nm and a wavelength of 550 nm and α2=Re(400 nm)/Re(550 nm) was computed.

### (Saponification Treatment of Cellulose Acetate Film)

An isopropyl alcohol solution of 1.5N potassium hydroxide of 25 ml/m² was coated on one surface of the produced cellulose acetate film, and the produced cellulose acetate film was left at 25° C. for 5 seconds, was cleaned by flowing water for 10 seconds, and was dried by blowing air of 25° C. Thus, only one surface of the cellulose acetate film was saponificated.

### (Formation of Alignment Film)

A coating solution having the following compositions was coated on one surface of the saponificated cellulose acetate film (transparent support) by a wire bar coater of #14 with an amount of 24 ml/m². Then, the cellulose acetate film was dried by warm air of 60° C. for 60 seconds and was dried by warm air of 90° C. for 150 seconds. Next, the formed film was subjected to a rubbing process by a direction of 45° to a stretching direction (substantially equal to the slow axis) of the cellulose acetate film (transparent support).

Compositions of Alignment Film Coating Solution

| | | |
|---|---|---|
| Modified polyvinyl alcohol as below | 20 | parts by mass |
| Water | 360 | parts by mass |
| Methanol | 120 | parts by mass |
| Glutaraldehyde | 2 | parts by mass |

Modified Polyvinyl Alcohol

| | | |
|---|---|---|
| 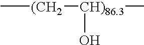 | 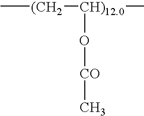 | 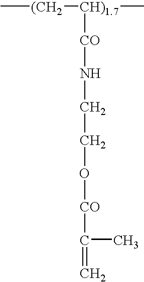 |

### (Formation of Optically Anisotropic Layer)

A coating solution containing a discotic compound having the following compositions was coated continuously on the produced alignment film by a wire bar of #3.2. For the dry of the solvent of the coating solution and alignment and aging of the discotic compound, the alignment film was heated by warm air of 100° C. for 30 seconds and warm air of 130° C. for 60 seconds. Subsequently, the alignment of the liquid crystal compound was fixed by irradiation of UV and the optically anisotropic layer was formed. Subsequently, the surface of the cellulose acetate film opposed to the surface on which the optically anisotropic layer was formed was continuously saponificated to prepare an optical compensation sheet.

Compositions of Optically Anisotropic Layer Coating Solution

| | | |
|---|---|---|
| Discotic compound (1) as below | 41.01 | parts by mass |
| Ethylene oxide modified trimethylolpropane | 4.06 | parts by mass |
| triacrylate (V #360, manufactured by OSAKA | | |
| ORGANIC CHEMICAL INDUSTRY LTD.) | | |
| Cellulose acetate butylate (CAB551-0.2, | 0.34 | part by mass |
| manufactured by Eastman Chemical Ltd.) | | |
| Cellulose acetate butylate (CAB531-1, | 0.11 | part by mass |
| manufactured by Eastman Chemical Ltd.) | | |
| Fluoro-aliphatic group-containing polymer | 0.03 | part by mass |
| 1 as below | | |
| Fluoro-aliphatic group-containing polymer | 20.23 | parts by mass |
| 2 as below | | |
| Photopolymerization initiator (IRUGACURE | 1.35 | parts by mass |
| 907, manufactured by Ciba-Geigy Ltd.) | | |
| Sensitizer (Kayacure-DETX, manufactured by | 0.45 | part by mass |
| NIPPON KAYAKU CO., LTD) | | |
| Methyl ethyl ketone | 107 | parts by mass |

Discotic Compound (1)

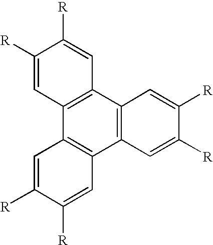

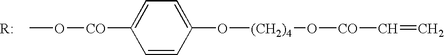

Fluoro-Aliphatic Group-Containing Polymer 1 (a/b = 90/10 wt %)

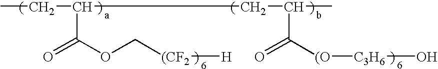

Fluoro-Aliphatic Group-Containing Polymer 2 (a/b = 98/2 wt %)

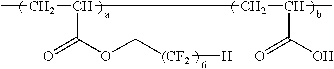

The optically anisotropic layer was formed similar to the above description, excluding that the transparent support was changed to a glass plate. The Re retardation value of the optically anisotropic layer was measured by light having a wavelength of 632.8 nm, using an ellipsometer (M-150, manufactured by JASCO Corporation). The retardation values Re (40°) and Re (−40°) were measured by tilting the in-plane slow axis by 40° and −40° as a tilt axis.

The Re retardation value was measured in a wavelength of 400 nm. The values was Re(λ: 632.8 nm)=38 nm, Re(40)/Re=1.76, and Re(−40)/Re=0.46, Re(400)/Re(550)=1.06.

With respect to the range of a polar angle (angle of the inclination from a normal line) of 50%, a white brightness viewing angle was measured. The result was 120°.

### (Preparation of Elliptical Polarizing Plate)

A polarizing film was produced by adsorbing iodine to the stretched polyvinyl alcohol film.

Next, a transparent support side of the produced optical compensation sheet was adhered to one side of the polarizing film using a polyvinyl alcohol-based adhesive so that the slow axis of the transparent support was parallel to the transmission axis of the polarizing film.

A cellulose acetate film (FUJITAC TD80U, manufactured by FUJIFILM Corporation) which is commercially available was saponificated in the similar manner as the transparent support and was adhered to the opposed side of the polarizing film (a side on which the optical compensation sheet was not adhered) using the polyvinyl alcohol-based adhesive.

Thus, the elliptical polarizing plate was produced.

### (Preparation of ECB Alignment Liquid Crystal Cell)

A polyimide film was disposed on a glass substrate having an ITO electrode as an alignment film and the alignment film was subjected to a rubbing treatment. A rubbing direction was set to a direction of 45° in the displaying plane. The obtained two glass substrates were adhered to each other such that the rubbing directions thereof were parallel to each other, and a cell gap was set to 3.5 μm. Liquid crystal, in which the dielectric anisotropy Δε was positive, and the refractive-index anisotropy was Δn=0.0939(450 nm, 20° C.), 0.0854 (589 nm, 20° C.), 0.0853 (633 nm, 20° C.) and Δε=+8.5 (for example, MLC-9100 manufactured by Merck Ltd.), was used between the upper and lower substrates. Here, the brightness in the white state varies depending on the value of a product Δn·d of the thickness d and the refractive-index anisotropy Δn. Accordingly, in order to obtain maximum brightness, the cell gap was preferably set in a range of 0.2 to 0.4 μm. An absorption axis of the polarizing plate crosses a liquid crystal cell alignment direction (rubbing direction) by substantially 45° and a crossing angle between the absorption axes of the upper and lower polarizing plates was substantially 90°.

### (Preparation of Color Filter)

Transer color filter manufactured by FUJIFILM Corporation which was formed on a transparent glass substrate by a method described in JPA No. hei10-221518 were used. Irregularity of the surface of the used Transer color filter was 0.2 micron or less.

The thicknesses of blue, green and red layers of the color filter were changed, and the thickness of the liquid crystal layer corresponding to each green pixel was 3.5 μm and the thickness of the liquid crystal layer corresponding to each red pixel was 3.8 μm. The retardation values of the liquid crystal layer corresponding to each green pixel and each red pixel were respectively Δn(λ1)×d1=0.3 μm and Δn(λ2)×d2=0.295 μm (here, λ1=589 nm and λ2=633 nm). The retardation values of the respective color layers of the color filter were measured using an ellipsometer (M-150, manufactured by JASCO Corporation. The retardation values were |Re(630 nm)|=0.2 nm, |Rth(630 nm)|=9.3 nm, |Re(400)−Re(700)|=1.9 nm, and |Rth(400)−Rth(700)|=4.3 nm.

### (Optical Capability of Liquid Crystal Display Device)

The produced liquid crystal display device was disposed on a field sequential backlight composed of an LED light source of three colors RGB, a white state voltage of 2 V and a black state voltage of 5 V were applied to the liquid crystal cell such that a brightness photometer (SR-3, manufactured by TOPCON Corporation) was used, and a contrast ratio in the normal direction to the panel surface (a ratio of white state transmissivity to black state transmissivity) and transmissivity in the black state at a polar angle of 60° and at an azimuthal angle ranging from 0 to 360° was measured with an interval of 5°, and the maximum transmissivities are shown in Table 1.

From the result of the same Table, the leakage amounts of blue, red and green lights were small and the coloring hardly occurs in any oblique direction.

### Example 2

In Example 1, the thicknesses of the blue, green and red layers of the color filter were further changed, and the retardation values of the liquid crystal layer corresponding to respective color layers were changed. The thickness of the liquid crystal layer of a blue pixel was 3.3 μm, the thickness of the liquid crystal layer of a green pixel was 3.5 μm, and the thickness of the liquid crystal layer of a red pixel was 3.8 μm. Retardation of the liquid crystal layer corresponding to respective pixels was respectively Δn(λ₁)×d₁=0.31 μm and Δn(λ₂)×d₂=0.30 μm and Δn(λ₃)×d₃=0.295 μm (here, λ₁ =450 nm, λ₂=589 nm and λ₃=633 nm).

The liquid crystal display device according to the present example provided the smaller leakage amounts of blue, red and green lights in any oblique direction and smaller coloration, compared with the liquid crystal display device according to Example 1.

### Comparative Example 1

In Example 1, the measurement was performed without a color filter and the result is shown in Table 1. From the same Table, the transmissivity of the red light was large and red coloring occurred.

TABLE 1

| | CR | | | |
|---|---|---|---|---|
| | in the | Leaked blue | Leaked green | Leaked red |
| | normal | light | light | light |
| | direction | transmittance | transmittance | transmittance |
| Example 1 | 1200 | 0.05% | 0.03% | 0.08% |
| Example 2 | 1200 | 0.04% | 0.02% | 0.04% |
| Comparative | 1200 | 0.08% | 0.03% | 0.12% |
| Example 1 | | | | |

### Example 3

### Preparation of VA Mode Liquid Crystal Display Device of First Embodiment

### (Preparation of Cellulose Acylate Films 101 to 105 for First Optically Anisotropic Layer)

The ingredients were mixed in the ratios described in Table 2, and the cellulose acylate solutions were prepared. Each of the cellulose acylate solutions was cast using a band casting device, the obtained web was stripped from the band, and stretching was performed. After stretching, the cellulose acylate films 101 to 105 having thicknesses described in Table 2 were produced by drying.

With respect to the films, a three-dimensional birefringence measurement was performed at each of wavelengths of 450 nm, 550 nm and 630 nm using an automatic birefringence meter KOBRA-21ADH (manufactured by OJI SCIENTIFIC INSTRUMENT) according to the above method and the thickness-direction retardation Rth was obtained by changing the in-plane retardation Re and the tilt angle and measuring Re. In Table 2, the values of Rth(550), Rth(450)/Re(550), and Rth(630)−Re(550) are shown. From the result shown in Table 2, it is understandable that the produced cellulose acylate films 101 to 105 satisfies the optical properties required for the first optically anisotropic layer, and exhibits regular wavelength dispersion characteristics of Rth.

TABLE 2

| | | | | | |
|---|---|---|---|---|---|
| Film Sample | 101 | 102 | 103 | 104 | 105 |
| No. | | | | | |
| Polymer | Cellulose | Cellulose | Cellulose | Cellulose | Cellulose |
| | acylate | acylate | acylate | acylate | acylate |
| | (Ac | (Ac | (Ac | (Ac | (Ac |
| | substitution | substitution | substitution | substitution | substitution |
| | degree | degree | degree | degree | degree |
| | 2.86) | 2.82) | 2.92) | 2.86) | 2.92) |
| Triphenyl | 7 | — | 7 | 7 | 7 |
| phosphate | | | | | |
| (mass %) | | | | | |
| Biphenyl | 5 | — | 5 | 5 | 5 |
| phosphate | | | | | |
| (mass %) | | | | | |
| Rth Reducer | — | 5 | — | — | 10 |
| (mass %) | | | | | |
| UV absorbent 1 | — | 6 | 6 | 6 | 8 |
| (mass %) | | | | | |
| UV absorbent 2 | 2 | — | — | — | — |
| (mass %) | | | | | |
| Thickness (μm) | 80 | 80 | 80 | 80 | 80 |
| Rth (550) | 100 nm | 85 nm | 120 nm | 100 nm | 100 nm |
| Rth(550)/Re(550) | 50 | 43 | 60 | 50 | 50 |
| Rth(630)-Rth(550) | −5 nm | −10 nm | −20 nm | −30 nm | −40 nm |

*The additive amounts (% by mass) of the additives in Table are values
when the amount of cellulose acylate is 100% by mass.
UV absorbent 1

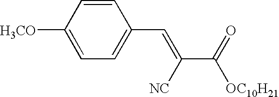

UV absorbent 2

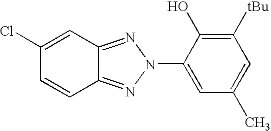

Rth Reducer

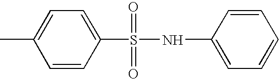

### (Preparation of Cellulose Acylate Films 201 for Second Optically Anisotropic Layer)

The cellulose acylate solutions 201 were prepared by mixing ingredients in the following ratio. Each of the cellulose acylate solutions was cast using a band casting device, and the obtained web was stripped from the band and was stretched under the following condition. A TD direction means a direction perpendicular to a transporting direction. After stretching, the cellulose acylate film 201 was obtained by drying.

Cellulose Acetate Solution 201

| | | |
|---|---|---|
| Cellulose acylate (acyl group content: | 100 | parts by mass |
| 2.86) | | |
| Triphenyl phosphate | 7 | parts by mass |
| Biphenyl phosphate | 5 | parts by mass |
| Re Enhancer 1 | 9 | parts by mass |
| Methylene chloride | 457 | parts by mass |
| Methanol | 94 | parts by mass |

Re Enhancer 1

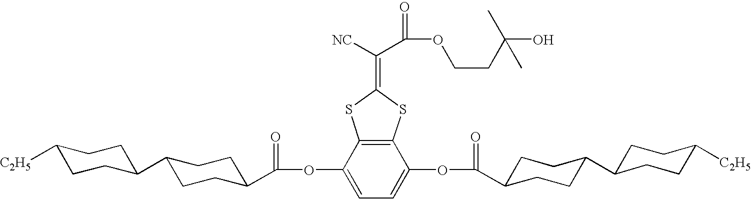

With respect to the films (thickness: 80 μm), a three-dimensional birefringence measurement was performed at wavelengths of 450 nm, 550 nm, and 630 nm using an automatic birefringence meter KOBRA-21ADH (manufactured by OJI SCIENTIFIC INSTRUMENT) by the above method and the thickness-direction retardation Rth obtained by changing the in-plane retardation Re and the tilt angle and measuring Re was obtained. The produced cellulose acylate film showed Re(550) of 105 nm, Rth(550) of 120 nm, Re(450)/Re(550) of 0.85, Re(630)/Re(550) of 1.04, Rth(450)/Rth(550) of 0.83, and Rth(630)/Rth(550) of 1.06, and it is understandable that the produced cellulose acylate film satisfies the optical properties required for the second optically anisotropic layer and exhibits reversed wavelength dispersion characteristics of both of Re and Rth.

(Preparation of Display Surface Side Polarizing Plates 101 to 105 and Backlight Side Polarizing plate 201)

The surfaces of the produced polymer films 101 to 105 and 201 were alkali-saponificated. The polymer films were immersed for 2 minutes at 55° C. in 1.5N aqueous sodium hydroxide, were cleaned in a bath of a room temperature, and were neutralized using 0.1N sulfuric acid at 30° C. The polymer films were cleaned in the bath of the room temperature and were dried by warm air of 100° C. Subsequently, a roll-type polyvinyl alcohol film having a thickness of 80 μm was stretched by five times in an iodine aqueous solution and was dried and thus a polarizing film having a thickness of 20 μm was obtained. The alkali-saponificated polymer films 101 to 105 and 201 and the alkali-saponificated FUJITAC TD80UL (manufactured by FUJIFILM Corporation) were prepared using a 3% polyvinyl alcohol (PVA-117H manufactured by Kuraray) aqueous solution as an adhesive and were adhered with a polarizing film sandwiched therebetween so that the saponificated surface became the polarizing film side, and the polarizing plates 101 to 105 and 201 in which the polymer films and TD80UL function as the protection film of the polarizing film were obtained.

The liquid crystal display devices 301 to 304 having the same configuration as FIG. 2 were produced. Each of the produced polarizing plates 101 to 105 was disposed as the polarizing plate (polarizing plate P1′ of FIG. 2) of the display surface side and the produced polarizing plate 201 was disposed as the polarizing plate (polarizing plate P2′ of FIG. 2) of the backlight side. Since the RGB color filter shown in FIG. 3B was formed on the inner surface of Substrate 1, the liquid crystal layer 10′, having d_{B}=3.3 μm, d_{G}=3.5 μm, and d_{R}=3.8 μm, satisfied Relation (2).

d_{B}<d_{G}<d_{R} (2):

With respect to the produced liquid crystal display devices, color shifts Δu′v′(=√(u═max−u′min)²+(v′max−v′min)²) in a black state were measured. Here, u′max(v′max) is a maximum u′(v′) of 0 to 360 degrees and u′min(v′min) is a minimum u′(v′) of 0 to 360 degrees. The result is shown in Table 3.

### Comparative Example 2

The polarizing plates 103 to 105 were used as a display surface side polarizing plate, the liquid crystal display devices 303′ to 305′ having the same configuration as Example 3 were produced, except that a substrate having an RGB color filter having a uniform thickness on its inner surface, was used as Substrate 1, and the color shifts Δu′v′ in the black state were measured. The result is shown in Table 3.

TABLE 3

| | | Polarizing plate disposed at | | | | |
|---|---|---|---|---|---|---|
| | | Displaying plane side No. | | | | |
| | | 101 | 102 | 103 | 104 | 105 |
| | | Polarizing Plate disposed at | | | | |
| | | Backlight side No. | | | | |
| | | 201 | 201 | 201 | 201 | 201 |
| Example 3 | LCD No. | 301 | 302 | 303 | 304 | — |
| (with | Δu′v′ | 0.025 | 0.03 | 0.04 | 0.05 | — |
| multi-gaps) | | | | | | |
| Comparative | LCD No. | — | — | 303′ | 304′ | 305′ |
| Example 2 | Δu′v′ | — | — | 0.08 | 0.07 | 0.05 |
| (with uniform | | | | | | |
| gap) | | | | | | |

From the result shown in Table 3, it is understandable that Example 3 employing the VA mode liquid crystal cell satisfying Relation (2), produced by changing the thicknesses of the RGB layers of the color filter, provided smaller color shift compared with Comparative Example 2 employing the liquid crystal cell with the RGB color filter having a uniform thickness. In particular, it is also understandable that the VA mode liquid crystal display device according to Example 3 provided smaller color shift with the first optically anisotropic layer showing Rth(630)−Rth(550), which is an indicator of wavelength dispersion characteristics of Rth, ranging from −30 to 0 nm. In contrast, the VA mode liquid crystal display device according to Comparative example 2 provided small color shift as that of Example 3 with the first optically anisotropic layer showing Rth(630)−Rth(550) less than −40 nm. That is, the device according to Comparative example 2 provided small color shift as that the device according to the present invention provided only by employing the optically anisotropic layer representing extreme regular wavelength dispersion characteristics of Rth.

### Example 4

### Preparation of VA Mode Liquid Crystal Display Device of First Aspect

### (Preparation of Cellulose Acylate Films 202 for Second Optically Anisotropic Layer)

Preparation of Cellulose Acylate Solution

A cellulose acylate solution was prepared by inserting the following ingredients into a mixing tank, and agitating and dissolving the ingredients at 80° C. for three hours.

Ingredients of Cellulose Acylate Solution

| | | |
|---|---|---|
| Cellulose acylate having an acetic acid | 100 | parts by mass |
| content of 2.94 | | |
| Triphenyl phosphate (plasticizer) | 4 | parts by mass |
| Biphenyl Diphenyl phosphate (plasticizer) | 3 | parts by mass |
| Dye as below | 6 | parts by mass |
| Methylene chloride (first solvent) | 402 | parts by mass |
| Methanol (second solvent) | 60 | parts by mass |

Dye

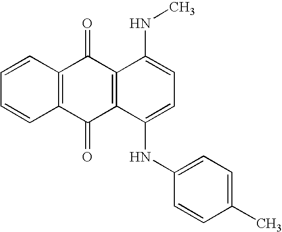

### (Preparation of Matting Agent Dispersion)

A matting agent dispersion was prepared by inserting the following ingredients into a dispersing machine, and agitating and dispersing the ingredients.

Ingredients of Matting Agent Dispersion

| | |
|---|---|
| Silica particles having an average particle | 2.0 parts by mass |
| diameter of 16 nm (AEROSIL·R972, manufactured | |
| by Nippon Aerosil Corporation) | |
| Methylene chloride (first solvent) | 76.3 parts by mass |
| Methanol (second solvent) | 11.4 parts by mass |
| Cellulose acylate solution | 10.3 parts by mass |

### (Preparation of Retardation Enhancer Solution)

A retardation increasing agent solution was prepared by inserting the following ingredients into a mixing tank and agitating and dispersing the compositions while warming at 30° C.

Ingredients of Retardation Increasing Agent Solution

| | | |
|---|---|---|
| Retardation Enhancer F-1 as below | 12 | parts by mass |
| Retardation Enhancer F-2 as below | 10 | parts by mass |
| Methylene chloride (first solvent) | 58 | parts by mass |
| Methanol (second solvent) | 8 | parts by mass |
| Cellulose acylate solution | 12 | parts by mass |

Retardation Enhancer F-1

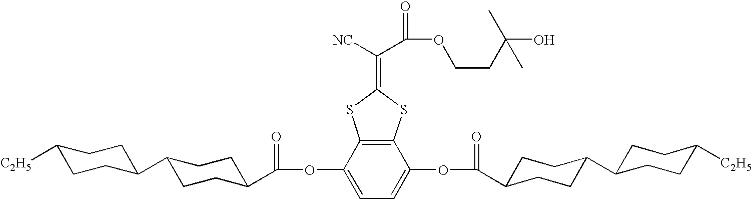

Retardation Enhancer F-2

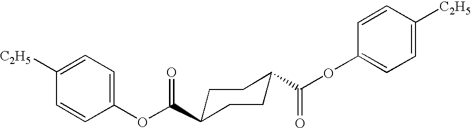

### (Formation of Film)

The cellulose acylate solution of 94.8 parts by mass, the matting agent dispersion of 1.3 parts by mass and the retardation enhancer solution of 8.4 parts by mass were mixed after filtering and the mixed solution was cast using a band casting device. A mass ratio of the retardation enhancer F-1 to the cellulose acylate was 6.0% and a mass ratio of the retardation enhancer F-2 to the cellulose acylate was 5.0%. The film having a residual solvent amount of 30% by mass was stripped from the band. The film was horizontally stretched by a stretching ratio of 25% using the tenter at a temperature of 140° C., the stretching ratio was decreased to 25% after stretching, and the film was maintained at 140° C. for 20 seconds. Thereafter, a clip was detached, the film was dried at 130° C. for 25 minutes, and the cellulose acylate film was produced. The residual solvent amount of the produced cellulose acylate film was 0.2% by mass and the thickness thereof was 55 μm.

### (Optical Measurement Evaluation of Cellulose Acylate Film 202)

With respect to the produced optical film 202 (thickness: 55 μm), a three-dimensional birefringence was measured at wavelengths of 450 nm, 550 nm and 630 nm using an automatic birefringence meter KOBRA-21ADH (manufactured by OJI SCIENTIFIC INSTRUMENT) and the thickness-direction retardation Rth was obtained by changing the in-plane retardation Re and the tilt angle and measuring Re. The produced cellulose acylate film 202 showed Re(550) of 100 nm, Rth(550) of 125 nm, Re(450)/Re(550) of 0.84, Re(630)/Re(550) of 1.04, Rth(450)/Rth(550) of 0.82, and Rth(630)/Rth(550) of 1.06, and it is understandable that the cellulose acylate film satisfies optical characteristics required for the second optically anisotropic layer and exhibits reversed wavelength dispersion characteristics of both of Re and Rth.

(Preparation of Polarizing plate and Liquid Crystal Display Device)

Polarizing plate 202 was produced in the same manner as Example 3, except that the produced cellulose acylate film 202 was employed in the place of the cellulose acylate film 201. The liquid crystal display device 306 having the configuration shown in FIG. 2 was produced in the same manner as Example 3 using the polarizing plate 202 and the polarizing plate 101 produced in Example 3.

### (Measurement of Display Capability)

In the same operation as Example 3, the color shift Δu′v′(=√(u′max−u′min)²+(v′max−v′min)²) of the produced liquid crystal display device 306 in the black state was measured. Here, u′max(v′max) is a maximum u′(v′) of 0 to 360 degrees and u′min(v′min) represents a minimum u′(v′) of 0 to 360 degrees. The result is shown in Table 4.

### Comparative Example 4

Liquid crystal display device 306′ having the same configuration as the liquid crystal display device 306 was produced in the same manner as Example 4, except that the substrate having the RGB color filter having a uniform thickness on its inner surface was uses as Substrate 1; and the color shift Δu′v′ in the black state was measured. The result is shown in Table 4.

TABLE 4

| | | Polarizing plate disposed at |
|---|---|---|
| | | Displaying plane side No. |
| | | 101 |
| | | Polarizing Plate disposed at |
| | | Backlight side No. |
| | | 202 |
| Example 4 | LCD No. | 306 |
| (with | Δu′v′ | 0.02 |
| multi-gaps) | | |
| Comparative | LCD No. | 306′ |
| Example 4 | Δu′v′ | 0.06 |
| (with uniform | | |
| gap) | | |

### Example 5

### Preparation of VA Mode Liquid Crystal Display Device of Second Embodiment

### (Preparation of Film 501 for Optically Anisotropic Layer)

The norbornene-based polymer film “ZEONOR” (ZEON CORPORATION) which is commercially available was fixed in the long direction and was stretched in the width direction by 30% at 140° to prepare the norbornene-based film 501.

### (Preparation of Film 502 for Optically Anisotropic Layer)

The cellulose acylate solution was prepared by mixing ingredients in the following ratio. The cellulose acylate solution was cast using the band casting device, and the obtained web was stripped from the band and was stretched by 25% in the TD direction under the condition of 140° C. The TD direction means a direction perpendicular to the transporting direction. After stretching, the optical film 502 of 40 μm was obtained by drying.

(Cellulose Acylate Solution)

| | | |
|---|---|---|
| Cellulose acylate having an acetic acid | 100 | parts by mass |
| content of 1.54 and a propionyl substitution | | |
| degree of 0.84 | | |
| Additive K-1 as below | 5 | parts mass |
| Additive K-2 as below | 4 | parts mass |
| Methylene chloride | 416 | parts mass |
| Ethanol | 79 | parts mass |

Additive K-1

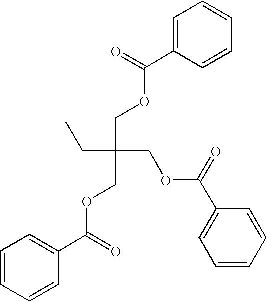

Additive K-2

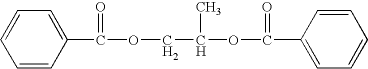

(Preparation of film 503 for Optical Anisotropy layer)

The cellulose acylate solution was prepared by mixing ingredients in the following ratio. The cellulose acylate solution was cast using the band casting device, and the obtained web was stripped from the band and was stretched by 25% in the TD direction under the condition of 120° C. Then, the optical film 503 of 55 μm was obtained by drying.

(Cellulose Acylate Solution)

| | | |
|---|---|---|
| Cellulose acylate having an acetic acid | 100 | parts by mass |
| content of 2.81 | | |
| retardation increasing agent as below | 4 | parts by mass |
| Triphenyl phosphate (plasticizer) | 7 | parts by mass |
| Biphenyl Diphenyl phosphate (plasticizer) | 5 | parts by mass |
| Methylene chloride | 430 | parts by mass |
| Methanol | 64 | parts by mass |

Retardation Increasing Agent

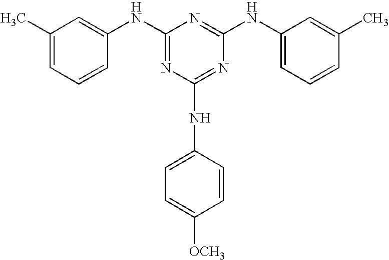

### (Preparation of Film 504 for Optically Anisotropic Layer)

The cellulose acylate solution was prepared by mixing ingredients in the following ratio. The cellulose acylate solution was cast using the band casting device, and the obtained web was stripped from the band and was stretched by 20% in the TD direction under the condition of 140° C. Then, the optical film 504 of 50 μm was obtained by drying.

(Cellulose Acylate Solution)

| | | |
|---|---|---|
| Cellulose acylate having an acetic acid | 100 | parts by mass |
| content of 2.86 | | |
| Retardation Enhancer F-1 as below | 2 | parts by mass |
| Retardation Enhancer F-2 as below | 6 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

Retardation Enhancer F-1

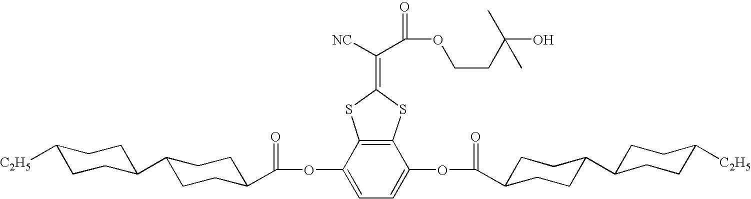

Retardation Enhancer F-2

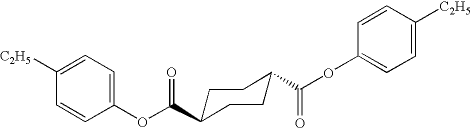

With respect to the produced optical films 501 to 504, a three-dimensional birefringence was measured at wavelengths of 450 nm, 550 nm and 630 nm using an automatic birefringence meter KOBRA-21ADH (manufactured by OJI SCIENTIFIC INSTRUMENT) and the thickness-direction retardation Rth was obtained by changing the in-plane retardation Re and the tilt angle and measuring Re. The result is shown in Table 5. As shown in Table 5, the films 501 to 504 satisfied Relations (XV) and (XVI).

TABLE 5

| Film | Re(550) | Rth(550) |
|---|---|---|
| No. | (nm) | (nm) |
| 501 | 54 | 111 |
| 502 | 42 | 111 |
| 503 | 42 | 128 |
| 504 | 58 | 110 |

(Preparation of Polarizing plate and Liquid Crystal Display Device)

Polarizing plates 501 to 504 were produced in the same manner as Example 3, except that the produced optical films 501 to 504 were used instead of the cellulose acylate film 201 respectively.

The VA mode liquid crystal display device having the same configuration as FIG. 8 was produced using the two produced polarizing plates. Specifically, the liquid crystal display devices 501 to 504 were produced using the produced polarizing plates 501 to 504 as polarizing plates P1″ and P2″ of FIG. 8. The polarizing plates were disposed so that the films 501 to 504 were disposed at the side of liquid crystal cell 5′, that is, the films 501 to 504 were disposed as optically anisotropic layers 20a and 20b of FIG. 8.

The liquid crystal cell, LC′, employed in the liquid crystal display devices 501 to 504 has a multi-gaps structure and the thicknesses of the B, G and R regions of the liquid crystal layer 5′ are shown in Table 6. The thickness of the liquid crystal layer was adjusted as shown in Table 6 by the thicknesses of the color layers of the color filter.

TABLE 6

| | LCD No. | | | |
|---|---|---|---|---|
| | 501 | 502 | 503 | 504 |
| d_{B}(Cell gap of B) | 3.4 μm | 3.0 μm | 3.3 μm | 3.2 μm |
| d_{G}(Cell gap of G) | 3.5 μm | 3.5 μm | 3.5 μm | 3.5 μm |
| d_{R}(Cell gap of R) | 4.0 μm | 3.8 μm | 4.1 μm | 3.8 μm |
| Δn(550) × d*¹ | 0.31 μm | 0.29 μm | 0.31 μm | 0.30 μm |

*¹A mean thickness of a liquid crystal layer (nm)

### (Measurement of Display Capability)

With respect to the produced liquid crystal display devices 501 to 504, the color shift Δu′v′(=√(u′max−u′min)²+(v′max−v′min)²) in the black state was measured in the same manner as Example 3. Here, u′max (v′max) is a maximum u′(v′) of 0 to 360 degrees and u′min(v′min) is a minimum u′(v′) of 0 to 360 degrees. The result is shown in Table 7.

TABLE 7

| | | Polarizing plate No. | | | |
|---|---|---|---|---|---|
| | | 501 | 502 | 503 | 504 |
| Example 5 | LCD No. | 501 | 502 | 503 | 504 |
| (with | Δu′v′ | 0.03 | 0.03 | 0.04 | 0.01 |
| multi-gaps) | | | | | |
| Comparative | LCD No. | 501′ | 502′ | 503′ | 504′ |
| Example 5 | Δu′v′ | 0.05 | 0.06 | 0.07 | 0.04 |
| (with | | | | | |
| uniform | | | | | |
| gap) | | | | | |

From the result shown in Table 7, it is understandable that Example 5 employing the VA mode liquid crystal cell satisfying Relation (2), produced by changing the thicknesses of the RGB layers of the color filter, provided smaller color shift compared with Comparative Example 5 employing the liquid crystal cell with the RGB color filter having a uniform thickness. It is also understandable, according to Example 5, color shift in any oblique direction can be reduced without any limitations on the optically anisotropic layer in terms of material and wavelength dispersion of retardation.

What is claimed is:

1. A liquid crystal display device comprising at least a liquid crystal cell, and a polarizing plate (a first polarizing plate) disposed on at least one side of the outsides of the liquid crystal cell,
wherein the liquid crystal cell comprises a pair of substrates which face each other, an electrode disposed on at least one of the pair of substrates, a liquid crystal layer sandwiched between the pair of substrates, and at least three pixel regions,
a color filter showing wavelength selectivity in transmissivity is disposed on each of the at least three pixel regions,
the thicknesses of the liquid crystal layers corresponding to a color filter showing a maximum transmissivity at a main wavelength λ₁, a color filter showing a maximum transmissivity at a main wavelength λ₂, and a color filter showing a maximum transmissivity at a main wavelength λ₃, provided that λ₁, λ₂, and λ₃ (unit: nm) are in an order from the smaller one, are d₁, d₂ and d₃ (unit: nm) respectively, and Relation (1) is satisfied:
d₂<d₃. (1):

2. The liquid crystal display device of claim 1, satisfying Relation (2):
d₁<d₂<d₃. (2):

3. The liquid crystal display device of claim 1, wherein, among thickness-direction retardation (Rth) values of the color filter disposed on the at least three pixel regions, those of at least two of them are different from each other.

4. The liquid crystal display device of claim 1, wherein the color filter satisfies Relations (I) and (II):

|Re(630)|≦10, and, |Rth(630)|≦40 (I):

|Re(400)−Re(700)|≦10, and, (Rth(400)−Rth(700)|≦35 (II):
wherein in Relations (I) and (II), Re(λ) is an in-plane retardation value (nm) at a wavelength λ nm, and Rth(λ) is a thickness-direction retardation value (nm) at a wavelength λ nm.

5. The liquid crystal display device of claim 1, further comprising a first optically anisotropic layer satisfying Relations (III) and (IV):
0 nm<Rth(550)≦300 nm (III):
Rth(550)/Re(550)>10; and (IV):
a second optically anisotropic layer having at least one optical axis in the plane.

6. The liquid crystal display device of claim 5, wherein the first optically anisotropic layer satisfies Relations (V) to (VII):
Rth(450)/Rth(550)≧1 (V):
Rth(630)/Rth(550)≧1 (VI):
−30 nm≦Rth(630)−Rth(450)≦0 nm. (VII):

7. The liquid crystal display device of claim 5, wherein the second optically anisotropic layer satisfies Relations (VIII) and (IX):
55 nm≦Re(550)≦315 nm (VIII):
0 nm≦Rth(550)≦275 nm. (IX):

8. The liquid crystal display device of claim 1,
wherein an optically anisotropic layer A is disposed between the first polarizing plate and the liquid crystal cell;
the optical anisotropy layer A satisfies Relations (XV) and (XVI):
30 nm≦Re(550)≦80 nm (XV):
75 nm≦Rth(550)≦155 nm; and (XVI):
when a slow axis of the optically anisotropic layer A is projected on the same plane as an absorption axis of the first polarizing plate, the projected axis is parallel to the absorption axis.

9. The liquid crystal display device of claim 8, further comprising:
a second polarizing plate, the first and second polarizing plates sandwiching the liquid crystal cell therebetween, of which absorption axis is perpendicular to the absorption axis of the first polarizing plate,; and
an optically anisotropic layer B disposed between the second polarizing plate and the liquid crystal cell, wherein the optically anisotropic layer B satisfies Relations (XV) and (XVI), and, when a slow axis of the optically anisotropic layer B is projected on the same plane as an absorption axis of the second polarizing plate, the projected axis is parallel to the absorption axis.

10. The liquid crystal display device of claim 9, wherein the thickness-direction retardation values at a wavelength of 550 nm, Rth(550), of the optically anisotropic layers A and B and Δn(550)×d of the liquid crystal layer satisfy Relation (XVII):
0.7≦(2×Rth(550))/Δn(550)×d≦1.3 (XVII):
in which Δn(550) is a refractive-index anisotropy of the thickness direction of the liquid crystal layer at a wavelength of 550 nm, and d is an average thickness (nm) of the liquid crystal layer.

11. The liquid crystal display device of claim 5, wherein at least one of the optically anisotropic layers comprises at least one polymer and at least one additive, and the at least one additive is a liquid crystalline compound.

12. The liquid crystal display device of claim 11, wherein an amount of the liquid crystalline compound is from 0.1 to 30% by mass, and a mass ratio of the liquid crystalline compound to all additives is from 40 to 100% by mass.

13. The liquid crystal display device of claim 11, wherein the at least one of the optically anisotropic layers comprises two types of liquid crystalline compound in an amount of 0.1 to 30% by mass, and a mass ratio of the at least two types of liquid crystalline compound to all additives is 50 to 100% by mass.

14. The liquid crystal display device of claim 11, wherein the at least one of the optically anisotropic layers comprises at least one compound represented by Formula (A): 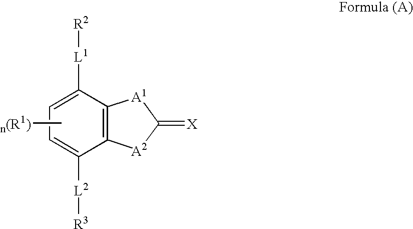
in which L¹ and L² independently represent a single bond or a divalent linking group; A¹ and A²independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2;
and at least one compound represented by Formula (a):
Ar¹-L¹²-X-L¹³-Ar² Formula (a):
in which Ar¹ and Ar² independently represent an aromatic group; L¹² and L¹³ independently represent —O—CO— or —CO—O—; and X represents 1,4-cyclohexylen, vinylene or ethynylene.

15. The liquid crystal display device of claim 5, wherein at least one of the optically anisotropic layers is formed of a norbornene-based polymer film.

16. The liquid crystal display device of claim 5, wherein at least one of the optically anisotropic layers is formed of a cellulose acylate-based film.

17. The liquid crystal display device of claim 16, wherein an acyl substitution group of cellulose acylate as a main component in the cellulose acylate film is at least one selected from acetyl, propionyl, and butyryl.

18. The liquid crystal display device of claim 5, wherein at least one of the optically anisotropic layers comprises at least one Rth enhancer.

19. The liquid crystal display device of claim 18, wherein the Rth enhancer comprises at least one compound having an absorption maximum at a wavelength ranging from 250 nm to 380 nm.

20. The liquid crystal display device of claim 18, wherein the Rth enhancer comprises at least one compound represented by Formula (I) 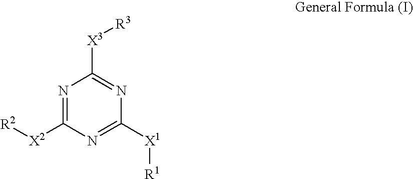
in which X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

21. The liquid crystal display device of claim 20, wherein the amount of the at least one compound represented by Formula (I) is from 0.1 to 30% by mass.

22. The liquid crystal display device of claim 5, wherein the thickness of the optically anisotropic layer is 30 to 200 μm.

23. The liquid crystal display device of claim 1, employing an in-plane alignment type electrically controlled birefringence (ECB) mode, in which alignment of liquid crystal molecules is changed to be vertical to the surface of the substrate under an electric field thereby providing a low transmissivity state.

24. The liquid crystal display device of claim 1, employing a bend alignment mode.

25. The liquid crystal display device of claim 1, employing a TN mode.

26. The liquid crystal display device of claim 1, employing a VA mode.
